(19) United States
(12) Patent Application Publication
(10) Pub. No.: US 2024/0024953 A1
(43) Pub. Date: Jan. 25, 2024

(54) ASPECTS OF THREE-DIMENSIONAL OBJECT FORMATION

(71) Applicant: Velo3D, Inc., Campbell, CA (US)

(72) Inventors: Benyamin Buller, Cupertino, CA (US); Tsvetan Tsvetanov, Santa Cruz, CA (US); Nicholas Karahalis Burgess, San Jose, CA (US); Jason Andrew Monschke, San Jose, CA (US); Tasso Lappas, Pasadena, CA (US)

(21) Appl. No.: 18/215,886

(22) Filed: Jun. 29, 2023

Related U.S. Application Data
(63) Continuation of application No. 18/115,813, filed on Mar. 1, 2023.
Application No. 18/115,813 is a continuation of application No. 17/985,293, filed on Nov. 11, 2022, now abandoned.
Application No. 17/985,293 is a continuation of application No. 17/873,292, filed on Jul. 26, 2022, now abandoned.
Application No. 17/873,292 is a continuation of application No. 17/725,938, filed on Apr. 21, 2022, now abandoned.
Application No. 17/725,938 is a continuation of application No. 17/571,809, filed on Jan. 10, 2022, now abandoned.
Application No. 17/571,809 is a continuation of application No. 17/486,145, filed on Sep. 27, 2021, now abandoned.
Application No. 17/486,145 is a continuation of application No. 17/346,406, filed on Jun. 14, 2021, now abandoned.
Application No. 17/346,406 is a continuation of application No. 17/169,831, filed on Feb. 8, 2021, now abandoned.
Application No. 17/169,831 is a continuation of application No. PCT/US19/42637, filed on Jul. 19, 2019.
(60) Provisional application No. 62/716,264, filed on Aug. 8, 2018.

(51) Int. Cl. B22F 10/85; B28B 1/00; B28B 17/00; B22F 10/38; B33Y 50/02

(52) U.S. Cl. CPC B22F 10/85; B28B 1/001; B28B 17/0072; B28B 17/0081; B22F 10/38; B33Y 50/02

(57) ABSTRACT

The present disclosure relates to generation of forming instructions to form one or more three-dimensional (3D) objects and/or analyzing any failure. The failure may comprise a failure of one or more apparatuses utilized during the forming process (or any components of the apparatuses). The failure may comprise a failure in at least a portion of the 3D object during and/or after its formation. The failure may be analyzed before, during, and/or after generation of the forming instructions.

### RELATED APPLICATIONS

This patent application is a continuation of U.S. patent application Ser. No. 18/115,813 filed Mar. 1, 2023, which is a continuation of U.S. patent application Ser. No. 17/985,293 filed Nov. 11, 2022, which is a continuation of U.S. patent application Ser. No. 17/873,292 filed Jul. 26, 2022, which is a continuation of U.S. patent application Ser. No. 17/725,938 filed Apr. 21, 2022, which is a continuation of U.S. patent application Ser. No. 17/571,809 filed Jan. 10, 2022, which is a continuation of U.S. patent application Ser. No. 17/486,145 filed Sep. 27, 2021, which is a continuation of U.S. patent application Ser. No. 17/346,406 filed Jun. 14, 2021, which is a continuation of U.S. patent application Ser. No. 17/169,831 filed Feb. 8, 2021, which is a continuation application of PCT/US19/42637 filed Jul. 19, 2019, which claims priority from U.S. Provisional Patent Application Ser. No. 62/716,264 filed Aug. 8, 2018 and titled “ASPECTS OF THREE-DIMENSIONAL OBJECT FORMATION,” each of which is entirely incorporated herein by reference.

### BACKGROUND

Three-dimensional objects may be formed using various methodologies, for example, molding, sculpting, or three-dimensional printing. Three-dimensional (3D) printing (e.g., additive manufacturing) is a process for making a three-dimensional object of any shape from a design. The design may be in the form of a data source, such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed, and thereafter successive layers of hardened material are added one by one, wherein each new layer of hardened material is added on a pre-formed layer of hardened material, until the entire designed three-dimensional structure (3D object) is layer-wise materialized.

3D models may be generated with a computer-aided design package, via a 3D scanner, or manually. The modeling process of preparing geometric data for 3D computer graphics may be similar to those of the plastic arts, such as sculpting or animating. 3D scanning is a process of analyzing and collecting digital data on the shape and appearance of a real object (e.g., real-life object). Based on these data, 3D models of the scanned object can be produced.

Many additive processes are currently available. They may differ in the manner layers are deposited and/or formed to create the materialized structure. They may vary in the material(s) that are used to generate the designed structure. Some methods melt and/or soften material to produce the layers. Examples of 3D printing methods comprise selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, and/or metal) are cut to shape and joined together.

Sometimes, a forming process (e.g., 3D printing) leads to at least a portion of a generated 3D object exhibiting an increased likelihood of at least one defect. For example, a defect may comprise a dislocation (e.g., a crack and/or a seam) in a formed 3D object, or a deformation of a (e.g., geometry of a) 3D object (as compared to a requested geometry of the 3D object). The geometrical deformation may comprise bending, warping, or twisting. The deformation may include a geometric distortion and/or altered material property, with respect to a requested three-dimensional object having one or more geometric requirements (e.g., as to shape and/or tolerances) and/or one or more requested material properties. The deformation may comprise an internal deformation. Internal may be within the 3D object or a portion thereof. The deformation may include a change in the material properties. The deformation may be disruptive (e.g., for the intended purpose of the 3D object). The deformation may comprise a geometric deformation. The deformation may comprise inconsistent and/or unrequested material properties. The deformation may occur before, during, and/or after hardening of the transformed material. The deformation may comprise balling, warping, curling, bending, rolling, or external cracking. The geometrical deformation may comprise deviation from at least one requested dimension of the requested 3D object. The deformation in the material properties may comprise density, porosity, dislocation, metallurgical phase, crystal phase, crystal structure, alloy composition, or internal cracking.

At times, formation of a 3D object is resource intensive. A resource may comprise computational resources (e.g., a processing unit cycles, memory operations, or input/output operations) required to prepare formation instructions to generate a 3D object. A resource may comprise a time required to form the 3D object. At times, a 3D object may fail to successfully form due to at least one (e.g., structural and/or internal) defect in the formed 3D object, and/or to at least one malfunction of forming device or component thereof. Successful formation may comprise (i) formed for its intended purpose or (ii) formed according to requirement (e.g., within allowed tolerance(s)). Failure to successfully form a 3D object may lead to expenditure of human, energetic, and/or material resources, in efforts to successfully prepare, form, and/or salvage the 3D object. At times, is may be of interest to save this expenditure, e.g., by (i) deciding not to initiate a forming process that would lead to a failure to successfully form a 3D object (e.g., a build failure), or (ii) halting formation of the 3D object after it initiated.

### SUMMARY

At times, it is requested to analyze (e.g., estimate, calculate and/or assess) a likelihood of failure in the forming of a 3D object. Such analysis may allow saving expenditures that would otherwise be invested to form a failed 3D object and/or damage at least a component of a forming apparatus. A failure can comprise a defect in at least a portion of the 3D object and/or a malfunction in a device operating to form the 3D object. A defect may comprise a rupture, a collapse, a failure of the 3D object to meet at least one (e.g., design) requirement, or a failure of the 3D object to operate (e.g., perform) per its intended purpose. A malfunction may comprise damage to the device that is operating to form the 3D object.

In some embodiments, analysis (e.g., a prediction and/or feedback) is provided regarding an estimated likelihood of a failure to generate the 3D object. The analysis may be provided before, during, and/or after formation of the 3D object. The analysis may be provided before, during, and/or after generating the forming instructions. In some embodiments, the analysis is provided in the course of generating forming instructions for a device to form the 3D object (e.g., during formation preparation). In some embodiments, the analysis is provided considering a (e.g., estimated) physical state (e.g., deformation) of at least a portion of the 3D object during its formation. In some embodiments, the analysis is provided prior to commitment of substantial (e.g., human, computer, and/or material) resources for the preparation or formation of the designed 3D object (e.g., rapid analysis, and/or simplified analysis).

At times, it may be requested to fabricate a 3D object including complex topology and/or geometry. For example, the 3D object may comprise overhangs (e.g., ledges), and/or cavities. The overhangs may be shallow overhangs. At times, the analysis may consider a geometry and/or orientation of the 3D object. At times, the analysis may consider a (e.g., physics model) simulation of the process of forming at least a portion of the 3D object and/or the reaction of the 3D object to its formation (e.g., a post formation relaxation process within the formed 3D object). The physics model may be a simplified (e.g., physics model) simulation of at least a portion of the 3D object. At times, the analysis may not consider a (e.g., physics model) simulation of at least a portion of the 3D object. At times, the analysis may consider the geometry of the 3D object. The geometry may comprise a curvature, angle, or a fundamental length scale (FLS) of a bottom skin (e.g., of an overhang) of at least a portion of the 3D object. The FLS may comprise a length. The angle may be between a bottom skin and an adjacent portion of the 3D object (e.g., that is adjacent to the bottom skin). The curvature may be a positive or a negative curvature.

The operations of any of the methods, non-transitory computer readable media, and/or controller directions described herein can be in any order. At least two of the operations in any of the methods, non-transitory computer readable media, and/or controller(s) can be performed simultaneously.

In another aspect, a method for forming a three-dimensional object comprises: generating an instruction set to form the three-dimensional object by using at least a geometric model of the three-dimensional object; and before, after, and/or during generation of the instruction set, analyzing any failure of the three-dimensional object due to (e.g., as a consequence of) forming at least a portion of the three-dimensional object.

In some embodiments, analyzing any failure of the three-dimensional object due to (e.g., as a consequence of) forming at least a portion of the three-dimensional object considers at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, analyzing any failure of the three-dimensional object due to (e.g., as a consequence of) forming at least a portion of the three-dimensional object in operation (b) is before generation of the instruction set. In some embodiments, analyzing any failure of the three-dimensional object as a consequence of forming at least a portion of the three-dimensional object in operation (b) is during generation of the instruction set. In some embodiments, the method further comprises analyzing any failure of the three-dimensional object as a consequence of forming at least a portion of the three-dimensional object during formation of the three-dimensional object. In some embodiments, the instruction set comprises one or more instructions. In some embodiments, the method further comprises during formation of the three-dimensional object, analyzing any failure of the formed three-dimensional object as a consequence of formation of the three-dimensional object. In some embodiments, the failure of the formed three-dimensional object is manifested during formation of the three-dimensional object. In some embodiments, the failure of the formed three-dimensional object is manifested after formation of the three-dimensional object. In some embodiments, generating an instruction set to form the three-dimensional object is by considering a failure mode comprising (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the adjustive deformation comprises bending, curling, warping, twisting, rolling, plastic yielding, or balling. In some embodiments, the destructive deformation comprises cracking, or tearing. In some embodiments, the destructive deformation is of an auxiliary support and/or of the three-dimensional object. In some embodiments, the excessive material addition comprises balling, agglomerating, or extending. In some embodiments, the adjustive deformation comprises out of plane and/or in-plane deformation, which plane is perpendicular to a global vector. In some embodiments, the material property comprises a phase, a density, and/or a dislocation. In some embodiments, analyzing comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser dispenses the pre-transformed material and/or a binder. In some embodiments, transforming the pre-transformed material to the transformed material comprises physically binding, chemically bonding, or altering a material phase of the pre-transformed material. In some embodiments, the transforming agent comprises an energy beam, a binding agent, or a reactive agent. In some embodiments, forming comprises a printing, molding, welding, machining, or casting. In some embodiments, the three-dimensional object is a first three-dimensional object, wherein analyzing any failure of at least a portion of the first three-dimensional object comprises considering historical data of at least a portion of a second three-dimensional object that is formed and has a similar associated geometry to the at least the portion of the first three-dimensional object. In some embodiments, analyzing any failure of the first three-dimensional object is while considering a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the simulation is performed on at least two portions of the three-dimensional object. In some embodiments, the simulation comprises estimating at least two groups of failure modes for the at least two portions, which failure modes comprise: (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the at least two groups of failure modes are the same. In some embodiments, the at least two groups of failure modes are different. In some embodiments, the method further comprises estimating a group of failure modes for a respective portion of the three-dimensional object. In some embodiments, the geometric model comprises a digital model. In some embodiments, the geometric model comprises a virtual model. In some embodiments, the method further comprises embodying the instruction set in a data structure. In some embodiments, the data structure is configured to be read by a forming device. In some embodiments, forming comprises layerwise printing of the three-dimensional object. In some embodiments, analyzing any failure of three-dimensional object as a consequence of forming is during at most about ten (10) minutes. In some embodiments, analyzing any failure of three-dimensional object as a consequence of forming is during at most about one (1) minute. In some embodiments, analyzing any failure of three-dimensional object as a consequence of forming is at most about half a minute (0.5 min). In some embodiments, the accuracy of analyzing the failure is of at least about seventy percent (70%). In some embodiments, the three-dimensional object has a surface-to-volume ratio (sa/vol) of at least about 10. In some embodiments, the three-dimensional object has a sa/vol of at least about 50.

In another aspect, a computer system for forming a three-dimensional object comprises processing circuitry coupled to a memory, the memory having recorded thereon instructions that, when executed by the processing circuitry, cause the processing circuitry to be configured to: generate an instruction set to form the three-dimensional object by using at least a geometric model of the three-dimensional object; and before, after, and/or during generation of the instruction set, analyze any failure of the three-dimensional object due to (e.g., as a consequence of) forming at least a portion of the three-dimensional object.

In some embodiments, analyze any failure of the three-dimensional object as a consequence of forming at least a portion of the three-dimensional object considers at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, the processing circuitry configured to analyze any failure of the three-dimensional object as a consequence of forming at least a portion of the three-dimensional object in operation (b) before generation of the instruction set. In some embodiments, the processing circuitry configured to analyze any failure of the three-dimensional object as a consequence of forming at least a portion of the three-dimensional object in operation (b) during generation of the instruction set. In some embodiments, the computer system further comprises the processing circuitry configured to analyze any failure of the three-dimensional object as a consequence of forming at least a portion of the three-dimensional object during formation of the three-dimensional object. In some embodiments, the instruction set comprises one or more instructions. In some embodiments, the computer system further comprises the processing circuitry configured to, during formation of the three-dimensional object, analyze any failure of the formed three-dimensional object as a consequence of formation of the three-dimensional object. In some embodiments, the failure of the formed three-dimensional object is manifested during formation of the three-dimensional object. In some embodiments, the failure of the formed three-dimensional object is manifested after formation of the three-dimensional object. In some embodiments, the processing circuitry is configured to generate an instruction set to form the three-dimensional object by considering a failure mode comprising (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the adjustive deformation comprises bending, curling, warping, twisting, rolling, plastic yielding, or balling. In some embodiments, the destructive deformation comprises cracking, or tearing. In some embodiments, the destructive deformation is of an auxiliary support and/or of the three-dimensional object. In some embodiments, the excessive material addition comprises balling, agglomerating, or extending. In some embodiments, the adjustive deformation comprises out of plane and/or in-plane deformation, which plane is perpendicular to a global vector. In some embodiments, the material property comprises a phase, a density, and/or a dislocation. In some embodiments, the processing circuitry configured to analyze comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser is configured to dispense the pre-transformed material and/or a binder. In some embodiments, a transformation of the pre-transformed material to the transformed material comprises physically binding, chemically bonding, or altering a material phase of the pre-transformed material. In some embodiments, the transforming agent comprises an energy beam, a binding agent, or a reactive agent. In some embodiments, the forming tool comprises a printing, molding, welding, machining, or casting tool. In some embodiments, the three-dimensional object is a first three-dimensional object, wherein the processing circuitry configured to analyze any failure of at least a portion of the first three-dimensional object comprises the processing circuitry configured to consider historical data of at least a portion of a second three-dimensional object that is formed and has a similar associated geometry to the at least the portion of the first three-dimensional object. In some embodiments, the processing circuitry configured to analyze any failure of the first three-dimensional object comprises the processing circuitry configured to consider a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the processing circuitry configured to perform the simulation on at least two portions of the three-dimensional object. In some embodiments, the processing circuitry configured to perform the simulation comprises an estimation of at least two groups of failure modes for the at least two portions, which failure modes comprise: (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the at least two groups of failure modes are the same. In some embodiments, the at least two groups of failure modes are different. In some embodiments, the computer system further comprises the processing circuitry configured to estimate a group of failure modes for a respective portion of the three-dimensional object. In some embodiments, the geometric model comprises a digital model. In some embodiments, the geometric model comprises a virtual model. In some embodiments, the computer system further comprises the processing circuitry configured to embody the instruction set in a data structure. In some embodiments, the data structure is configured to be read by a forming device. In some embodiments, forming comprises layerwise printing of the three-dimensional object. In some embodiments, the processing circuitry is configured to analyze any failure of three-dimensional object as a consequence of forming is during at most about ten (10) minutes. In some embodiments, the processing circuitry is configured to analyze any failure of three-dimensional object as a consequence of forming is during at most about one (1) minute. In some embodiments, the processing circuitry is configured to analyze any failure of three-dimensional object as a consequence of forming is at most about half a minute (0.5 min). In some embodiments, the accuracy of analysis of the failure is of at least about seventy percent (70%). In some embodiments, the three-dimensional object has a surface-to-volume ratio (sa/vol) of at least about 10. In some embodiments, the three-dimensional object has a sa/vol of at least about 50.

In another aspect, a non-transitory computer-readable medium storing program instructions for generating forming instructions for formation of a three-dimensional object that, when the program instructions are executed by a processing unit, cause the processing unit to: generate an instruction set to form the three-dimensional object by using at least a geometric model of the three-dimensional object; and before, after, and/or during generation of the instruction set, analyze any failure of the three-dimensional object due to (e.g., as a consequence of) forming at least a portion of the three-dimensional object.

In some embodiments, analyze any failure of the three-dimensional object as a consequence of forming at least a portion of the three-dimensional object comprises program instructions that cause the processing unit to consider at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. The non-transitory computer readable medium of claim 126, wherein the fundamental length scale comprises a length. In some embodiments, the program instructions cause the processing unit to analyze any failure of the three-dimensional object as a consequence of forming at least a portion of the three-dimensional object in operation (b) before generation of the instruction set. In some embodiments, the program instructions cause the processing unit to analyze any failure of the three-dimensional object as a consequence of forming at least a portion of the three-dimensional object in operation (b) during generation of the instruction set. In some embodiments, the non-transitory computer readable medium further comprises program instructions that cause the processing unit to analyze any failure of the three-dimensional object as a consequence of forming at least a portion of the three-dimensional object during formation of the three-dimensional object. In some embodiments, the instruction set comprises one or more instructions. In some embodiments, the non-transitory computer readable medium further comprises program instructions that cause the processing unit to, during formation of the three-dimensional object, analyze any failure of the formed three-dimensional object as a consequence of formation of the three-dimensional object. In some embodiments, the failure of the formed three-dimensional object is manifested during formation of the three-dimensional object. In some embodiments, the failure of the formed three-dimensional object is manifested after formation of the three-dimensional object. In some embodiments, the program instructions cause the processing unit to generate an instruction set to form the three-dimensional object by considering a failure mode comprising (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the adjustive deformation comprises bending, curling, warping, twisting, rolling, plastic yielding, or balling. In some embodiments, the destructive deformation comprises cracking, or tearing. In some embodiments, the destructive deformation is of an auxiliary support and/or of the three-dimensional object. In some embodiments, the excessive material addition comprises balling, agglomerating, or extending. In some embodiments, the adjustive deformation comprises out of plane and/or in-plane deformation, which plane is perpendicular to a global vector. In some embodiments, the material property comprises a phase, a density, and/or a dislocation. In some embodiments, the program instructions cause the processing unit to analyze comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser is configured to dispense the pre-transformed material and/or a binder. In some embodiments, a transformation of the pre-transformed material to the transformed material comprises physically binding, chemically bonding, or altering a material phase of the pre-transformed material. In some embodiments, the transforming agent comprises an energy beam, a binding agent, or a reactive agent. In some embodiments, the forming tool comprises a printing, molding, welding, machining, or casting tool. In some embodiments, the three-dimensional object is a first three-dimensional object, wherein to analyze any failure of at least a portion of the first three-dimensional object comprises program instructions that cause the processing unit to consider historical data of at least a portion of a second three-dimensional object that is formed and has a similar associated geometry to the at least the portion of the first three-dimensional object. In some embodiments, to analyze any failure of the first three-dimensional object comprises program instructions that cause the processing unit to consider a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the program instructions cause the processing unit to perform the simulation on at least two portions of the three-dimensional object. In some embodiments, the program instructions cause the processing unit to perform the simulation comprises an estimation of at least two groups of failure modes for the at least two portions, which failure modes comprise: (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the at least two groups of failure modes are the same. In some embodiments, the at least two groups of failure modes are different. In some embodiments, the non-transitory computer readable medium further comprises program instructions that cause the processing unit to estimate a group of failure modes for a respective portion of the three-dimensional object. In some embodiments, the geometric model comprises a digital model. In some embodiments, the geometric model comprises a virtual model. In some embodiments, the non-transitory computer readable medium further comprises program instructions that cause the processing unit to embody the instruction set in a data structure. In some embodiments, the data structure is configured to be read by a forming device. In some embodiments, forming comprises layerwise printing of the three-dimensional object. In some embodiments, the program instructions cause the processing unit to analyze any failure of three-dimensional object as a consequence of forming is during at most about ten (10) minutes. In some embodiments, the program instructions cause the processing unit to analyze any failure of three-dimensional object as a consequence of forming is during at most about one (1) minute. In some embodiments, the program instructions cause the processing unit to analyze any failure of three-dimensional object as a consequence of forming is at most about half a minute (0.5 min). In some embodiments, the accuracy of analysis of the failure is of at least about seventy percent (70%). In some embodiments, the three-dimensional object has a surface-to-volume ratio (sa/vol) of at least about 10. In some embodiments, the three-dimensional object has a sa/vol of at least about 50.

In another aspect, a method for forming a three-dimensional object comprises: (a) generating an instruction set to form the three-dimensional object by using at least a geometric model of a three-dimensional object, which instructions are generated over (e.g., during) time duration T; and (b) analyzing any failure in the formed three-dimensional object over (e.g., during) at most about half of the time duration T (0.5*T), which failure is due to (e.g., consequential to) formation of at least a portion of the three-dimensional object.

In some embodiments, analyzing any failure of the three-dimensional object as a consequence of forming at least a portion of the three-dimensional object considers at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, analyzing any failure of the three-dimensional object as a consequence of forming at least a portion of the three-dimensional object in operation (b) is before generation of the instruction set. In some embodiments, analyzing any failure of the three-dimensional object as a consequence of forming at least a portion of the three-dimensional object in operation (b) is during generation of the instruction set. In some embodiments, the method further comprises analyzing any failure of the three-dimensional object as a consequence of forming at least a portion of the three-dimensional object during formation of the three-dimensional object. In some embodiments, the instruction set comprises one or more instructions. In some embodiments, the method further comprises during formation of the three-dimensional object, analyzing any failure of the formed three-dimensional object as a consequence of formation of the three-dimensional object. In some embodiments, the failure of the formed three-dimensional object is manifested during formation of the three-dimensional object. In some embodiments, the failure of the formed three-dimensional object is manifested after formation of the three-dimensional object. In some embodiments, generating an instruction set to form the three-dimensional object is by considering a failure mode comprising (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the adjustive deformation comprises bending, curling, warping, twisting, rolling, plastic yielding, or balling. In some embodiments, the destructive deformation comprises cracking, or tearing. In some embodiments, the destructive deformation is of an auxiliary support and/or of the three-dimensional object. In some embodiments, the excessive material addition comprises balling, agglomerating, or extending. In some embodiments, the adjustive deformation comprises out of plane and/or in-plane deformation, which plane is perpendicular to a global vector. In some embodiments, the material property comprises a phase, a density, and/or a dislocation. In some embodiments, analyzing comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser dispenses the pre-transformed material and/or a binder. In some embodiments, transforming the pre-transformed material to the transformed material comprises physically binding, chemically bonding, or altering a material phase of the pre-transformed material. In some embodiments, the transforming agent comprises an energy beam, a binding agent, or a reactive agent. In some embodiments, forming comprises a printing, molding, welding, machining, or casting. In some embodiments, the three-dimensional object is a first three-dimensional object, wherein analyzing any failure of at least a portion of the first three-dimensional object comprises considering historical data of at least a portion of a second three-dimensional object that is formed and has a similar associated geometry to the at least the portion of the first three-dimensional object. In some embodiments, analyzing any failure of the first three-dimensional object is while considering a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the simulation is performed on at least two portions of the three-dimensional object. In some embodiments, the simulation comprises estimating at least two groups of failure modes for the at least two portions, which failure modes comprise: (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the at least two groups of failure modes are the same. In some embodiments, the at least two groups of failure modes are different. In some embodiments, the method further comprises estimating a group of failure modes for a respective portion of the three-dimensional object. In some embodiments, the geometric model comprises a digital model. In some embodiments, the geometric model comprises a virtual model. In some embodiments, the method further comprises embodying the instruction set in a data structure. In some embodiments, the data structure is configured to be read by a forming device. In some embodiments, forming comprises layerwise printing of the three-dimensional object. In some embodiments, the three-dimensional object has a surface-to-volume ratio (sa/vol) of at least about 10. In some embodiments, the three-dimensional object has a sa/vol of at least about 50. In some embodiments, the analyzing any failure in the formed three-dimensional object is during at most about 0.2 times the time duration T (0.2*T). In some embodiments, the analyzing any failure in the formed three-dimensional object is during at most about 0.01 times the time duration T (0.01*T). In some embodiments, the accuracy of analyzing the failure is of at least about seventy percent (70%). In some embodiments, analyzing any failure in the formed three-dimensional object during at most about ten (10) minutes. In some embodiments, analyzing any failure in the formed three-dimensional object during at most about one (1) minute. In some embodiments, analyzing any failure in the formed three-dimensional object during at most about half a minute (0.5 min).

In another aspect, a computer system for forming a three-dimensional object comprises processing circuitry coupled to a memory, the memory having recorded thereon instructions that, when executed by the processing circuitry, cause the processing circuitry to be configured to: (a) generate an instruction set to form the three-dimensional object by using at least a geometric model of a three-dimensional object, which instruction set is generated during time duration T; and (b) analyze any failure in the formed three-dimensional object over (e.g., during) at most about half of the time duration T (0.5*T), which failure is due to (e.g., consequential to) formation of at least a portion of the three-dimensional object.

In some embodiments, analyze any failure of the three-dimensional object as a consequence of forming at least a portion of the three-dimensional object considers at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, the processing circuitry is configured to analyze any failure of the three-dimensional object as a consequence of forming at least a portion of the three-dimensional object in operation (b) before generation of the instruction set. In some embodiments, the processing circuitry is configured to analyze any failure of the three-dimensional object as a consequence of forming at least a portion of the three-dimensional object in operation (b) during generation of the instruction set. In some embodiments, the computer system further comprises the processing circuitry is configured to analyze any failure of the three-dimensional object as a consequence of forming at least a portion of the three-dimensional object during formation of the three-dimensional object. In some embodiments, the instruction set comprises one or more instructions. In some embodiments, the computer system further comprises the processing circuitry configured to, during formation of the three-dimensional object, analyze any failure of the formed three-dimensional object as a consequence of formation of the three-dimensional object. In some embodiments, the failure of the formed three-dimensional object is manifested during formation of the three-dimensional object. In some embodiments, the failure of the formed three-dimensional object is manifested after formation of the three-dimensional object. In some embodiments, the processing circuitry is configured to generate an instruction set to form the three-dimensional object by considering a failure mode comprising (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the adjustive deformation comprises bending, curling, warping, twisting, rolling, plastic yielding, or balling. In some embodiments, the destructive deformation comprises cracking, or tearing. In some embodiments, the destructive deformation is of an auxiliary support and/or of the three-dimensional object. In some embodiments, the excessive material addition comprises balling, agglomerating, or extending. In some embodiments, the adjustive deformation comprises out of plane and/or in-plane deformation, which plane is perpendicular to a global vector. In some embodiments, the material property comprises a phase, a density, and/or a dislocation. In some embodiments, the processing circuitry configured to analyze comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser is configured to dispense the pre-transformed material and/or a binder. In some embodiments, a transformation of the pre-transformed material to the transformed material comprises physically binding, chemically bonding, or altering a material phase of the pre-transformed material. In some embodiments, the transforming agent comprises an energy beam, a binding agent, or a reactive agent. In some embodiments, the forming tool comprises a printing, molding, welding, machining, or casting tool. In some embodiments, the three-dimensional object is a first three-dimensional object, wherein the processing circuitry configured to analyze any failure of at least a portion of the first three-dimensional object comprises the processing circuitry configured to consider historical data of at least a portion of a second three-dimensional object that is formed and has a similar associated geometry to the at least the portion of the first three-dimensional object. In some embodiments, the processing circuitry configured to analyze any failure of the first three-dimensional object comprises the processing circuitry configured to consider a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the processing circuitry configured to perform the simulation on at least two portions of the three-dimensional object. In some embodiments, the processing circuitry configured to perform the simulation comprises an estimation of at least two groups of failure modes for the at least two portions, which failure modes comprise: (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the at least two groups of failure modes are the same. In some embodiments, the at least two groups of failure modes are different. In some embodiments, the computer system further comprises the processing circuitry configured to estimate a group of failure modes for a respective portion of the three-dimensional object. In some embodiments, the geometric model comprises a digital model. In some embodiments, the geometric model comprises a virtual model. In some embodiments, the computer system further comprises the processing circuitry configured to embody the instruction set in a data structure. In some embodiments, the data structure is configured to be read by a forming device. In some embodiments, forming comprises layerwise printing of the three-dimensional object. In some embodiments, the processing circuitry is configured to analyze any failure of three-dimensional object as a consequence of forming is during at most about ten (10) minutes. In some embodiments, the processing circuitry is configured to analyze any failure of three-dimensional object as a consequence of forming is during at most about one (1) minute. In some embodiments, the processing circuitry is configured to analyze any failure of three-dimensional object as a consequence of forming is at most about half a minute (0.5 min). In some embodiments, the accuracy of analysis of the failure is of at least about seventy percent (70%). In some embodiments, the three-dimensional object has a surface-to-volume ratio (sa/vol) of at least about 10. In some embodiments, the three-dimensional object has a sa/vol of at least about 50. In some embodiments, the processing circuitry is configured to analyze any failure in the formed three-dimensional object during at most about 0.2 times the time duration T (0.2*T). In some embodiments, the processing circuitry is configured to analyze any failure in the formed three-dimensional object during at most about 0.01 times the time duration T (0.01*T).

In another aspect, a non-transitory computer-readable medium storing program instructions for forming a three-dimensional object that, when the program instructions are executed by a processing unit, cause the processing unit to: (a) generate an instruction set to form the three-dimensional object by using at least a geometric model of a three-dimensional object, which instruction set is generated over (e.g., during) time duration T; and (b) analyze any failure in the formed three-dimensional object during at most about half of the time duration T (0.5*T), which failure is consequential to formation of at least a portion of the three-dimensional object.

In some embodiments, analyze any failure of the three-dimensional object as a consequence of forming at least a portion of the three-dimensional object comprises program instructions that cause the processing unit to consider at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, the program instructions cause the processing unit to analyze any failure of the three-dimensional object as a consequence of forming at least a portion of the three-dimensional object in operation (b) before generation of the instruction set. In some embodiments, the program instructions cause the processing unit to analyze any failure of the three-dimensional object as a consequence of forming at least a portion of the three-dimensional object in operation (b) during generation of the instruction set. In some embodiments, the non-transitory computer readable medium further comprises program instructions that cause the processing unit to analyze any failure of the three-dimensional object as a consequence of forming at least a portion of the three-dimensional object during formation of the three-dimensional object. In some embodiments, the instruction set comprises one or more instructions. In some embodiments, the non-transitory computer readable medium further comprises program instructions that cause the processing unit to, during formation of the three-dimensional object, analyze any failure of the formed three-dimensional object as a consequence of formation of the three-dimensional object. In some embodiments, the failure of the formed three-dimensional object is manifested during formation of the three-dimensional object. In some embodiments, the failure of the formed three-dimensional object is manifested after formation of the three-dimensional object. In some embodiments, the program instructions cause the processing unit to generate an instruction set to form the three-dimensional object by considering a failure mode comprising (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the adjustive deformation comprises bending, curling, warping, twisting, rolling, plastic yielding, or balling. In some embodiments, the destructive deformation comprises cracking, or tearing. In some embodiments, the destructive deformation is of an auxiliary support and/or of the three-dimensional object. In some embodiments, the excessive material addition comprises balling, agglomerating, or extending. In some embodiments, the adjustive deformation comprises out of plane and/or in-plane deformation, which plane is perpendicular to a global vector. In some embodiments, the material property comprises a phase, a density, and/or a dislocation. In some embodiments, the program instructions cause the processing unit to analyze comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser is configured to dispense the pre-transformed material and/or a binder. In some embodiments, a transformation of the pre-transformed material to the transformed material comprises physically binding, chemically bonding, or altering a material phase of the pre-transformed material. In some embodiments, the transforming agent comprises an energy beam, a binding agent, or a reactive agent. In some embodiments, the forming tool comprises a printing, molding, welding, machining, or casting tool. In some embodiments, the three-dimensional object is a first three-dimensional object, wherein to analyze any failure of at least a portion of the first three-dimensional object comprises program instructions that cause the processing unit to consider historical data of at least a portion of a second three-dimensional object that is formed and has a similar associated geometry to the at least the portion of the first three-dimensional object. In some embodiments, to analyze any failure of the first three-dimensional object comprises program instructions that cause the processing unit to consider a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the program instructions cause the processing unit to perform the simulation on at least two portions of the three-dimensional object. In some embodiments, the program instructions cause the processing unit to perform the simulation comprises an estimation of at least two groups of failure modes for the at least two portions, which failure modes comprise: (i) any auxiliary supports of, (ii) a residual stress in, (iii) a material property of, (iv) any adjustive deformation in, (v) any destructive deformation in, or (vi) any excessive material attached to, the at least the portion of the three-dimensional object. In some embodiments, the at least two groups of failure modes are the same. In some embodiments, the at least two groups of failure modes are different. In some embodiments, the non-transitory computer readable medium further comprises program instructions that cause the processing unit to estimate a group of failure modes for a respective portion of the three-dimensional object. In some embodiments, the geometric model comprises a digital model. In some embodiments, the geometric model comprises a virtual model. In some embodiments, the non-transitory computer readable medium further comprises program instructions that cause the processing unit to embody the instruction set in a data structure. In some embodiments, the data structure is configured to be read by a forming device. In some embodiments, forming comprises layerwise printing of the three-dimensional object. In some embodiments, the program instructions cause the processing unit to analyze any failure of three-dimensional object as a consequence of forming is during at most about ten (10) minutes. In some embodiments, the program instructions cause the processing unit to analyze any failure of three-dimensional object as a consequence of forming is during at most about one (1) minute. In some embodiments, the program instructions cause the processing unit to analyze any failure of three-dimensional object as a consequence of forming is at most about half a minute (0.5 min). In some embodiments, the accuracy of analysis of the failure is of at least about seventy percent (70%). In some embodiments, the three-dimensional object has a surface-to-volume ratio (sa/vol) of at least about 10. In some embodiments, the three-dimensional object has a sa/vol of at least about 50. In some embodiments, the program instructions cause the processing unit to analyze any failure in the formed three-dimensional object during at most about 0.2 times the time duration T (0.2*T). In some embodiments, the program instructions cause the processing unit to analyze any failure in the formed three-dimensional object during at most about 0.01 times the time duration T (0.01*T).

In another aspect, a method for forming a three-dimensional object comprises: (a) generating an instruction set to form the three-dimensional object by using at least a geometric model of the three-dimensional object; and (b) analyzing any balling deformation that would occur during formation of the three-dimensional object.

In some embodiments, analyzing any balling deformation considers at least (i) a curvature, (ii) an angle, and/or (iii) a fundamental length scale, of at least a portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, analyzing any balling deformation in operation (b) is before generation of the instruction set. In some embodiments, analyzing any balling deformation in operation (b) is during generation of the instruction set. In some embodiments, the method further comprises analyzing any balling deformation during formation of the three-dimensional object. In some embodiments, the instruction set comprises one or more instructions. In some embodiments, the method further comprises, during formation of the three-dimensional object, analyzing any balling deformation as a consequence of formation of the three-dimensional object. In some embodiments, the balling deformation is manifested during formation of the three-dimensional object. In some embodiments, the balling deformation is manifested after formation of the three-dimensional object. In some embodiments, generating an instruction set to form the three-dimensional object is by considering a failure mode comprising any excessive material attached to the at least the portion of the three-dimensional object. In some embodiments, the excessive material addition comprises balling, agglomerating, or extending. In some embodiments, analyzing comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser dispenses the pre-transformed material and/or a binder. In some embodiments, transforming the pre-transformed material to the transformed material comprises physically binding, chemically bonding, or altering a material phase of the pre-transformed material. In some embodiments, the transforming agent comprises an energy beam, a binding agent, or a reactive agent. In some embodiments, forming comprises a printing, molding, welding, machining, or casting. In some embodiments, the three-dimensional object is a first three-dimensional object, wherein analyzing any balling deformation comprises considering historical data of at least a portion of a second three-dimensional object that is formed and has a similar associated geometry to the at least the portion of the first three-dimensional object. In some embodiments, analyzing any balling deformation is while considering a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the simulation is performed on at least two portions of the three-dimensional object. In some embodiments, the geometric model comprises a digital model. In some embodiments, the geometric model comprises a virtual model. In some embodiments, the method further comprises embodying the instruction set in a data structure. In some embodiments, the data structure is configured to be read by a forming device. In some embodiments, forming comprises layerwise printing of the three-dimensional object. In some embodiments, analyzing any balling deformation is during at most about ten (10) minutes. In some embodiments, analyzing any balling deformation is during at most about one (1) minute. In some embodiments, analyzing any balling deformation is at most about half a minute (0.5 min). In some embodiments, the accuracy of analyzing the balling deformation is of at least about seventy percent (70%). In some embodiments, the three-dimensional object has a surface-to-volume ratio (sa/vol) of at least about 10. In some embodiments, the three-dimensional object has a sa/vol of at least about 50. In some embodiments, analyzing any balling deformation comprises a balling deformation that leads to failure of the formed three-dimensional object, which failure occurs as a consequence of forming at least a portion of the three-dimensional object. In some embodiments, analyzing any balling deformation occurs before and/or during generation of the instruction set. In some embodiments, analyzing any balling deformation occurs before generation of the instruction set.

In another aspect, a computer system for forming a three-dimensional object comprises processing circuitry coupled to a memory, the memory having recorded thereon instructions that, when executed by the processing circuitry, cause the processing circuitry to be configured to: (a) generate an instruction set to form the three-dimensional object by using at least a geometric model of the three-dimensional object; and (b) analyze any balling deformation that would occur during formation of the three-dimensional object.

In some embodiments, analyze any balling deformation comprises processing circuitry configured to consider at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, the processing circuitry is configured to analyze any balling deformation in operation (b) before generation of the instruction set. In some embodiments, the processing circuitry is configured to analyze any balling deformation in operation (b) during generation of the instruction set. In some embodiments, the computer system further comprises the processing circuitry is configured to analyze any balling deformation during formation of the three-dimensional object. In some embodiments, the instruction set comprises one or more instructions. In some embodiments, the computer system further comprises the processing circuitry configured to, during formation of the three-dimensional object, analyze any balling deformation as a consequence of formation of the three-dimensional object. In some embodiments, the balling deformation is manifested during formation of the three-dimensional object. In some embodiments, the balling deformation is manifested after formation of the three-dimensional object. In some embodiments, the processing circuitry is configured to generate an instruction set to form the three-dimensional object by considering a failure mode comprising any excessive material attached to the at least the portion of the three-dimensional object. In some embodiments, the excessive material addition comprises balling, agglomerating, or extending. In some embodiments, the processing circuitry configured to analyze comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser is configured to dispense the pre-transformed material and/or a binder. In some embodiments, a transformation of the pre-transformed material to the transformed material comprises physically binding, chemically bonding, or altering a material phase of the pre-transformed material. In some embodiments, the transforming agent comprises an energy beam, a binding agent, or a reactive agent. In some embodiments, the forming tool comprises a printing, molding, welding, machining, or casting tool. In some embodiments, the three-dimensional object is a first three-dimensional object, wherein the processing circuitry configured to analyze any balling deformation comprises the processing circuitry configured to consider historical data of at least a portion of a second three-dimensional object that is formed and has a similar associated geometry to the at least the portion of the first three-dimensional object. In some embodiments, the processing circuitry configured to analyze any balling deformation comprises the processing circuitry configured to consider a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the processing circuitry configured to perform the simulation on at least two portions of the three-dimensional object. In some embodiments, the geometric model comprises a digital model. In some embodiments, the geometric model comprises a virtual model. In some embodiments, the computer system further comprises the processing circuitry configured to embody the instruction set in a data structure. In some embodiments, the data structure is configured to be read by a forming device. In some embodiments, forming comprises layerwise printing of the three-dimensional object. In some embodiments, the processing circuitry is configured to analyze any balling deformation is during at most about ten (10) minutes. In some embodiments, the processing circuitry is configured to analyze any balling deformation is during at most about one (1) minute. In some embodiments, the processing circuitry is configured to analyze any balling deformation is at most about half a minute (0.5 min). In some embodiments, the accuracy of analysis of the balling deformation is of at least about seventy percent (70%). In some embodiments, the three-dimensional object has a surface-to-volume ratio (sa/vol) of at least about 10. In some embodiments, the three-dimensional object has a sa/vol of at least about 50. In some embodiments, the processing circuitry is configured to analyze any balling deformation comprises a balling deformation that leads to failure of the formed three-dimensional object, which failure occurs as a consequence of forming at least a portion of the three-dimensional object. In some embodiments, the processing circuitry is configured to analyze any balling deformation before and/or during generation of the instruction set. In some embodiments, the processing circuitry is configured to analyze any balling deformation before generation of the instruction set.

In another aspect, a non-transitory computer-readable medium storing program instructions for forming a three-dimensional object that, when the program instructions are executed by a processing unit, cause the processing unit to: (a) generate an instruction set to form the three-dimensional object by using at least a geometric model of a three-dimensional object (e.g., the instruction set can be generated during time duration T); and (b) analyze any balling deformation that would occur during formation of the three-dimensional object.

In some embodiments, analyze any balling deformation comprises program instructions that cause the processing unit to consider at least (i) a curvature, (ii) an angle, and/or (iii) a fundamental length scale, of the at least the portion of the three-dimensional object. In some embodiments, the at least a portion of the three-dimensional object is a first portion of the three-dimensional object, and wherein the angle is an angle relative to: (i) a second portion of the three-dimensional object that borders the first portion, (ii) a plane normal to a global vector, and/or (iii) a platform configured to support the three-dimensional object during its formation. In some embodiments, the curvature is relative to: (i) a plane normal to a global vector, and/or (ii) a platform configured to support the three-dimensional object during its formation. In some embodiments, the three-dimensional object comprises one or more layers, and wherein the curvature is relative to: (i) a plane normal to a global vector, (ii) a platform configured to support the three-dimensional object during its formation, and/or (iii) an average layering plane of the one or more layers. In some embodiments, the fundamental length scale comprises a length. In some embodiments, the program instructions cause the processing unit to analyze any balling deformation in operation (b) before generation of the instruction set. In some embodiments, the program instructions cause the processing unit to analyze any balling deformation in operation (b) during generation of the instruction set. In some embodiments, the non-transitory computer readable medium further comprises program instructions that cause the processing unit to analyze any balling deformation during formation of the three-dimensional object. In some embodiments, the instruction set comprises one or more instructions. In some embodiments, the non-transitory computer readable medium further comprises program instructions that cause the processing unit to, during formation of the three-dimensional object, analyze any balling deformation as a consequence of formation of the three-dimensional object. In some embodiments, the balling deformation is manifested during formation of the three-dimensional object. In some embodiments, the balling deformation is manifested after formation of the three-dimensional object. In some embodiments, the program instructions cause the processing unit to generate an instruction set to form the three-dimensional object by considering a failure mode comprising any excessive material attached to the at least the portion of the three-dimensional object. In some embodiments, the excessive material addition comprises balling, agglomerating, or extending. In some embodiments, the program instructions cause the processing unit to analyze comprises a calculation by a graphical processing unit (GPU), a system-on-chip (SOC), an application specific integrated circuit (ASIC), an application specific instruction-set processor (ASIPs), a programmable logic device (PLD), and/or a field programmable gate array (FPGA). In some embodiments, the calculation comprises using a processor that comprises an electrical circuitry, and/or an electronic cable. In some embodiments, the calculation comprises using wired and/or wireless communication. In some embodiments, the calculation comprises using optical communication. In some embodiments, the calculation comprises using a processor that comprises an emitter and/or receiver. In some embodiments, a forming tool for forming the three-dimensional object comprises a dispenser or a platform that supports the three-dimensional object during its formation. In some embodiments, the forming tool comprises a transforming agent. In some embodiments, the transforming agent is for transforming a pre-transformed material to a transformed material. In some embodiments, the pre-transformed material comprises a powder. In some embodiments, the pre-transformed material comprises an elemental metal, a metal alloy, a ceramic, an allotrope of elemental carbon, a resin, or a polymer. In some embodiments, the metal alloy comprises an iron-comprising alloy, a nickel-comprising alloy, a cobalt-comprising allow, a chrome-comprising alloy, a cobalt chrome-comprising alloy, a titanium-comprising alloy, a magnesium-comprising alloy, or a copper-comprising alloy. In some embodiments, the dispenser is configured to dispense the pre-transformed material and/or a binder. In some embodiments, a transformation of the pre-transformed material to the transformed material comprises physically binding, chemically bonding, or altering a material phase of the pre-transformed material. In some embodiments, the transforming agent comprises an energy beam, a binding agent, or a reactive agent. In some embodiments, the forming tool comprises a printing, molding, welding, machining, or casting tool. In some embodiments, the three-dimensional object is a first three-dimensional object, wherein to analyze any balling deformation comprises program instructions that cause the processing unit to consider historical data of at least a portion of a second three-dimensional object that is formed and has a similar associated geometry to the at least the portion of the first three-dimensional object. In some embodiments, to analyze any balling deformation comprises program instructions that cause the processing unit to consider a computational model. In some embodiments, the computational model comprises historical data and/or a simulation. In some embodiments, the computational model comprises a physics simulation or a machine learning simulation. In some embodiments, the physics simulation comprises a simulation of a forming process of the three-dimensional object. In some embodiments, the forming process comprises printing, molding, welding, machining, or casting. In some embodiments, the forming process comprises hatching, tiling, forming globular melt pools, forming high aspect ratio melt pools, re-transforming, annealing, machining, or pre-heating. In some embodiments, the simulation of the forming process of the three-dimensional object considers aspects including (i) the geometric model, and/or (ii) behavior of a material forming the three-dimensional object during and/or after its formation. In some embodiments, the behavior of the material comprises thermal conductance, material microstructure, or mechanical properties. In some embodiments, the mechanical properties comprise stress, strain, contractibility, surface tension, flow, volatility, or wettability. In some embodiments, the simulation of the forming process of the three-dimensional object is simplified by analogizing the process to one or more electronic circuitry components. In some embodiments, the program instructions cause the processing unit to perform the simulation on at least two portions of the three-dimensional object. In some embodiments, the geometric model comprises a digital model. In some embodiments, the geometric model comprises a virtual model. In some embodiments, the non-transitory computer readable medium further comprises program instructions that cause the processing unit to embody the instruction set in a data structure. In some embodiments, the data structure is configured to be read by a forming device. In some embodiments, forming comprises layerwise printing of the three-dimensional object. In some embodiments, the program instructions cause the processing unit to analyze any balling deformation is during at most about ten (10) minutes. In some embodiments, the program instructions cause the processing unit to analyze any balling deformation is during at most about one (1) minute. In some embodiments, the program instructions cause the processing unit to analyze any balling deformation is at most about half a minute (0.5 min). In some embodiments, the accuracy of analysis of the failure is of at least about seventy percent (70%). In some embodiments, the three-dimensional object has a surface-to-volume ratio (sa/vol) of at least about 10. In some embodiments, the three-dimensional object has a sa/vol of at least about 50. In some embodiments, the program instructions cause the processing unit to analyze any balling deformation comprises a balling deformation that leads to failure of the formed three-dimensional object, which failure occurs as a consequence of forming at least a portion of the three-dimensional object. In some embodiments, the program instructions cause the processing unit to analyze any balling deformation before and/or during generation of the instruction set. In some embodiments, the program instructions cause the processing unit to analyze any balling deformation before generation of the instruction set.

Another aspect of the present disclosure provides a system for effectuating the methods disclosed herein.

Another aspect of the present disclosure provides an apparatus for effectuating the methods disclosed herein.

Another aspect of the present disclosure provides an apparatus comprising a controller that directs effectuating one or more operations (e.g., steps) in the method disclosed herein, wherein the controller is operatively coupled to the apparatuses, systems, and/or mechanisms that it controls to effectuate the method.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods above or elsewhere herein.

Another aspect of the present disclosure provides an apparatus for printing one or more 3D objects comprising a controller that is programmed to direct a mechanism used in a 3D printing methodology to implement (e.g., effectuate) any of the method disclosed herein, wherein the controller is operatively coupled to the mechanism.

Another aspect of the present disclosure provides a computer software product, comprising a non-transitory computer-readable medium in which program instructions are stored, which instructions, when read by a computer, cause the computer to direct a mechanism used in the 3D forming procedure to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.,” Figs.,” “Fig.” or “Figs.” herein), of which:

FIG. 1 shows a schematic cross-sectional view of a three-dimensional (3D) printing system and its components;

FIG. 2 illustrates a flowchart;

FIG. 3 illustrates a flowchart;

FIG. 4A schematically illustrates a perspective view of a 3D object; FIG. 4B schematically illustrates a perspective view of a portion of a 3D object with support members; and FIG. 4C schematically illustrates a cross section in various layering planes;

FIG. 5 illustrates a three-dimensional object and a forming apparatus;

FIGS. 6A-C schematically illustrates various cross-sectional views of 3D objects;

FIG. 7 schematically illustrates a portion of a 3D object;

FIG. 8 schematically illustrate various optional modules used in generation of forming instruction(s);

FIG. 9 illustrates a flow chart;

FIG. 10A schematically illustrates an optical setup; FIG. 10B schematically illustrates an energy beam; and FIG. 10C schematically illustrates a control scheme;

FIG. 11A shows a cross sectional view of a 3D object with a support member; and FIG. 11B schematically depicts a planar view of a 3D object;

FIG. 12A schematically illustrates a cross section of a 3D object; FIG. 12B schematically illustrates an example of a 3D plane; and FIG. 12C schematically illustrates a cross section in portion of a 3D object;

FIG. 13 schematically illustrates various vertical cross sectional views of different 3D object portions and a guiding circle;

FIGS. 14A-B schematically illustrate various physical models;

FIG. 15 schematically illustrates a computer system;

FIG. 16 schematically illustrates a computer system; and

FIG. 17 schematically illustrates a portion of a 3D object.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

The present disclosure provides apparatuses, systems and methods for controlling aspects of forming (e.g., printing) 3D objects, and analyzing any failure in formation of 3D objects. In some embodiments, the apparatuses, devices, systems, software and methods described herein enable an analysis (e.g., estimation, calculation and/or assessment) of a likelihood of failure in the forming of a 3D object. The requested 3D object may comprise a complex topology (e.g., which topology may comprise overhangs and/or cavities). The analysis may be performed before, during, and/or after generating forming instructions by which a forming device forms the 3D object. The analysis may be performed before, during and/or after formation of the 3D object. A failure can comprise a defect in at least a portion of the 3D object and/or a malfunction in a device operating to form the 3D object. A defect may comprise a rupture, a collapse, a failure of the 3D object to meet at least one (e.g., design) requirement, or a failure of the 3D object to operate (e.g., perform) for its intended purpose. For example, an analysis may comprise (i) any estimated failure mode(s) of the 3D object formation, or (ii) a response to the (e.g., any) estimated failure mode(s). In some embodiments, an estimated failure mode comprises a failure of: (i) object support; (ii) residual stress; (iii) material property; (iv) excessive material addition (e.g., that can manifest as balling); (v) adjustive deformation (e.g., bending, curling, warping, twisting, rolling, plastic yielding, or balling); or (vi) destructive deformation (e.g., cracking, or, tearing); of the (e.g., forming) 3D object. At times, an analysis may consider a geometry and/or orientation of the 3D object. At times, the analysis may consider a (e.g., physics model) simulation of a process of forming at least a portion of the 3D object and/or the reaction of the 3D object to its formation (e.g., a post formation relaxation process within the formed 3D object). At times, the analysis may be a simplification of: various aspects of the geometric model and/or simulation of forming the requested 3D object. In some embodiments, a malfunction may comprise damage to the device that is operating to form the 3D object. In some embodiments, a response to an estimated failure mode may comprise: (i) an object formation modification, (ii) a notification, or (iii) a refinement of a failure estimate. In some embodiments, the analysis is provided prior to commitment of substantial (e.g., human, computer, and/or material) resources for the preparation or formation of the designed 3D object (e.g., rapid analysis, and/or simplified analysis).

Terms such as “a,” “an,” and “the” are not intended to refer to only a singular entity, but may include the general class of which a specific example may be used for illustration. The terminology herein is used to describe specific embodiments of the invention, but their usage does not delimit the invention.

When ranges are mentioned, the ranges are meant to be inclusive, unless otherwise specified. For example, a range between value 1 and value 2 is meant to be inclusive and include value 1 and value 2, unless otherwise stated. The inclusive range will span any value from about value 1 to about value 2. The term “between” as used herein is meant to be inclusive unless otherwise specified. For example, between X and Y is understood herein to mean from X to Y.

The term “adjacent” or “adjacent to,” as used herein, includes ‘next to’, ‘adjoining’, ‘in contact with,’ and ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism, including a first mechanism that is in signal communication with a second mechanism. The term “configured to” refers to an object or apparatus that is (e.g., structurally) configured to bring about an intended result.

Fundamental length scale (abbreviated herein as “FLS”) can refer to any suitable scale (e.g., dimension, or size) of an object. For example, a FLS of an object may comprise a length, a width, a height, a diameter, a spherical equivalent diameter, or a diameter of a bounding sphere.

A “global vector” may be (a) a (e.g., local) gravitational field vector, (b) a vector in a direction opposite to the direction of a layerwise 3D object formation, and/or (c) a vector normal to a surface of a platform that supports the 3D object, in a direction opposite to the 3D object.

The phrase “a three-dimensional object” as used herein may refer to “one or more three-dimensional objects,” as applicable.

“Real time” as understood herein may be during at least part of the forming (e.g., printing) of a 3D object. Real time may be during a print operation. Real time may be during a print cycle. Real time may comprise during formation of: a 3D object, a layer of hardened material as part of the 3D object, a hatch line, a single-digit number of melt pools, a melt pool, or any combination thereof.

The phrase “is/are structured,” or “is/are configured,” when modifying an article, refers to a structure of the article that is able to bring about the enumerated result.

The phrase “a target surface” may refer to (1) a surface of a build plane (e.g., an exposed surface of a material bed), (2) an exposed surface of a platform, (3) an exposed surface of a 3D object (or a portion thereof), (4) any exposed surface adjacent to an exposed surface of the material bed, platform, or 3D object, and/or (5) any targeted surface. Targeted may be by at least one energy beam, or by a dispenser (e.g., having a printing head).

The methods, systems, apparatuses, and/or software may effectuate the formation of one or more objects (e.g., 3D objects). In some cases, the one or more objects comprise an elemental metal, metal alloy, ceramic, an allotrope of elemental carbon, a polymer, or a resin. The pre-transformed material may comprise an organic, or an inorganic material. In some embodiments, the 3D object comprises an overhang structure. An overhang structure (also referred to herein as “overhang” or “overhang region”) can refer to a structure of a 3D object that protrudes a distance from another structure (e.g., a core structure). An overhang structure may comprise (e.g., correspond to) a ceiling (e.g., cavity ceiling), bottom (e.g., cavity bottom), protrusion, ledge, blade, hanging structure, undercut, projection, protuberance, balcony, wing, leaf, extension, shelf, jut, hook, or a step, of a 3D object. The overhang may be free of auxiliary supports, e.g., during the forming of the overhang. For example, the overhang may be formed on (e.g., attached to, or anchored to) a previously formed (e.g., already hardened) portion of the 3D object. A surface (e.g., bottom surface) of an overhang may have a surface roughness at or below a prescribed roughness measurement. Bottom may be in the direction of the global vector and/or face the platform, during forming of the 3D object.

In some embodiments, the 3D object comprises a skin, which can correspond to a portion of the 3D object that comprises an exterior surface of the 3D object. The skin may be formed by an outer contour of a layer of the 3D object, and may be referred herein as “outer portion” or “exterior portion.” The contour of the layer can be referred herein as a “rim,” “contour,” “contour portion,” “perimeter,” or “perimeter portion.” In some embodiments, the skin is a “bottom” skin, which can correspond to a skin on a bottom of an overhang with respect to a platform surface during formation (e.g., printing) of the one or more 3D objects. Bottom may be in the direction of the global vector and/or face the platform, during formation of the 3D object.

Three-dimensional printing (also “3D printing”) generally refers to a process for generating a 3D object. The apparatuses, methods, controllers, and/or software described herein pertaining to generating (e.g., forming, or printing) a 3D object pertain also to generating a plurality of 3D objects. For example, 3D printing may refer to sequential addition of material layers or joining of material layers (or parts of material layers) to form a 3D structure, in a controlled manner. The controlled manner may comprise manual or automated control. In the 3D printing process, the deposited material can be transformed (e.g., fused, sintered, melted, bound, or otherwise connected) to subsequently harden and form at least a part of the 3D object. Fusing (e.g., sintering or melting), binding, or otherwise connecting the material is collectively referred to herein as transforming a pre-transformed material (e.g., powder material) into a transformed material. Fusing the material may include melting or sintering the material. Binding can comprise chemical bonding. Chemical bonding can comprise covalent bonding. Examples of 3D printing may include additive printing (e.g., layer by layer printing, or additive manufacturing). Bonding may utilize an adhesive. Bonding may comprise embedding one material in another (e.g., in a matrix formed by another material). 3D printing may include layered manufacturing (e.g., layer-wise deposition). 3D printing may include rapid prototyping. 3D printing may include solid freeform fabrication. The 3D printing may include binding pre-transformed material with a binder (e.g., polymer or resin). The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise Laser Metal Deposition (LMD, also known as Laser Deposition Welding) or Laser Engineered Net Shaping (LENS). 3D printing methodologies can comprise powder feed or wire deposition. 3D printing methodologies may comprise forming a green body. 3D printing methodologies may comprise a binder that binds pre-transformed material (e.g., binding a powder). The binder may remain in the 3D object, or may be (e.g., substantially) released from the 3D printing (e.g., by heating, extracting, evaporating, and/or burning).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

“Pre-transformed material,” as understood herein, is a material before it has been first transformed (e.g., once transformed) by an energy beam during the formation (e.g., printing) of one or more 3D objects. The pre-transformed material may be a material that was, or was not, transformed prior to its use in the 3D printing process. The pre-transformed material may be a material that was partially transformed prior to its use in the 3D printing process. The pre-transformed material may be a starting material for the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The FLS of the formed (e.g., printed) 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 meter (m), 2 m, 3 m, 4 m, 5 m, 10 m, 50 m, 80 m, 100 m or 1000 m. In some cases, the FLS of the printed 3D object may be between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some embodiments, the forming process comprises layer-wise material deposition. In some instances, it is desired to control the manner in which at least a portion of a layer of hardened material is formed. The layer of hardened material may comprise a plurality of melt pools. In some instances, it may be desired to control one or more characteristics of the melt pools that form the layer of hardened material. The characteristics may comprise a depth of a melt pool, a microstructure, or the repertoire of microstructures of the melt pool. The microstructure of the melt pool may comprise the grain (e.g., crystalline and/or metallurgical) structure, or grain structure repertoire that makes up the melt pool. The grain structure may be referred to herein as microstructure.

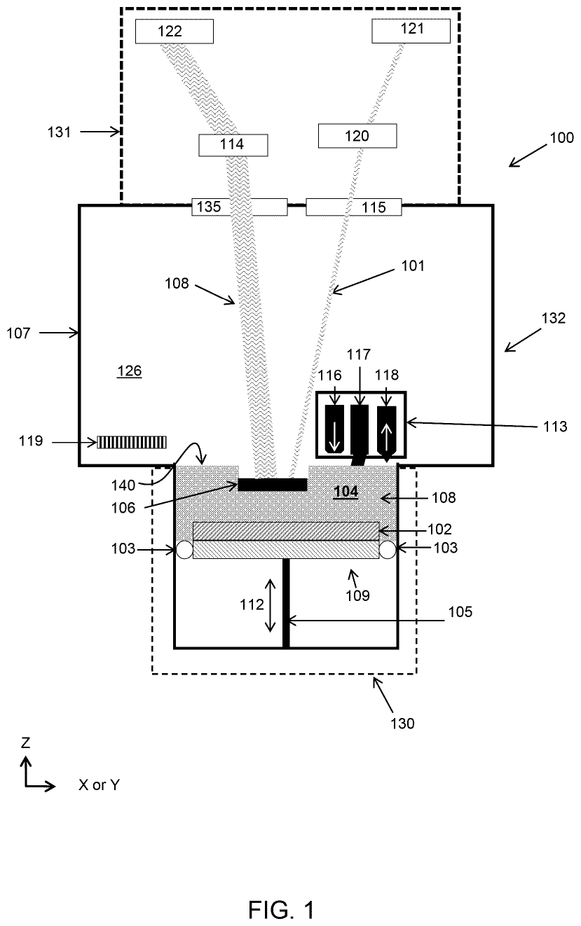

In some embodiments, forming the 3D object comprises transformation of a pre-transformed material into a transformed material. In some embodiments, transforming comprises heating at least a portion of a target surface (e.g., exposed surface of a material bed), and/or a previously formed area of hardened material using at least one energy source. The energy source may generate heat sufficient to effect the transformation via control of a pressure at which the pre-transformed material is subjected. The forming of the 3D object may be at a pressure. The pressure may comprise a pressure wave (e.g., a sound wave) or static pressure. The energy source may generate an energy beam. The energy source may be a radiative energy source. The energy source may be a dispersive energy source (e.g., a fiber laser). The energy source may generate a substantially uniform (e.g., homogenous) energy stream. The energy source may comprise a cross section (e.g., or a footprint) having a (e.g., substantially) homogenous fluence. The energy beam may have a spot size (e.g., footprint or cross-section) on a target surface. The energy generated for transforming a portion of material (e.g., pre-transformed or transformed) by the energy source will be referred herein as the “energy beam.” The energy beam may heat a portion of a 3D object (e.g., an exposed surface of the 3D object). The energy beam may heat a portion of the target surface (e.g., an exposed surface of the material bed, and/or a deeper portion of the material bed that is not exposed). The target surface may comprise a pre-transformed material, a partially transformed material and/or a transformed material. The target surface may comprise a portion of the build platform, for example, a base (e.g., FIG. 1, 102). The target surface may comprise a (surface) portion of a 3D object. The heating by the energy beam may be substantially uniform across its footprint on the target surface. In some embodiments, the energy beam takes the form of an energy stream emitted toward the target surface in a step and repeat sequence (e.g., tiling sequence). The energy profile of the energy beam footprint may correspond to a Gaussian or a top hat. The energy beam may advance along a trajectory. The energy beam may advance continuously, in a pulsing sequence, or in a step- and repeat sequence (e.g., tiling sequence). The energy source may comprise an array of energy sources, e.g., a light emitting diode (LED) array.

In some embodiments, the methods, systems, apparatuses, and/or software disclosed herein comprises controlling at least one characteristic of the layer of hardened material (or a portion thereof) that is part of the 3D object. The methods, systems, apparatuses, and/or software disclosed herein may comprise controlling the degree of 3D object deformation and/or its material properties. The control may be an in-situ and/or real-time control. The control may be during formation of at least a portion of the 3D object. The control may comprise a closed loop or an open loop control scheme. The at least the portion of the 3D object may be a surface, a layer, a plurality (e.g., multiplicity) of layers, a portion of a layer, and/or a portion of a plurality of layers. The layer of hardened material of the 3D object may comprise a plurality of melt pools. The characteristics of the layer may comprise planarity, curvature, or radius of curvature of the layer (or a portion thereof). The characteristics may comprise the thickness of the layer (or a portion thereof). The characteristics may comprise the smoothness (e.g., planarity) of the layer (or a portion thereof).

In some embodiments, a 3D forming (e.g., printing, or print) cycle refers to printing one or more 3D objects in a 3D printer, e.g., using one printing instruction batch. A 3D printing cycle may include printing one or more 3D objects above a (e.g., single) platform and/or in a material bed. A 3D printing cycle may include printing all layers of one or more 3D objects in a 3D printer. On the completion of a 3D printing cycle, the one or more objects may be removed from the 3D printer (e.g., by sealing and/or removing a build module from the printer) in a removal operation (e.g., simultaneously). During a printing cycle, the one or more objects may be printed (a) in the same material bed, (b) above the same platform, (c) with the same printing system, (d) at the same time span, (e) using the same forming (e.g., printing) instructions, or (f) any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle (e.g., within a material bed). In some embodiments, at least two layers of a print cycle within a material bed have different layer heights. A printing cycle may comprise a collection (e.g., sum) of print operations. A print operation may comprise a print increment (e.g., formation of a layer as part of the 3D object, e.g., deposition of a layer and transformation of a portion thereof to form at least part of the 3D object). A printing cycle (also referred to herein as “build cycle”) may comprise one or more printing-laps (e.g., the process of forming a printed layer in a layerwise deposition to form the 3D object). The printing-lap may be referred to herein as “build-lap” or “print increment.” In some embodiments, a printing cycle comprises one or more printing laps. The 3D printing lap may correspond with (i) depositing a (planar) layer of pre-transformed material (e.g., as part of a material bed) above a platform, and (ii) transforming at least a portion of the pre-transformed material (e.g., by at least one energy beam) to form a layer of a 3D objects above the platform (e.g., in the material bed). The printing cycle may comprise a plurality of laps to layerwise form the 3D object. The 3D printing cycle may correspond with (1) depositing a pre-transformed material toward a platform, and (II) transforming at least a portion of the pre-transformed material (e.g., by at least one energy beam) at or adjacent to the platform to form one or more 3D objects above the platform at the same time-window. An additional sequential layer (or part thereof) can be added to a previous layer of a 3D object by transforming (e.g., fusing and/or melting) a fraction of pre-transformed material that is introduced (e.g., as a pre-transformed material stream) to the prior-formed layer. At times, the platform supports a plurality of material beds and/or a plurality of 3D objects. One or more 3D objects may be formed in a single material bed during a printing cycle (e.g., one or more print jobs). The transformation may connect transformed material of a given layer (e.g., formed during a printing lap) to a previously formed 3D object portion (e.g., of a previous printing lap). The transforming operation may comprise utilizing a transforming agent (e.g., an energy beam, a pressure source, or a binder dispenser) to transform the pre-transformed (or re-transform the transformed) material. In some instances, the transforming agent (e.g., energy beam) is utilized to transform at least a portion of the material bed (e.g., utilizing any of the methods described herein).

In some embodiments, at least one (e.g., each) energy source of the 3D forming (e.g., printing) system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr).

In some embodiments, a transforming agent is dispensed through a material dispenser (e.g., binding dispenser). The dispenser may be any dispenser disclosed herein. The dispenser can be controlled (e.g., manually and/or automatically). The automatic control may be using one or more controllers that are operatively coupled to at least one component of the dispenser. The one or more controllers may comprise respective one or more electric circuits (e.g., electrical circuitry). The electrical circuitry may connect one or more controllers to a component that is controlled by the one or more controllers. The one or more controllers may comprise respective one or more signal transmitters and/or receivers. The signals may connect a controller to a component that is controlled by the controller (e.g., via signal communication). The component may comprise a signal transmitter and/or receiver. The control may be before, during, and/or after the forming (e.g., printing) of the at least one 3D object. The dispenser may be translated using an actuator. The translation of the dispenser can utilize a scanner (e.g., an XY stage). In some embodiments, the at least one 3D object is printed using a plurality of dispensers. In some embodiments, at least two dispensers dispense the same type of binder (e.g., comprising a binding agent). In some embodiments, at least two dispensers each dispense a different type of binder. In some embodiments, a binding agent is a polymer or resin. The binding agent can be organic or inorganic. The binding agent can be carbon based or silicon based.

In some embodiments, the forming device may comprise an energy source. In some embodiments, the forming process may utilize an energy beam. In some embodiments, the energy source is movable such that it can translate across (e.g., laterally) the top surface of the material bed, e.g., during the printing. The energy beam(s) and/or energy source(s) can be moved via at least one guidance system. The guidance system may comprise a (e.g., galvanometer) scanner. The scanner may comprise a galvanometer scanner, a moving (e.g., rotating) polygon, a mechanical-stage (e.g., X-Y stage), a piezoelectric device, a gimbal, or any combination of thereof. The scanner may comprise a (e.g., polygonal) mirror. The scanner may comprise a modulator. The scanner may be the same for at least two energy sources and/or beams. In some embodiments, at least two (e.g., each) energy sources and/or beams may have a separate scanner. At least two scanners may be operably coupled with a single energy source and/or energy beam. The systems and/or apparatuses disclosed herein may comprise one or more shutters (e.g., safety shutters). The energy source(s) may project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle).

At times, at least one energy source is modulated (e.g., during formation of the 3D object). The energy (e.g., beam) emitted by the energy source can be modulated. The modulator can comprise an amplitude modulator, a phase modulator, or polarization modulator. The modulation may affect (e.g., alter) the energy (e.g., beam). The modulation may be external to the energy source (e.g., external modulation such as external light modulator). The modulation may alter the intensity of the energy (e.g., beam). The modulation may alter the current supplied to the energy source (e.g., direct modulation). The modulator can comprise an aucusto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam.

The scanner can be included in an optical system that is configured to direct energy from the energy source to a predetermined position on the (target) surface (e.g., exposed surface of the material bed). At least one controller can be programmed to control a trajectory of the energy beam(s) (e.g., respectively), e.g., with the aid of the optical system. The controller can regulate a supply of energy generated by the energy source, e.g., and transmitted to the pre-transformed material (e.g., at the target surface) to form a transformed material. The optical system may comprise one or more optical components (e.g., mirror, lens, prism, collimator, optical window, filter, or beam splitter). The optical system may be enclosed in an optical enclosure. Examples of an optical enclosure and/or system can be found in Patent Application serial number PCT/US17/64474, titled “OPTICS, DETECTORS, AND THREE-DIMENSIONAL PRINTING” that was filed Dec. 4, 2017, or in Patent Application serial number PCT/US18/12250, titled “OPTICS IN THREE-DIMENSIONAL PRINTING” that was filed Jan. 3, 2018, each of which is incorporated herein by reference in its entirety.

The energy beam (e.g., transforming energy beam) may comprise a Gaussian energy beam. The energy beam may have any cross-sectional shape comprising an ellipse (e.g., circle), or a polygon. The energy beam may have a cross section (e.g., at an intersection of the energy beam on a target surface) with a FLS of at least about 20 μm, 50 μm, 75 μm, 100 μm, 150 μm, 200 μm or 250 μm, 0.3 millimeters (mm), 0.4 mm, 0.5 mm, 0.8 mm, 1 mm, 1.5 mm, 2 mm, 2.5 mm, 3 mm, 3.5 mm, 4 mm, 4.5 mm, or 5 mm. The cross section of the energy beam may be any value of the afore-mentioned values (e.g., from about 50 μm to about 250 μm, from about 50 μm to about 150 μm, from about 150 μm to about 250 μm, from about 0.2 mm to about 5 mm, from about 0.2 mm to about 2.5 mm, or from about 2.5 mm to about 5 mm). The FLS may be measured at full width half maximum intensity of the energy beam. The FLS may be measured at 1/e² intensity of the energy beam. In some embodiments, the energy beam is a focused energy beam at the target surface. In some embodiments, the energy beam is a defocused energy beam at the target surface. The energy profile of the energy beam may be (e.g., substantially) uniform (e.g., in the energy beam's cross-sectional area that impinges on the target surface). The energy profile of the energy beam may be (e.g., substantially) uniform during an exposure time (e.g., also referred to herein as a dwell time). The exposure time (e.g., at the target surface) of the energy beam may be at least about 0.1 milliseconds (ms), 0.5 ms, 1 ms, 10 ms, 50 ms, 100 ms, 200 ms, 500 ms, 1000 ms, 2500 ms, or 5000 ms. The exposure time may be between any of the above-mentioned exposure times (e.g., from about 0.1 ms to about 5000 ms, from about 0.1 ms to about 1000 ms, or from about 1000 ms to about 5000 ms). In some embodiments, the energy beam is configured to be continuous or non-continuous (e.g., pulsing), e.g., during its translation across the target surface. In some embodiments, at least one energy source can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of a value between the afore-mentioned values (e.g., from about 50 J/cm² to about 5000 J/cm², from about 50 J/cm² to about 2500 J/cm², or from about 2500 J/cm² to about 5000 J/cm²). In some embodiments, the power density (e.g., power per unit area) of the energy beam is at least about 100 Watts per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm2, 7000 W/mm², 8000 W/mm², 9000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the energy beam may be any value between the aforementioned values (e.g., from about 100 W/mm² to about 100000 W/mm², about 100 W/mm² to about 1000 W/mm², or about 1000 W/mm² to about 10000 W/mm², from about 10000 W/mm² to about 100000 W/mm², from about 10000 W/mm² to about 50000 W/mm², or from about 50000 W/mm² to about 100000 W/mm²). The energy beam may emit energy stream towards the target surface in a step and repeat sequence. The target surface may comprise an exposed surface of an energy beam, a previously formed 3D object portion, or a platform.

At times, an energy source provides power at a peak wavelength. For example, an energy source can provide electromagnetic energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. An energy beam can provide energy at a peak wavelength between any value of the afore-mentioned peak wavelength values (e.g., from about 100 nm to about 2000 nm, from about 100 nm to about 1000 nm, or from about 1000 nm to about 2000 nm). The energy source (e.g., laser) may have a power of at least about 0.5 Watt (W), 1 W, 5 W, 10 W, 50 W, 100 W, 250 W, 500 W, 1000 W, 2000 W, 3000 W, or 4000 W. The energy source may have a power between any value of the afore-mentioned laser power values (e.g., from about 0.5 W to about 4000 W, from about 0.5 W to about 1000 W, or from about 1000 W to about 4000 W).

At times, an energy beam is translated across a surface (e.g., target surface) at a given rate (e.g., a scanning speed), e.g., in a trajectory. The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be any value between the aforementioned values (e.g., from about 50 mm/sec to about 50000 mm/sec, from about 50 mm/sec to about 3000 mm/sec, or from about 3000 mm/sec to about 50000 mm/sec). The energy beam may be continuous or non-continuous (e.g., pulsing). The energy profile of the energy beam may be (e.g., substantially) uniform during the exposure time (e.g., also referred to herein as dwell time). The exposure time (e.g., at the target surface) of the energy beam may be at least about 0.1 milliseconds (ms), 0.5 ms, 1 ms, 10 ms, 50 ms, 100 ms, 500 ms, 1000 ms, 2500 ms, or 5000 ms. The exposure time may be any value between the above-mentioned exposure times (e.g., from about 0.1 ms to about 5000 ms, from about 0.1 ms to about 1000 ms, or from about 1000 ms to about 5000 ms). The exposure time (e.g., irradiation time) may be the dwell time. The dwell time may be at least 1 minute, or 1 hour.

In some embodiments, the at least one 3D object is formed (e.g., printed) using a plurality of transforming agents (e.g., energy beams and/or energy sources). At times, at least two transforming agents (e.g., energy sources) may have at least one characteristic value in common with each other. At times, at least two energy sources may have at least one characteristic value that is different from each other. Characteristics of the transforming agent may comprise transformation density (or transformation strength), trajectory, FLS of a footprint on the target surface, hatch spacing, scan speed, focus, defocus, scanning scheme, or energy density distribution at the target surface. The transformation density may refer to the volume or weight of material transformed in a given time by the transforming agent. The FLS of a footprint on the target surface may refer to the FLS of the energy beam on the target surface, of a (e.g., binder) stream dispensed on the target surface, and/or a stream (e.g., wire) of pre-transformed material dispensed on the target surface. Characteristics of the energy beam may comprise wavelength, power density, amplitude, trajectory, FLS of a footprint on the target surface, intensity, intensity distribution, energy, energy density, energy density distribution, fluence, Andrew Number, hatch spacing, scan speed, scanning scheme, or charge. The scanning scheme may comprise a continuous, pulsed or tiling scanning scheme. The charge can be electrical and/or magnetic charge. Andrew number is proportional to the power of the irradiating energy over the multiplication product of its velocity (e.g., scan speed) by a hatch spacing. The Andrew number is at times referred to as the area filling power of the irradiating energy. In some embodiments, at least two energy source(s) and/or beam(s) can be translated at different rates (e.g., velocities).

In some embodiments, the methods, systems, software, and/or apparatuses disclosed herein comprise at least one transforming agent generator. The transforming agent generator may comprise an energy source or a dispenser. The transforming agent may comprise an energy beam or a binder. In some cases, the system can comprise 1, 2, 3, 4, 5, 6, 7, 8, 9, 10, 30, 100, 300, 1000 or more transforming agent generators. For example, one or more dispensers can be direct binding materials (e.g., binders) onto the target surface. The binder may comprise an organic or an inorganic material. One or more energy sources can be direct energy beam(s) onto the target surface. One or more transforming agent generators can be directed onto the target surface. The system can comprise an array of transforming agent generators. Alternatively or additionally, the target surface, material bed, 3D object (or part thereof), or any combination thereof, may be heated by a heating member comprising a lamp (e.g., a focused lamp), heating rod, or radiator (e.g., a panel radiator). The heating member may comprise an energy beam.

In some embodiments, the at least one energy source is a single (e.g., first) energy source. In some embodiments, the at least one energy source is a plurality of energy sources. An energy source can be a source configured to deliver energy to an area (e.g., a confined area). An energy source can deliver energy to the confined area through radiative heat transfer. The energy beam may comprise a radiation comprising an electromagnetic or charged particle beam. The energy beam may comprise a radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy source may include a laser source. The laser source may comprise a Nd:YAG, Neodynium (e.g., neodymium-glass), or an Ytterbium laser. The laser may comprise a carbon dioxide laser (CO₂ laser).

A guidance system and/or a transforming agent generator (e.g., an energy source) may be controlled manually and/or by at least one controller. For example, at least two guidance systems may be directed by the same controller. For example, at least one guidance system may be directed by its own (e.g., unique) controller. A plurality of controllers may be operatively coupled to each other, to the guidance system(s) (e.g., scanner(s)), and/or to the energy source(s). At least two of a plurality of energy beams may be directed towards the same position at the target surface, or to different positions at the target surface. The one or more guidance systems may be positioned at an angle (e.g., tilted) with respect to the target surface. The guidance system may comprise an actuator or an optical element. One or more sensors may be disposed adjacent to the target surface. At least one of the one or more sensors may be disposed to have an indirect view of the target surface. At least one of the one or more sensors may be disposed to have a direct view of the target surface (e.g., a camera viewing the target surface). The one or more sensors may be configured to have a field of view of at least a portion of the target surface (e.g., an exposed surface of the material bed).

FIG. 1 shows an example of a 3D forming (e.g., 3D printing) system 100 (also referred to herein as “3D printer”) and apparatuses, including a (e.g., first) energy source 121 that emits a (e.g., first) energy beam 101 and a (e.g., second) energy source 122 that emits a (e.g., second) energy beam 108. In some embodiments, at least two energy beams of a 3D printing system may be overlapping (e.g., at a target surface of the 3D printing system). In the example of FIG. 1 the energy from energy source 121 travels through an (e.g., first) guidance system 120 (e.g., comprising a scanner) and an optical window 115 to be incident upon a target surface 140 within an enclosure 126 (e.g., comprising an atmosphere). The enclosure can comprise one or more walls that enclose the atmosphere. The target surface may comprise at least one layer of pre-transformed material (e.g., FIG. 1, 108) that is disposed adjacent to a platform (e.g., FIG. 1, 109). Adjacent can be above. In some embodiments, an elevator shaft (e.g., FIG. 1, 105) is configured to facilitate movement of the platform (e.g., vertically; FIG. 1, 112). The enclosure (e.g., 132) may including sub-enclosures comprising an optical chamber (e.g., 131), a processing chamber (e.g., 107), and a build module (e.g., 130). The sub-enclosures (e.g., chambers) may be reversibly detachable from each other, e.g., manually and/or automatically (e.g., using at least one controller). The chamber wall(s) may include any material disclosed herein (e.g., (e.g., elemental metal, metal alloy, an allotrope of elemental carbon, ceramic, a polymer, a resin, or glass). The platform may be separated from one or more walls (e.g., side walls) of the build module by a seal (e.g., FIG. 1, 103). The guidance system of the energy beam may comprise an optical system comprising one or more optical elements. FIG. 1 shows the energy from the energy source 122 travels through an optical system 114 (e.g., comprising a scanner) and an optical window 135 to impinge (e.g., be incident) upon the target surface 140. The energy from the (e.g., plurality of) energy source(s) may be directed through the same optical system and/or the same optical window. At times, energy from the same energy source is directed to form a plurality of energy beams by one or more optical systems. The target surface may comprise a (e.g., portion of) hardened material (e.g., FIG. 1, 106) formed via transformation of pre-transformed material in a material bed (e.g., FIG. 1, 104). In the example of FIG. 1, a layer forming device 113 includes a (e.g., powder) dispenser 116, a leveler 117, and material removal mechanism 118. During printing, the 3D object (e.g., and the material bed) may be supported by a (e.g., movable) platform, which platform may comprise a base (e.g., FIG. 1, 102). The base may be detachable (e.g., after the printing). A hardened material may be anchored to the base (e.g., via supports and/or directly), or non-anchored to the base (e.g., floating anchorlessly in the material bed, e.g., suspended in the material bed). An optional thermal control unit (e.g., FIG. 1, 119) can be configured to maintain a local temperature (e.g., of the material bed and/or atmosphere). In some cases, the thermal control unit comprises a (e.g., passive or active) heating member. In some cases, the thermal control unit comprises a (e.g., passive or active) cooling member. The thermal control unit may comprise or be operatively coupled to a thermostat. The thermal control unit can be provided inside of a region where the 3D object is formed or adjacent to (e.g., above) a region (e.g., within the processing chamber atmosphere) where the 3D object is formed. The thermal control unit can be provided outside of a region (e.g., within the processing chamber atmosphere) where the 3D object is formed (e.g., at a predetermined distance).

In some embodiments, an optical system through which an energy beam travels can be disposed within the enclosure, outside of the enclosure, or within at least one wall of the enclosure. For example, an optical window of an optical system may be disposed in at least one wall of the enclosure (e.g., as in FIGS. 1, 135 and 115). In some embodiments, at least a portion of the optical system is disposed in its own (optical) enclosure (e.g., FIG. 1, 131). The optical enclosure may optionally be (e.g., operatively and/or physically) coupled with the processing chamber. Examples of an optical mechanism and any of its components (e.g., including an optical enclosure and/or optical window) can be found in patent application number PCT/US17/60035, titled “GAS FLOW IN THREE-DIMENSIONAL PRINTING” that was filed on Nov. 3, 2017, or in Patent Application serial number PCT/US18/12250, each of which is incorporated herein by reference in its entirety.

In some embodiments, the target surface is detected by a detection system. The detection system may comprise at least one sensor. The detection system may comprise a light source operable to illuminate a portion of the 3D forming (e.g., printing) system enclosure (e.g., the target surface). The light source may be configured to illuminate onto a target surface. The illumination may be such that objects in the field of view of the detector are illuminated with (e.g., substantial) uniformity. For example, sufficient uniformity may be uniformity such that at most a threshold level (e.g., 25 levels) of variation in grayscale intensity exists (for objects), across the build plane. The illumination may comprise illuminating a map of varied light intensity (e.g., a picture made of varied light intensities). Examples of illumination apparatuses include a lamp (e.g., a flash lamp), a LED, a halogen light, an incandescent light, a laser, or a fluorescent light. The detection system may comprise a camera system, CCD, cmOS, detector array, a photodiode, or line-scan CCD (orcmOS). Examples of a control system, detection system and/or illumination can be found in U.S. patent application Ser. No. 15/435,090, titled “ACCURATE THREE-DIMENSIONAL PRINTING” that was filed Feb. 16, 2017, which is incorporated herein by reference in its entirety.

In a forming process (e.g., 3D printing), a requested 3D object can be formed (e.g., printed) according to forming (e.g., printing) instructions. The forming instructions may at least in part consider a (e.g., geometric) model of a requested 3D object. The geometric model may be a virtual model (e.g., a computer-generated model of the 3D object). For example, the geometric model may comprise a CAD model. The geometric model may be a virtual representation of the geometry and/or the topology of the 3D object (e.g., in the form of 3D imagery). In some cases, a geometric model corresponds to an image (e.g., scan) of an object (e.g., a real object such as a test object). The image may be a scan image.

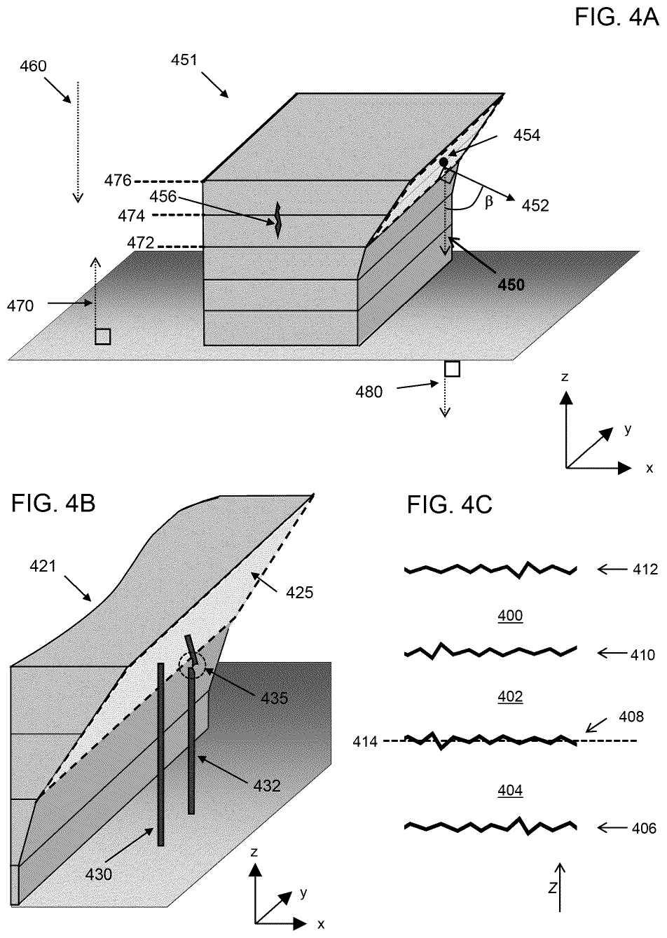

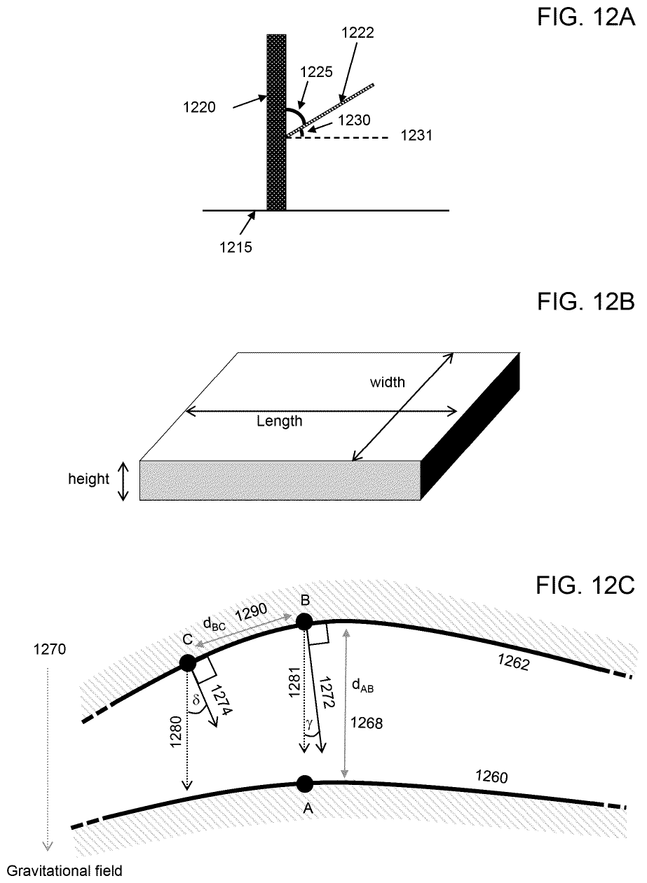

In some embodiments, a model of a 3D object is arranged (e.g., divided) into a number of constituent portions (e.g., virtual slices). A slice of a 3D model may correspond to a (e.g., planar) section of the 3D model. The (e.g., planar) slice may defined by a top surface, a bottom surface, and a thickness (e.g., where top and bottom are with respect to a global vector). A thickness of a slice may correspond with a layer height (e.g., thickness) of the formed 3D object (e.g., FIG. 12B). The 3D model may be organized into a plurality of (e.g., neighboring) slices. For example, a plurality of slices may be arranged such that a top surface of a first slice is adjacent to (e.g., juxtaposed with) a bottom surface of a neighboring slice that is above the first slice (e.g., above with respect to a global vector) (e.g., slices that would correspond to layers 472 and 474 in FIG. 4A). The first slice may be directly adjacent to the second slice. For example, the first slice may contact the second slice. In some embodiments, a (e.g., corresponding) virtual slice exists for each layer of the physically formed 3D object that is formed additively in a layer-wise manner.

At times, 3D forming (e.g., printing) comprises one or more forming (e.g., printing) instructions (e.g., embodied in a computer-readable medium). The forming instructions, when executed, may cause a (e.g., suitable) manufacturing (e.g., 3D printing) device to perform a series of operations. The series of operations may cause additive formation of the 3D object. The forming instructions may divide the formation of a physical 3D object into a series of physical layers (e.g., layers made of transformed material). The series of physical layers may correspond to a series of virtual slices of a geometric model. In some embodiments, each slice of a geometric model comprises an associated (e.g., set of) printing instruction of a printing lap. In some embodiments, printing operations comprise (i) depositing a first (e.g., planar) layer of pre-transformed material as part a material bed, and (ii) directing an energy beam towards a first portion of the first layer of pre-transformed material to form a first transformed material. In some embodiments, the printing operations comprise (i) depositing a first (e.g., planar) layer of pre-transformed material as part a material bed, and (ii) directing a transforming agent (e.g., an energy beam or a binding agent) towards a first portion of the first layer of pre-transformed material to form a first transformed material. The transformed material may be a portion of the 3D object. The transformed material may be hardened into a hardened (e.g., solid) material as part of the 3D object. The transformed material may comprise pre-transformed material that are connected (e.g., using a binding agent, through chemical bonding such as utilizing covalent bonds, and/or by sintering). The transformed material may be embedded in a matrix (e.g., formed by a binding agent such as glue). Optionally, this process may be repeated layer by layer deposition, or layerwise deposition. Another layer may be formed, for example, by adding a second (e.g., planar) layer of pre-transformed material, directing a transforming agent (e.g., an energy beam, a chemically reactive species, or a binding agent) toward a second portion of the second layer of pre-transformed material to form a second transformed material according to forming instructions of a second slice in the (e.g., geometric) computer model of the 3D object. A dispenser may deposit the binder and/or the reactive species, e.g., through an opening in the dispenser. An energy source may generate the energy beam. A dispenser may deposit the pre-transformed material, e.g., to form the material bed. In some embodiments, the 3D object is formed in a material bed. The material bed (e.g., powder bed) may comprise flowable material (e.g., powder) during the forming process. During formation of the one or more 3D objects, the material bed may exclude a pressure gradient. In some examples, the 3D object (or a portion thereof) may be formed in the material bed with diminished number of auxiliary supports and/or spaced apart auxiliary supports (e.g., spaced by at least about 2, 3, 5, 10, 40, or 60 millimeters). In some examples, the 3D object (or a portion thereof) may be formed in the material bed without being anchored (e.g., to the platform). For example, the 3D object may be formed without auxiliary supports.

In some examples the 3D object may be formed above a platform, without usage of a material bed. The 3D printing cycle may correspond with (I) depositing a pre-transformed material toward the platform, and (II) transforming at least a portion of the pre-transformed material (e.g., by at least one energy beam) at or adjacent to the platform (e.g., during deposition of the pre-transformed material towards the platform) to form one or more 3D objects disposed above the platform. An additional sequential layer (or part thereof) can be added to the previous layer of a 3D object by transforming (e.g., fusing and/or melting) a fraction of pre-transformed material that is introduced (e.g., as a pre-transformed material stream) to the prior-formed layer. The depositing in operation (1) and the transforming in operation (II) may comprise a print increment. A dispenser may deposit the pre-transformed material, e.g., through an opening of the dispenser.

In some embodiments, forming instructions for forming (e.g., a given layer of) the 3D object(s) may comprise the utilization (e.g., selection) of one or more 3D forming (e.g., printing) procedures. A forming procedure may comprise a forming feature (e.g., an auxiliary support) or a forming process (e.g., of a plurality of forming processes). The particular forming procedure(s) (e.g., of a plurality of forming procedures) that is used to generate a given portion of the (e.g., layer of) the 3D object may consider the geometry of the 3D object. For example, the particular forming procedure that is used may consider: (i) a position of the given portion (e.g., with respect to a geometry of the 3D object(t), (ii) an angle of the given portion (e.g., of a normal vector at a surface of the 3D object, with respect to a global vector), (iii) an intended use of the given portion (e.g., according to an intended use of the requested 3D object), (iv) a requested (e.g., surface) characteristic of the given portion (e.g., a surface roughness or a dimensional accuracy), and/or (v) a requested material property of the given portion. The particular forming procedure(s) that is/are used to generate a given portion of the 3D object may be selected manually and/or automatically. A forming (e.g., printing) procedure that is (e.g., initially) automatically selected to generate a given portion of the 3D object may be referred to herein as a “default forming procedure.”

In some embodiments, a forming instructions engine (e.g., module and/or program) comprises code for generation of default forming instructions for a (e.g., each) virtual slice of a virtual geometric model. In some embodiments, the forming instructions engine considers (e.g., manual and/or automatic) selection of at least one forming process (e.g. of a plurality of forming processes) for a (e.g., each) virtual slice or slice portion. The slice portion may comprise a slice edge, or slice interior. The plurality of forming processes may comprise hatching, tiling, forming globular melt pools, forming high aspect ratio melt pools, re-transforming, annealing, or pre-heating. Examples of forming processes can be found in Patent Application serial number PCT/US18/20406, titled “THREE-DIMENSIONAL PRINTING OF THREE-DIMENSIONAL OBJECTS” that was filed Mar. 1, 2018, which is incorporated herein by reference in its entirety.

In some examples, the method, systems and/or apparatus may comprise a controller. The controller may comprise an electrical circuitry, a programmable logic device, a signal generator, a signal receiver, or a (e.g., embedded) software. The controller may be operatively coupled to a component of a forming system. Operative coupling may comprise physical coupling (e.g., direct physical coupling, or signal-based coupling). The physical coupling may comprise one or more wires (e.g., electrical wires). The signal-based coupling may comprise wireless coupling. The signal may comprise an electrical, magnetic, optical, or audio signal. In some instances, the software may be separated (e.g., disconnected) from the controller. In some instances, the software may be an integral part of the controller. The software may generate a sequence of events (e.g., printing instructions). The software may be embedded in a non-transitory media, e.g., a non-transitory computer readable media (e.g., hardware). The forming instructions may be a logical sequence of events. The software may generate the forming instructions according to a plan. The plan may comprise a procedure, a design, a scheme, a planning sequence, or an algorithm. The software may consider process build parameters (e.g., real-time and/or historical). The software may consider an (e.g., thermal) analysis of a material bed and/or of the 3D object (e.g., hardened material of the forming or previously formed 3D object portion) during and/or after the printing. The (e.g., thermal) analysis may consider the physical properties of the material in (i) the material bed and/or (ii) hardened material. The thermal analysis may consider heat diffusion through the (e.g., forming) 3D object and/or its surrounding (e.g., material bed). The analysis may comprise thermal or mechanical properties. The analysis may comprise physical behavior and/or physical characteristics of various material phases of the pre-transformed and/or transformed material (e.g., solid, liquid, gas, or plasma). The analysis may comprise an interplay between at least two of the material phases. The physical behavior may manifest during and/or after the printing. The physical characteristics may comprise heat capacity, heat conductance, heat response (e.g., expansion), stress response (e.g., contraction), surface tension, flow, or wetting. The thermal analysis may comprise dissipation of heat through the pre-transformed and/or transformed material (e.g., as part of the at least a portion of the printed 3D object).

At times, it is requested to assess (e.g., estimate) a likelihood of failure in the forming of (e.g., at least a portion of) a 3D object. A failure can comprise: (I) a defect in at least a portion of the 3D object; and/or (II) a malfunction in a device operating to form the 3D object. A defect may comprise: (i) a deformation (e.g., a protrusion of hardened material from an exposed surface of a material bed), (ii) a rupture, crack, tear, or dislocation in the 3D object, at least one auxiliary support, and/or border between the 3D object and the auxiliary support(s), (iii) a residual stress in the (e.g., completed, or being formed) 3D object that is beyond a threshold level, (iv) a failure of the 3D object to meet at least one (e.g., design) requirement (e.g., a deviation from an intended shape, a deviation in a material phase and/or material porosity), or (v) a failure of the 3D object to operate (e.g., perform) for its intended purpose. A malfunction may comprise damage to the device that is operating to form the 3D object. For example, damage to an energy source, a material dispenser, and/or a material planarizer (e.g., re-coater) of a forming system.

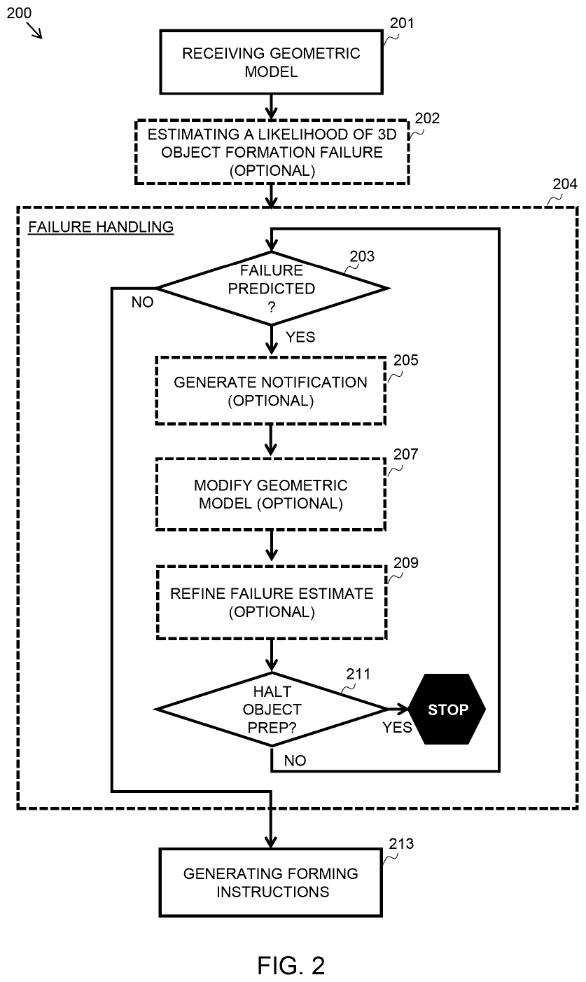

In some embodiments, a sequence of actions directed by a forming instructions engine is represented as a flowchart. The software may generate the flowchart. The flowchart may be a representation of a logic flow diagram. The flowchart may be a plan. FIG. 2 shows an example of a flowchart 200 depicting operations of a forming procedure comprising generating forming instructions from a model of a 3D object. In the example of FIG. 2, at operation 201 a geometric model of one or more requested 3D objects is received (e.g., by a controller and/or software). The geometric model may include a requested geometry of a 3D object. The geometry may include dimensions of the one or more objects. The requested geometry may comprise (e.g., pre-determined) dimensions of the 3D object (e.g., as requested by a customer and/or user). The geometric model may be a virtual model (e.g., a computer-generated model). The virtual model may include data representing a surface and/or a volume of a requested 3D object (e.g., represented as a point cloud or a computer-aided design (“CAD”) data file). The virtual model may reference any coordinate system. For example, a coordinate system may be cartesian, polar, cylindrical, or spherical. The coordinate system may be homogenous. The virtual model may be in the form of a virtual file (e.g., a CAD or an Additive Manufacturing file Format (“AMF”)). The example of FIG. 2 depicts an optional operation 202 of estimating a likelihood of 3D object formation failure, an optional failure handling operation 204, and an operation 213 for generating forming (e.g., printing) instructions. The instructions may include instructions for forming (e.g., multiple layers of) the one or more 3D objects. The instructions may comprise instructing at least one characteristic of: a transforming agent (e.g., an energy beam, a pressure source, or a binder dispenser); an energy source; at least one component of an optical system; a platform; any component of a dispenser (e.g., a layer dispensing mechanism); any component of a gas flow mechanism, of a 3D forming (e.g., printing) system; or any combination thereof.

In the example shown in FIG. 2, failure handling comprises an operation 203 for determining whether a formation failure is predicted (e.g., estimated, calculated, and/or analyzed). In some embodiments, one or more actions may be performed in response to a predicted failure. The response to a predicted failure may comprise: (i) a generated notification (e.g., FIG. 2, optional operation 205), (ii) a (e.g., suggested) modification to the 3D object (e.g., geometric model) (e.g., FIG. 2, optional operation 207), or (iii) a refinement to the failure estimate (e.g., FIG. 2, optional operation 209). In some embodiments, a determination of whether to halt preparation for forming the 3D object is made in response to a predicted failure (e.g., FIG. 2, operation 211). For example, preparation for forming the 3D object may be halted if a forming device malfunctions during the object formation (e.g., damage to a forming device apparatus or component may occur). In the example shown in FIG. 2, the sequence returns to the failure determination at operation 203 if object preparation is not halted. For example, the sequence may return to the operation 203 following a modification to the (e.g., model of the) 3D object and/or a refinement of a failure estimate. In some embodiments, in the case that a failure is not predicted (e.g., FIG. 2, 203), a sequence of operations continues with generating forming instructions (e.g., FIG. 2, operation 213).

In some embodiments, estimating a likelihood of 3D object formation failure comprises providing analysis (e.g., in the form of feedback) regarding the failure estimate. The analysis may comprise identification of region(s) of the (e.g., geometric model of the) 3D object that are estimated to be at an increased risk (e.g., above a threshold) of formation failure. The (e.g., failure estimate) analysis may be provided before, during, and/or after generating the forming instructions. The analysis comprising the (e.g., increased failure risk) region(s) of the 3D object may comprise an indication (e.g., highlighted and/or outlined portion) on a (e.g., displayed) geometric model of the 3D object. The indication may comprise a named (e.g., labeled) portion of the (e.g., geometric model of the) 3D object. In some embodiments, the region(s) of increased risk are identified while considering (i) at least one object feature (e.g., overhang width and/or length, and/or cavity ceiling), (ii) auxiliary support structure(s) (e.g., sufficiency of support), (iii) a complexity of the 3D object (e.g., at the identified region), (iv) the requested 3D object material properties and/or (v) the requested material(s) for the 3D object. The requested 3D object material properties may comprise density, porosity, or material phases at one or more portions of the requested 3D object. For example, a complexity of the 3D object may be quantified according to representation of the 3D object as a geometric model. The representation of the 3D object may comprise a skeleton that includes branches, closed geometries (e.g., loops), and/or a medial axis representation.

In some embodiments, at least a portion of a 3D object may be supported (e.g., during its formation) by one or more auxiliary features. The auxiliary feature(s) can be supported by the material (e.g., powder) bed. The term “auxiliary feature” or “support structure” as used herein, generally refers to a feature that is part of a printed 3D object, but is not part of the desired, intended, designed, ordered, requested, or modeled 3D object. Auxiliary feature(s) (e.g., auxiliary support(s)) may provide structural support during and/or subsequent to the formation of the 3D object. The 3D object may have any number of supports. The supports may have any shape and size. In some examples, the supports comprise a rod, plate, wing, tube, shaft, or pillar. In some cases, the supports support certain portions of the 3D object and does not support other portions of the 3D object. In some cases, the supports are (e.g., directly) coupled to a bottom surface the 3D object (e.g., relative to the platform). In some embodiments, the supports are anchored to the platform. In some examples, the supports are used to support portions of the 3D object having a certain (e.g., complex or simple) geometry. The 3D object can have auxiliary feature(s) that can be supported by the material bed (e.g., powder bed) and not touch and/or anchor to the base, substrate, container accommodating the material bed, or the bottom of the enclosure. The 3D part (3D object) in a complete or partially formed state can be completely supported by the material bed (e.g., without touching the substrate, base, container accommodating the powder bed, or enclosure). The 3D object in a complete or partially formed state can be completely supported by the powder bed (e.g., without touching anything except the powder bed). The 3D object in a complete or partially formed state can be suspended anchorlessly in the powder bed, without resting on and/or being anchored to any additional support structures. In some cases, the 3D object in a complete or partially formed (e.g., nascent) state can freely float (e.g., anchorlessly) in the material bed. Auxiliary feature(s) may enable the removal of energy from the 3D object that is being formed.

The 3D object can be formed without auxiliary support and/or without contacting a building platform (e.g., a base, a substrate, or a bottom of an enclosure). The one or more auxiliary features (e.g., which may include a base support) can be used to hold and/or restrain the 3D object (e.g., during its formation). In some cases, one or more auxiliary supports can be used to anchor or hold a 3D object (or a portion thereof) in a material bed. The one or more auxiliary supports (e.g., features) can be specific to a 3D object, or portion thereof. These one or more auxiliary supports may increase the time needed to form the 3D object. The one or more auxiliary features can be removed prior to use and/or distribution of the 3D object. Eliminating the need for one or more auxiliary features can decrease the time and/or cost associated with generating the 3D part. In some examples, the 3D object may be formed with auxiliary features. The 3D object may be formed with or without contact to the container accommodating the material bed (e.g., side(s) and/or bottom of the container). The auxiliary support may contact, and not connect (e.g., anchor) to the container (e.g., the platform).

In some instances, the auxiliary support is a scaffold that encloses the 3D object or part thereof. The scaffold may comprise lightly sintered or lightly fused powder material. In some examples, the 3D object may not be anchored (e.g., connected) to the platform and/or walls that define the material bed (e.g., during formation). At times, the 3D object may not touch (e.g., contact) to the platform and/or walls that define the material bed (e.g., during formation). The 3D object can be suspended (e.g., float) in the material bed. The scaffold may comprise a continuously sintered (e.g., lightly sintered) structure that is at most about 1 millimeter (mm), 2 mm, 5 mm or 10 mm. In some examples, the 3D object may be printed without a supporting scaffold. The supporting scaffold may engulf the 3D object. The supporting scaffold may float in the material bed. The printed 3D object may be printed without the use of auxiliary features, may be printed using a reduced number of auxiliary features, or printed using spaced apart auxiliary features. Examples of an auxiliary support structure can be found in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. The printed 3D object may comprise a single auxiliary support. The single auxiliary feature (e.g., auxiliary support or auxiliary structure) may be a platform (e.g., a building platform such as a base or substrate), or a mold. The auxiliary support may be adhered to the platform or mold. Examples of auxiliary features comprise heat fins, wires, anchors, handles, supports, pillars, columns, frame, footing, scaffold, flange, projection, protrusion, mold, or other stabilization features.

In some embodiments, estimating a likelihood of 3D object formation failure comprises a simulation of (e.g., at least a portion) of the 3D object. The simulation may comprise a prediction of one or more behaviors of the (e.g., material(s) of the) 3D object, during and/or following its formation. A simulation may comprise a thermal, a mechanical, a liquid phase, a gas phase, or any combination thereof, of at least a portion of the forming procedure of the 3D object. The simulation may be of the forming (e.g., printing) process of the requested 3D object. The simulation may correspond to the behavior of the 3D object during its formation (e.g., in its partial and/or growing state) and/or after it has been formed (e.g., during its relaxation from being formed). The simulation may comprise a numerical simulation. The simulation may comprise a finite element, a boundary element, a finite-volume and/or a finite difference analysis. The simulation may comprise simulating one or more physical aspects of a behavior of a transforming and/or transformed material of a (e.g., portion of a) 3D object (e.g., during its formation). In some embodiments, a prediction (e.g., analysis and/or calculation) comprises a predicted change of at least one characteristic of the 3D object resulting from the forming process. At times, the prediction can be calculated using a physics model (e.g., considering one or more physics-based calculations). The physics model (e.g., considering one or more physics-based calculations) can be used to at least partially resolve temporal and/or spatial scales of interest. For example, when the material of a 3D object is being transformed from a pre-transformed material to a transformed material, the transformed and pre-transformed material may be subjected to a different (e.g., higher or lower) temperature. Different types of material (e.g., an elemental metal and/or metal alloy, non-metal, plastic, glass, ceramic, an allotrope of elemental carbon, a polymer, and/or a resin) have different thermo-mechanical characteristics (e.g., expansion and/or contraction). The simulation may consider the geometry, material property, manner of formation, mechanical properties, and thermal properties, of the requested 3D object. The mechanical properties may include a behavior of the printed and/or printing 3D object that include all relevant material phases of the material (e.g., liquid, solid, gas, and plasma). The mechanical properties may comprise stress, strain, or surface tension (e.g., of the liquid phase).

In some embodiments, the physics model (e.g., and associated simulations) comprises calculations of estimated deformation. At times, a (e.g., geometrical) deformation comprises bending, warping, or twisting. The deformation may include a geometric distortion and/or altered material property, with respect to a requested three-dimensional object having one or more geometric requirements (e.g., as to shape and/or tolerances) and/or one or more requested material properties. The deformation may comprise an internal deformation. Internal may be within the 3D object or a portion thereof. The deformation may include a change in the material properties. The deformation may be disruptive (e.g., for the intended purpose of the 3D object). The deformation may comprise a geometric deformation. The deformation may comprise inconsistent material properties. The deformation may occur before, during, and/or after hardening of the transformed material. The deformation may comprise balling, warping, curling, bending, rolling, or external cracking. The geometrical deformation may comprise deviation from at least one requested dimension of the requested 3D object. The deformation in the material properties may comprise density, porosity, dislocation, metallurgical phase, crystal phase, crystal structure, alloy composition, or internal cracking. The estimated deformation may consider the type of material forming the 3D object (e.g., comprising thermo-mechanics or fluid dynamics thereof). For example, the estimated deformation may consider estimated thermal expansion, thermal conductivity, thermal transfer and/or surface tension in the material of the 3D object. The deformation may involve changes due to thermo-mechanical properties of the object. The thermo-mechanical properties may cause changes in a dimension and/or another mechanical property of the 3D object (e.g., due to a temperature change). For example, a change may comprise a microstructure manifestation and/or a change in a porosity of the material. The change(s) may be characteristic of a particular forming process (e.g., of a plurality of forming processes). In some embodiments, the physics model (and associated simulations) comprises calculations of estimated deformation that consider continuum mechanical analyses of the object and/or a forming process by which it is formed. The continuum mechanical analyses may comprise thermo-mechanical and/or fluid dynamic analyses. The material of the 3D object may be in a partially molten or fully molten form (e.g., for at least part of the transformation process). In some embodiments, the physics model (and associated simulations) include calculations of estimated deformation that consider fluid dynamics. In some embodiments, the physics model (and associated simulations) comprises calculations of estimated deformation that consider surface tension of a material (e.g., pre-transformed and/or transformed material). In some embodiments, the physics model (and associated simulations) comprises calculations of estimated deformation that consider gas flow dynamics. The pre-transformed material may be in one form (e.g., powder) and the transformed material may be in another form (e.g., bulk). In some embodiments, the physics model (and associated simulations) comprises calculations of an estimated deformation that consider change in state of the material (e.g., in relation to density and/or surface tension).

A 3D object portion (or an entire 3D object) can be characterized as having an (e.g., characteristic) shape (e.g., cone shape, toroidal shape, disk shape, disc cone shape, spherical shape, wing shape, spiral shape, or bridge shape). In some embodiments, a characteristic shape may be associated with a characteristic deformation. The characteristic shape may be referred to herein as a “primitive.” In some embodiments, the physics model (and associated simulations) comprises calculations that consider a characteristic overall geometry of the object. The estimated deformation may comprise inelastic (e.g., plastic), elastic, or thermally induced deformation. The 3D object can include geometric features (e.g., edges, corners, overhangs, or a cavity wall such as a ceiling) that may deform. The 3D object can comprise a complex 3D object (e.g., having cavities, anchoring structure, closed shapes having a hollow interior (e.g., cavity, or ring), and/or overhangs). The 3D object may comprise non-supported segments (e.g., cavity ceiling or overhang). The non-supported segment may a have shallow angle with respect to a normal vector on a surface of the non-supported segment and a global vector (e.g., FIG. 4, angle β between 452 and 450). The shallow angles may be an angle of at most about 45 degrees (°), 40°, 35°, 30°, 25°, 20°, 15°, 10°, 5°, 1°, or 0.5°, with respect to the platform, the average layering plane, and/or a vector normal to the global vector. The shallow angles may be any value between the afore-mentioned values (e.g., from about 45° to about 0.5°, from about 10° to about 0.50, or from about 45° to about 10° with respect to the platform, the average layering plane, and/or a vector normal to the global vector). The non-supported segment may be (e.g., substantially) parallel to a target surface (e.g., a platform that supports the 3D object) and/or to an average layering plane of the 3D object. One type, or (e.g., at least two) different types of transforming agents (e.g., laser beam, electron beam, binding agent, and/or heating element) may be used to transform the material of the 3D object (e.g., in a forming process such as 3D printing or welding). In some embodiments, the physics model (and associated simulations) comprises calculations of estimated deformation that consider at least one characteristic of the transforming agent(s) (e.g., transformation density (or transformation strength), trajectory, FLS of a footprint on the target surface, hatch spacing, scan speed, focus, defocus, scanning scheme, or energy density distribution at the target surface). In some embodiments, at least two transforming agents (e.g., of a plurality of transforming agents) have different characteristics. The mode of the energy beam may comprise a continuous or pulsing beam. Different types of energy beam scanning methodologies (e.g., tiling, hatching) may be used in transforming the pre-transformed material to form the 3D object. In some embodiments, the physics model (and associated simulations) comprises calculations of estimated deformation that consider the path(s) of the energy beam(s). Different types of energy beam paths and dwell times may be used to transform the material of the 3D object. In some embodiments, the physics model (e.g., and associated simulations) comprises calculations of estimated deformation that consider the dwell times and/or intermission times of the energy beam(s) as it scans along its trajectory. One or more portions of the 3D object may be formed using one type of transforming agent and one or more other portions of the 3D object may be formed using a different type of transforming agent. In some embodiments, the same transformation agent (type) is used to form the 3D object. In some embodiments, the physics model (and associated simulations) comprises calculations of estimated deformation of different portions of the 3D object. For example, a 3D forming operation can involve stacking multiple layers of material, each of which may experience heating and/or cooling at different times. The different layers (or portions thereof) of a printed 3D object may experience (e.g., substantially) the same or different pressure gradients related to stress of the 3D object. In some embodiments, the physics model (and associated simulations) comprises calculations of estimated deformation that consider current and/or previous stacking (e.g., accumulation) of the layers. The estimated deformation may consider a strain/stress that arises from stacking of the layers). The stress may be a latent or an ancillary stress. The strain may be a latent or an ancillary strain.

In some embodiments, the physics model comprises calculations that consider an expected thermo-mechanical (e.g., thermo-plastic) deformation of the object. The deformation may be caused by a material reaction to external loads, body forces (e.g., gravity), changes in temperature, chemical content, and/or a chemical reaction. In some cases, an estimated thermo-plastic deformation can be used to at least partially predict deformation of the object. In some embodiments, an expected thermo-plastic deformation (e.g., thermal component of a thermo-mechanical model) is calculated by computing a thermal balance in the material using the following Equation 1:

$$ρ {c}_{ρ} \frac{\partial T}{\partial t} + {∇}_{x} \cdot q = ρ r ;$$

where t is time, T=T(t, x) is the temperature field, x is a deformation point; c_{ρ}=c_{ρ}(T) is the heat capacity of the material as a function of temperature; ρ=ρ(t,x) is the density; r=r (t, x) is the energy source field per unit mass; q=−∇ₓT; and ∇ₓT is the temperature gradient. The heat capacity can include a latent heat of melting for the material, and the material properties can be assumed to be temperature dependent. An expected mechanical deformation (e.g., mechanical component of a thermo-mechanical model) can be calculated by finding the function x=Φ (t, X) using the following Equation 2, such that:

∇ₓ·P(t,X)=0;

where P=P(t,X) is a stress tensor. The stress tensor can be the first Piola-Kirchhoff stress tensor. Equivalent forms of the above equation can comprise a different stress tensor. The different stress tensor may be a Cauchy, Nominal, Piola, second Piola-Kirchhoff, or Biot stress tensor. Equation 2 can assume inertial terms are negligible (e.g., a quasi-static approximation of the momentum equation). The constitutive model for the material can be calculated using the following Equation 3:

S=C:εₑₗ;

where S=F⁻¹ P is the same (e.g., of Equation 2), or another stress tensor, e.g., the second Piola-Kirchhoff stress tensor; C is the elastic 4-tensor of the material, and εₑₗ is the elastic strain tensor.

In some embodiments, a physics model comprises calculations that consider a type of material (e.g., type of alloy) and an expected thermo-mechanical reaction of that material to the forming process, e.g., that causes deformation. In some embodiments, the physics model relies on one or more assumptions. In one example, the physics model relies on the following assumptions: (i) an optimal transforming agent process (e.g., is applied to maintain a constant peak temperature over a dwell time); and (ii) a closed loop control is employed to adjust process parameters in real time. In some embodiments, a reduced set physics model (e.g., also) assumes: (iii) strain/stress related effects. The strain/stress related effects may be applied to a layer. The stress/strain related effects may be independent of or dependent on a stress field of any underlying structure. In some embodiments, the physics model can be used to calculate a predicted deformation substantially in real time (e.g., before, during and/or following formation of at least a portion of the 3D object). The real time calculations can be used in a feed forward and/or feedback (closed loop) control system(s) that controls the forming process.

In some embodiments, an estimation of a likelihood of failure in forming a 3D object comprises considering a threshold value of any of the simulated values (e.g., of material deformation, material properties, (e.g., required) object support, residual stress, mis-location of transformed material, and/or cracking). A threshold value may be determined automatically and/or manually (e.g., user-configured or supplied), based upon historical data, and/or heuristically. Historical data may be of a same (e.g., requested) prior-formed 3D object, and/or of a similar 3D object. The default/suggested threshold values may comprise (e.g., preferred) historical selection by a given user, (e.g., preferred) historical selection by an average user, (e.g., preferred) historical selection by a group of users (e.g., all users). Similar may be with respect to at least a portion of the (e.g., requested) 3D object. For example, a 3D object having one or more characteristic shapes (e.g., cone shape, toroidal shape, disk shape, disc cone shape, spherical shape, wing shape, spiral shape, or bridge shape) in common. For example, a primitive (e.g., as disclosed herein).

In some embodiments, the analysis and/or threshold may consider (e.g., or be according to) a heuristic. In some embodiments, a heuristic may be used to specify (e.g., suggest) one or more portions of a geometric model for designation as a region of interest (e.g., at least a portion of the 3D object). For example, a heuristic may suggest the one or more portions of the geometric model considering an (e.g., estimated) internal material property of a formed 3D object. In some embodiments, a heuristic may estimate one or more (e.g., internal) material properties of a formed 3D object. The material properties may comprise a density, or a (e.g., metallurgical) microstructure (e.g., a crystal structure) of the formed 3D object. The microstructure may be a grain structure. In some embodiments, a heuristic may comprise an estimate of (i) a rate of formation of (e.g., at least a portion of) the 3D object, (ii) a deviation of (e.g., at least a portion of) the formed 3D object from a requested geometry, or (iii) a surface roughness of (e.g., at least a portion of) the formed 3D object. The estimate of the rate of formation, the (e.g., geometry) deviation, material properties, and/or the surface roughness of the (e.g., portion of the) 3D object may consider a particular 3D printing (e.g., manufacturing) device (e.g., from a plurality of different manufacturing devices) that is configured to form the 3D object.

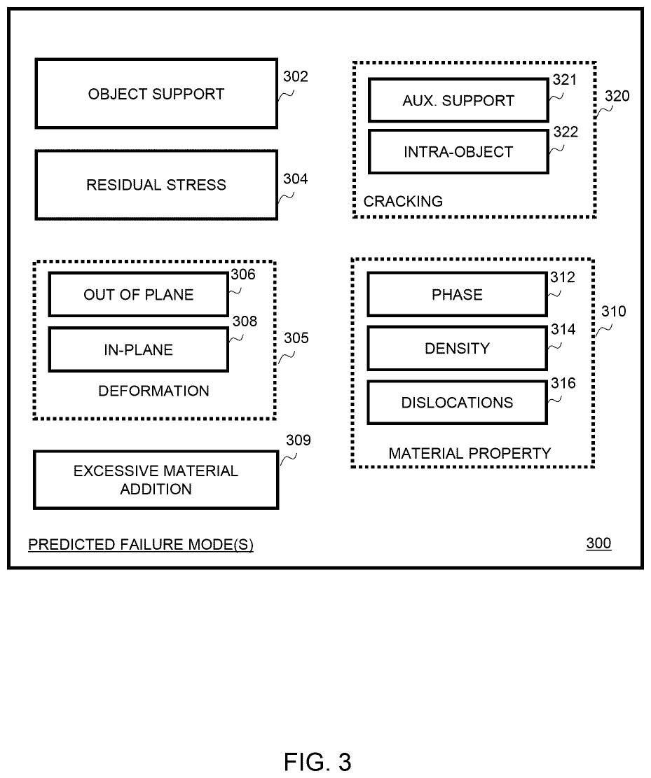

In some embodiments, an estimation of a likelihood of failure in forming a 3D object comprises an operation of estimating a failure mode. In the example of FIG. 3, an operation 300 of analyzing a predicted failure mode comprises failure modes of: (i) object support (e.g., 302), (ii) residual stress (e.g., 304), (iii) adjustive deformation (e.g., 305, e.g., bending, curling, warping, twisting, rolling, plastic yielding, or balling), (iv) a material property (e.g., 310, e.g., phase 312, density 314, or dislocations 316) (v) excessive material addition (e.g., 309, e.g., balling), or (vi) destructive deformation (e.g., cracking, or tearing) (e.g., 320), of the (e.g., forming) 3D object. At times, during and/or after formation of the 3D object, a geometry (e.g., or arrangement) of a 3D object (or portion thereof) may be susceptible to undergoing (e.g., inelastic) deformation, e.g., in response to an applied force. The deformation may be in-plane (e.g., 308, perpendicular to a global vector) and/or out of plane (e.g., 306, in a direction of a global vector). The force may be an internal force applied by the (e.g., transformed) material that forms the 3D object. The force may be applied according to (1) a (e.g. local) gravitational acceleration (e.g., according to a local gravitational field), (II) a contraction of the material of the 3D object, and/or (Ill) an expansion of the material of the 3D object. At times, an internal force may lead to cracking of at least one auxiliary support (e.g., 321) and/or in the (e.g., body of) the 3D object (e.g., 322, intra-object cracking). At times, a (e.g., forming) 3D object may be supported to counteract one or more forces applied to the 3D object during and/or after its formation. At times, (e.g., a portion) of an overhang and/or a cavity wall (e.g., ceiling) may be supported. A failure in the support of the 3D object (e.g., object support) may comprise a portion of the 3D object that is insufficiently supported. Insufficient support may comprise (e.g., lead to) an inelastic deformation (e.g., plastic yielding) of at least a portion of the 3D object (e.g., during and/or following formation) and/or to at least one auxiliary support. Insufficient support may arise due to the geometry of the 3D object, and/or an insufficient number and/or arrangement of (e.g., auxiliary) supports.

In some embodiments, estimating a predicted failure mode comprises one or more failure modes. The failure modes may comprise: (i) object support, (ii) residual stress, (iii) material property, (iv) excessive material addition (e.g., balling), (v) adjustive deformation (e.g., bending, curling, warping, twisting, rolling, plastic yielding, or balling), or (vi) destructive deformation (e.g., cracking, or, tearing), of the (e.g., forming) 3D object. The estimation can be performed for one or more portions of the 3D object model. At least two different estimations can be performed for (e.g., at least two) different portions of the 3D object model. For example, a first estimation comprising a first group of failure modes can be performed on a first portion of the model of the 3D object model, and a second estimation comprising a second group of failure modes can be performed on a second portion of the model of the 3D object model. The first group of failure modes can comprise a first failure mode. The second group of failure modes can comprise a second failure mode. The first group of failure modes can be the same or different from the second group of failure modes. Different can be in at least one failure mode of the group of failure modes. The first group of failure modes and the second group of failure modes can have at least one failure mode that is of the same type (or that is the same). The first group of failure modes and the second group of failure mode can have at least one failure mode that is of a different type (or that is different).

In some embodiments, analyzing an estimated likelihood of object formation failure comprises designating at least one failure mode for analysis. In some embodiments, for a (e.g., portion of the) requested 3D object having more than one designated failure mode analysis, a conflict resolution comprises ranking of the (e.g., plurality of) designated failure mode analyses. The ranking may comprise sequence determination, ordering, classifying, grouping, lining up, and/or succession. The ranking may consider the formation rate, material properties, surface characteristics (e.g., Ra values), any auxiliary supports, and a shape of the 3D object portion. The shape of the 3D object under consideration may comprise an angle with respect to the layering plane and/or plane normal to the global vector, a curvature, a skin portion (e.g., a bottom skin surface), or an interior portion. In some embodiments, an (e.g., at least one) failure mode analysis may be coerced. A coercion may cause a selected failure mode analysis to be ranked at a higher priority than (e.g., any) other (e.g., indicated and/or selected) failure mode analyses. In some embodiments, one (e.g., highest ranked) failure mode analysis is applied for a portion of the requested 3D object. In some embodiments, one coerced failure mode analysis may be designated for a given portion of the requested 3D object. In some embodiments, a (e.g., attempted) designation of at least two different failure mode analyses as coerced analyses generates an error condition. In some embodiments, for a number of failure mode analyses ‘n,’ up to ‘n−1’ failure mode analyses may be designated for suppression, with n being a positive integer. A suppression may comprise a deprecation or an exclusion of a given failure mode analysis.

In some embodiments, an estimation of a likelihood of failure in forming a 3D object may be performed according to a heuristic. In some embodiments, a heuristic may be used to identify (e.g., suggest) one or more portions of a geometric model for analysis of a likelihood of failure in formation. For example, a heuristic may suggest the one or more portions of the geometric model considering (i) an overhang (e.g., angle thereof) or cavity, (ii) a (e.g., local) complexity, (iii) a selected (e.g., default) forming process, or (iv) an (e.g., estimated) internal material property, of a portion of a requested (e.g., or forming) 3D object. For example, a selected forming process may be for forming the (e.g., portion of the) 3D object in a requested (e.g., minimum) time, with a requested (e.g., minimum) deviation from a requested geometry, and/or at a requested (e.g., minimum) surface roughness. In some embodiments, a heuristic may estimate one or more (e.g., internal) material properties of a formed 3D object. The material properties may comprise a density, a porosity, any dislocations, or a (e.g., metallurgical) microstructure (e.g., a crystal structure), of the formed 3D object. The microstructure may be a grain structure. An estimated microstructure may be correlated to a residual stress of the formed 3D object. In some embodiments, a heuristic may comprise an estimate of (i) a sufficiency of support, (ii) a deviation with respect to a requested geometry (e.g., a deformation), (iii) any excess material addition, (iv) a rate of formation, or (v) a surface roughness, of (e.g., at least a portion of) the formed 3D object. The estimate of the likelihood of failure in forming the 3D object may consider a (e.g., forming capability of a) particular 3D printing (e.g., manufacturing) device (e.g., from a plurality of different manufacturing devices) that is configured to form the 3D object.

In some embodiments, one or more portions of the 3D object are identified (e.g., pre-determined) as “critical” portions. A critical portion of a 3D object may be prone to substantial damage in an environment in which it is used. Substantial damage may render the 3D object unfit to its intended use. A critical portion of a 3D object may undergo, in an environment in which it is used, a relatively high induced stress, strain, and/or temperature gradient. The critical portion of the 3D object may undergo, in an environment in which it is used, cracking, internal deformation (e.g., dislocations) and/or wear (e.g., abrasion). Relatively high may be in relation to other portions of the 3D object. Relatively high may be to an extent in which the 3D object may be unfit for its intended use. In some embodiments, a portion of a 3D object that is identified (e.g., designated) as a critical portion may be formed to have a different material property than (e.g., remaining) other portions of the 3D object. A different material property may comprise a difference in a microstructure, a grain structure, a crystal structure (e.g., size and/or orientation), density, and/or a metallurgical structure. A different material property may comprise an increased ductility (e.g., where increased is in relation to remaining portions of the 3D object). For example, the critical portion of the 3D object may be formed to have a reduced (e.g., residual) stress and/or strain in at least one direction. Reduced may be relative to (e.g., remaining) other portions of the formed 3D object. In some embodiments, formation of a (e.g., at least one) critical portion of a 3D object comprises annealing. In some embodiments, a portion of a 3D object that is identified (e.g., designated) as a critical portion may be (e.g., automatically) included in an analysis of a likelihood of formation failure.

In some embodiments, an analysis of a likelihood of formation failure may be (e.g., automatically) designated (e.g., performed) for portion(s) of the geometric model that comprise an overhang (e.g., FIG. 4A, 454) of at least a threshold value. An overhang may be characterized according to an angle formed by (i) a normal vector on a surface of the overhang portion of the 3D object, and (ii) a global vector (e.g., FIG. 4A, angle β) and/or an (e.g., average) layering plane. In some embodiments, a threshold overhang angle for which a failure analysis will be performed comprises an overhang angle of at most about 90°, 75°, 60°, 45°, or 30° relative to a layering plane, and/or a plane perpendicular to the global vector. The threshold overhang angle may be any value between the afore-mentioned values (e.g., from about 90° to about 30°, from about 90° to about 60°, or from about 60° to about 30°, relative to a layering plane, and/or a plane perpendicular to the global vector).

In some embodiments, an overhang may be characterized by a fundamental length scale (FLS) (e.g., width) of the overhang. A width of an overhang may comprise a lateral extension of a given overhang portion for a given layer of formation of the 3D object. A FLS of an overhang (e.g., width) may be characterized in relation to an FLS of a layer height (e.g., thickness). In some embodiments, a threshold overhang FLS for which a failure analysis will be performed comprises an overhang FLS that is at least about 0.3*FLS of the layer height (wherein ‘*’ denotes the multiplication mathematical operation), 0.5*FLS of the layer height, 0.75*FLS of the layer height, 1*FLS of the layer height, 1.5*FLS of the layer height, 2*FLS of the layer height, or 4*FLS of the layer height. The threshold overhang FLS may comprise any value between the afore-mentioned values (e.g., from about 0.3*FLS of the layer height to about 4*FLS of the layer height, from about 0.3*FLS of the layer height to about 1*FLS of the layer height, or from about 1*FLS of the layer height to about 4*FLS of the layer height).

In some embodiments, an analysis of a likelihood of formation failure may be performed regarding a sufficiency of object support. For example, a formation failure analysis may comprise a determination of whether any auxiliary supports are required (e.g., suggested) for a given portion of the 3D object. For example, auxiliary support(s) may be suggested for at least a portion of any overhang and/or cavity (e.g., ceiling) forming a part of the 3D object. A formation failure analysis may comprise an estimation of a required (i) placement, (ii) number, (iii) spacing of auxiliary supports (e.g., between auxiliary supports and/or with respect to a surface of the 3D object), and/or (iv) dimension(s) (e.g., cross-section and/or height), of auxiliary support(s). A formation failure analysis may comprise an estimation of a likelihood of failure as a result of a forming process (e.g., of a plurality of forming processes) that was used to form the auxiliary support(s). In some embodiments, a same forming process is used in the formation of at least a portion of the 3D object and the auxiliary support(s). In some embodiments, at least two forming processes are used in the formation of at least a portion of the 3D object and the auxiliary support(s).

In some embodiments, an analysis of a likelihood of formation failure may be (e.g., automatically) designated (e.g., performed) according to a threshold value of (e.g., intrinsic and/or extrinsic) curvature of (e.g., surfaces of) the geometric model of a requested 3D object. At times, relatively small features (e.g., indentations and/or holes) of the geometric model may comprise a relatively high curvature. A small feature may be relative to a FLS of a layer thickness of the 3D object. A high curvature may be relative to an average curvature of (e.g., all) features, curves, and/or surfaces of the geometric model. For example, an analysis of a likelihood of formation failure may be performed for those features of the (e.g., geometric model of the) requested 3D object comprising curvature corresponding to a radius of curvature that is at most about 20 millimeters (mm), 10 mm, 8 mm, 5 mm, 2 mm, 1 mm, or 0.5 mm. The radius of curvature may be between any of the afore-mentioned radius of curvature values (e.g., from at most about 20 mm to about 0.5, about 20 mm to 5 mm, or about 5 mm to about 0.5 mm).

For example, an estimation can be performed on a first portion of the model of the 3D object, and no estimation performed on a second portion of the model of the 3D object. At times, the same group of failure modes can be chosen for the failure estimation prediction of the entire model of the 3D object. The prediction may comprise an analysis, calculation, or simulation. At times, the user can decide which portion undergoes what estimation (e.g., chose between the failure modes). At times, a suggested estimation (e.g., a suggested group of failure modes) can be offered to the user. The user may agree or disagree with the suggested (e.g., assigned) estimation of the portion. At times, any auxiliary support structures are included in the failure estimation of the model of the 3D object (or portion thereof), e.g., FIG. 3, 321. The auxiliary supports may have a group of failure modes that is the same or different than that of at least a portion of the 3D object model. For example, the failure modes of the auxiliary support may comprise (i) residual stress, (ii) material property, (iii) excessive material addition (e.g., balling), (iv) adjustive deformation (e.g., bending, curling, warping, twisting, plastic yielding, or rolling), or (v) destructive deformation (e.g., cracking, or tearing); of the (e.g., forming) auxiliary supports. At times, the group of failure modes used for the failure estimation of the auxiliary supports is different than that of any portion of the requested 3D object model. The auxiliary supports (e.g., model thereof) may be in contact with the 3D object model. The group of failure modes can comprise a failure mode.

In the example of FIG. 4A, a geometric model 451 of a 3D object is depicted in perspective view. In the example of FIG. 4A, a region of (e.g., estimated) insufficient support (e.g., an overhang, schematically shown as a dashed parallelogram) comprises a point 454 having a normal vector 452 to a surface of the geometric model. In some embodiments, an estimation of a sufficiency of object support comprises an analysis of (e.g., any) overhangs and/or cavity walls (e.g., ceiling) of the 3D object. In some embodiments, an analysis of overhangs comprises a comparison of an angle of the surface(s) of an overhang normal vector(s) with a global vector (e.g., FIG. 4A, angle beta β). The example of FIG. 4A depicts a global vector 450 that is directed (a) in a direction of a (e.g., local) gravitational field vector (FIG. 4A, 460), (b) opposite a vector that is in a direction of layerwise 3D object formation (FIG. 4A, 470), and/or (c) in a direction of a vector normal to a surface of a platform that supports the 3D object and is in a direction opposite to the 3D object (FIG. 4A, 480). In some embodiments, an overhang of a geometric model may comprise surfaces having a threshold angle with respect to the global vector. For example, surfaces comprising an angle β that is at most about 0.1°, 0.50, 1°, 5°, 10°, 25°, 30°, 35°, 40°, 45°, or 50° with respect to a global vector. The angle β with respect to the global vector may be between any of the afore-mentioned angles (from about 0.1° to about 50°, from about 0.1° to about 30°, from about 0.1° to about 25°, from about 0.1° to about 45°, from about 0.1° to about 10°, or from about 0.1° to about 20°).

At times, a supported overhang and/or cavity portion of a (e.g., forming) 3D object may experience a formation failure. For example, a failure may comprise one or more of the support structures that (i) experiences plastic deformation (e.g., bending), (ii) experiences cracking (e.g., tearing), and/or (ii) becomes dislodged from the 3D object and/or its anchor (e.g., material bed, base, and/or platform). FIG. 4B depicts a perspective view of a portion 421 of a geometric model that comprises an overhang region 425 that is estimated to have insufficient object support. In the example of FIG. 4B, the overhang is supported by (e.g., auxiliary) support 430 and 432. In the example of FIG. 4B, an estimated support structure failure includes a crack (e.g., tear) 435. At times, a crack may (e.g., also) form within a body of the (e.g., forming) 3D object (e.g., intra-object). In the example of FIG. 4A, a crack 456 is estimated (e.g., predicted and/or analyzed) to form within the body of the 3D object. The crack may form between various (e.g., identifiable) portions of the 3D body (e.g., at the connection between primitives). For example, between a ledge and a core portion of a 3D object.

The deformation may comprise (e.g., be of at least) a portion of the 3D object that deviates with respect to an intended (e.g., requested) geometry. The deformation (e.g., and the failure prediction) may comprise a deformation of the platform (e.g., build plate). The deformation (e.g., of the platform) may be simulated. The forming instructions engine (e.g., module and/or program) may execute the simulation. In some embodiments, the deformation (e.g., of the platform) is not simulated. One or more forces transmitted to the platform due to formation of the 3D object (e.g., that is anchored to the platform), may be accounted for and/or reported (e.g., as an output). The forming instructions engine (e.g., module and/or program) may account for and/or report the one or more forces. The forces transmitted to the platform may be transmitted during and/or after formation of the 3D object. The deformation may comprise warping, curling, twisting, bending, rolling, or external cracking. The predicted (e.g., analyzed) failure mode may comprise deformation that is out of plane (e.g., FIG. 3, 306) and/or in-plane (e.g., FIG. 3, 308). A plane against which (e.g., any) deformation is measured may be a layering plane (e.g., an average layering plane). In the example of FIG. 4A, layers (e.g., FIG. 4A, 472, 474, and 476) of the geometric model are depicted. Layers of the geometric model may correspond to (e.g., successive) layers of the formed 3D object (e.g., that formed in a layer-wise manner) and/or slices of the geometric model. In some cases, a layer comprises a layering plane that corresponds to an average layering plane. FIG. 4C shows an example schematic vertical cross section of a portion of a 3D object having layers of hardened material 400, 402, and 404 that are sequentially formed during a 3D forming procedure. Boundaries (e.g., FIG. 4C, 406, 408, 410 and 412) between the layers may be visible (e.g., by human eye or using microscopy). The microscopy method may comprise optical microscopy, scanning electron microscopy, or transmission electron microscopy. The boundaries between the layers may be evident by a microstructure of the 3D object. The boundaries between the layers may be (e.g., substantially) planar. The boundaries between the layers may have some irregularity (e.g., roughness) due to the transformation (e.g., melting and or sintering) process (e.g., and formation of any microstructure such as melt pools). An average layering plane (e.g., FIG. 4C, 414) may correspond to a (e.g., imaginary) plane that is an estimated or calculated average. A calculated average may correspond to an arithmetic mean of (e.g., a number of) point locations on a boundary between layers. A calculated average may be calculated using, for example, a linear regression analysis. In some cases, the average layering plane consider deviations from a nominal planar shape.

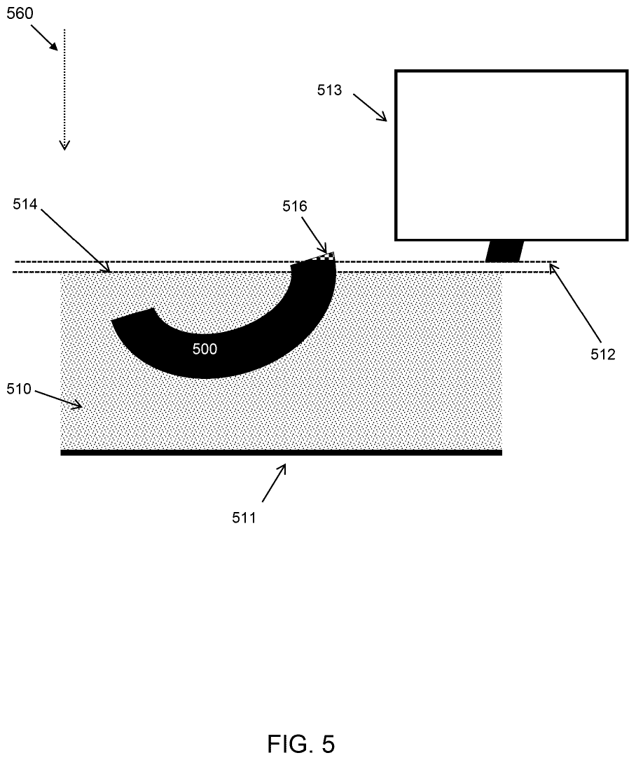

At times, a deformation failure mode comprises a (e.g., excessive) protrusion of at least a portion of the 3D object (e.g., above a target surface). A protrusion may be an out of plane deformation. A target surface may comprise a (e.g., top) surface of a (e.g., pre-transformed) material bed, a platform (e.g., base), and/or a hardened portion of the 3D object. Top may be with respect to a global vector. For example, for two positions in a 3D printing system, a (e.g., second) position (e.g., FIG. 4A, 476) that has a lower global vector value than a (e.g., first) position (e.g., FIG. 4A, 472) is above the (e.g., first) position. A protrusion of at least a portion of the (e.g., forming) 3D object may increase a risk of a forming system malfunction (e.g., damage to an energy source, a material dispenser, and/or a material planarizer (e.g., re-coater) of a forming system). In the example of FIG. 5, a hardened portion of a forming 3D object 500 is positioned within a material bed 510 that is supported by a platform (e.g., base) 511. In the example of FIG. 5, a layering (e.g., dispenser, re-coater and/or planarizer) device 513 is positioned at a position 512 that is above a target surface 514. Above may be with respect to a global vector (e.g., 560). In the example of FIG. 5, the hardened portion has a protrusion that is above the target surface 514. In some embodiments, only a portion of protruding (e.g., hardened) material is considered to be excessively protruding. An excessive protrusion may comprise (e.g., a portion of) protruding material that is at least a threshold distance from an exposed (e.g., target) surface (e.g., FIG. 5, 516). The threshold distance may correspond to a distance at which a layering device is maintained from a (e.g., target) surface. In some embodiments, an excessive protrusion may comprise any (e.g., hardened) material that protrudes at least about 50 micrometers (μm), 75 μm, 100 μm, 200 μm, 500 μm, 1000 μm, 2000 μm, or 5000 μm from an exposed (e.g., target) surface. The excessive protrusion may be any value between the afore-mentioned values (e.g., from about 50 μm to about 5000 μm, from about 50 μm to about 500 μm, or from about 500 μm to about 5000 μm). The surface may be an exposed (e.g., top) surface of a material bed. In some embodiments, a predicted (e.g., analyzed) formation failure considers a protrusion that is in a direction opposite to that of a global vector. For example, the protrusion (e.g., with respect to the target surface) may be in a direction that is toward an apparatus of a forming device (e.g., an energy source, a dispenser, and/or a material planarizer). In some embodiments, a predicted formation failure excludes to consider a deformation of (e.g., a portion of) a 3D object that is located below an exposed (e.g., target) surface. The protrusion may occur during and/or following formation of at least a portion of a 3D object. For example, the protrusion may occur during and/or following formation of a portion of a layer of a 3D object (e.g., that is formed in a layer-wise manner).

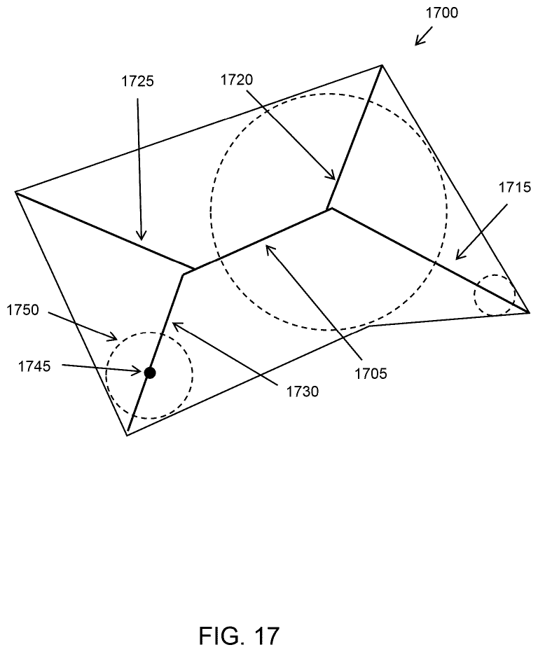

In some embodiments, an estimation of a likelihood of formation failure comprises a simulation of (e.g., only) a portion of the 3D object. A simulation of (e.g., only) a portion of the 3D object may decrease a time required to estimate a likelihood of object formation failure. A decreased time may be with respect to a time required to perform a simulation of the full 3D object (e.g., geometry). The (e.g., selected) portion may be at least a portion of a 3D object layer or a virtual slice of geometric model. The selected portion may be at least one (e.g., several) layer of a 3D object or virtual slice of a geometric model. The portion may be selected according to: (i) a user designation (e.g., selection), (ii) a determination of object support sufficiency, (iii) a complexity of a region of the (e.g., geometric model) of the 3D object, and/or (iv) historical data of the same (e.g., or a similar) 3D object or portion thereof (e.g., a primitive). For example, a user may interact to make a selection of the 3D object via a user interface (e.g., comprising control via a peripheral device such as a keyboard, a computer mouse, a stylus, an audio device, a tactile device such as a touch screen, and/or a visual device such as a screen). In some embodiments, a simulation is (e.g., suggested to be) performed for any overhangs and/or cavities of the 3D object determined lacking in sufficient object support (e.g., FIG. 4A, 454; FIG. 4B, 425). In some embodiments, a simulation is (e.g., suggested to be) performed for complex region(s) of a geometric model. Simulations of varying degrees of complexity can be performed to different portions of the 3D object. For example, a higher complexity degree simulation can be performed on a first portion of the model of the 3D object, and a relatively lower complexity degree simulation can be performed on a second portion of the model of the 3D object. For example, a simulation can be performed on a first portion of the model of the 3D object, and no simulation performed on a second portion of the model of the 3D object. At times, the same degree of complex simulation can be performed on the entire model of the 3D object. At times, a (e.g., first) formation failure analysis indicating a risk of failure that is made without simulation is followed (e.g., automatically, or suggested) by a (e.g., second) formation failure analysis that includes simulation. At times, the user can decide which portion undergoes what degree of simulation (e.g., between a series of complexity options). At times, a suggested degree of simulation complexity is offered to the user. The user may agree or disagree with the suggested (e.g., assigned) degree of simulation complexity to the portion. At times, any auxiliary support structures are included in the simulations of the model of the 3D object (or portion thereof). The auxiliary supports may have a simulation complexity degree that is the same or different than that of at least a portion of the 3D object model. At times, the complexity degree of the simulation of the auxiliary supports is different from any portion of the 3D object model. For example, the complexity degree of the simulation of the auxiliary supports may be simpler than that of any (e.g., other) portion of the 3D object model. In some embodiments, a complexity of a region is according to a representation of the 3D object. For example, a complexity is determined for a medial axis (e.g., skeleton) representation according to a number of branches and/or closed structures (e.g., loops) that form a part of the skeleton representation (e.g., the higher the number of branches and/or close loops in the 3D object model, the more complex it is). The medial axis may be defined as the locus of the centers of maximal inscribed discs. In the example of FIG. 17, for a shape 1700, a medial axis 1705 representing the shape is formed (e.g., determined) according to the locus of the centers (e.g., 1745) of inscribed circles (e.g., 1750). A complexity of an object may be related to a number of branches required to describe the object (e.g., with increasing branch number for increasing complexity). In the example of FIG. 17, the medial axis includes four branches (e.g., 1715, 1720, 1725, and 1730). The closed structure may comprise a curvature. The closed structure may comprise a straight line.

In some embodiments, an estimated likelihood of object formation failure comprises an estimation of excessive material addition (e.g., FIG. 3, 309). Excessive (e.g., improper) material addition may comprise any balling of (e.g., transformed) material, e.g., that is generated during formation of a 3D object. Balling may comprise formation of a portion (e.g., volume) of (e.g., transformed or transforming) material that does not form a portion of the requested 3D object geometry. The volume may assume (e.g., harden into) a volume (e.g., due to surface tension) that may comprise a curved or globular shape. The hardened volume may comprise a shape corresponding to that of a spheroid, ellipsoid, or potato. For example, balling may comprise a transformation of material (e.g., by a transforming agent) that is mis-located. Mis-located may be with respect to an intended location (e.g., on the forming 3D object and/or a target surface). Without wishing to be bound to theory, balling may occur due to a melt pool that hardens with insufficient (e.g., without) contact to a prior-formed portion of the 3D object. Balling may lead to (i) a reduction in a surface finish and/or a deviation from a requested geometry, (ii) an increased porosity and/or void formation, (iii) a malfunction of the forming apparatus, and/or (iv) any other failure (e.g., halting) in the formation of the 3D object. At times, a transforming portion of material attracts pre-transformed material that is in a neighborhood of the transforming portion. At times, an excess of pre-transformed material that is attracted to the transforming material may cause the transforming portion to become larger and/or to have at least one material characteristic other than what was intended (e.g., requested). For example, an object (e.g., stalactite) formed of pre-transformed and/or incompletely transformed material may attach to a portion of the forming 3D object (e.g., an underside of a ledge). At times, a stalactite may evolve (e.g., grow) throughout the formation of the 3D object (e.g., and lead to a formation failure).

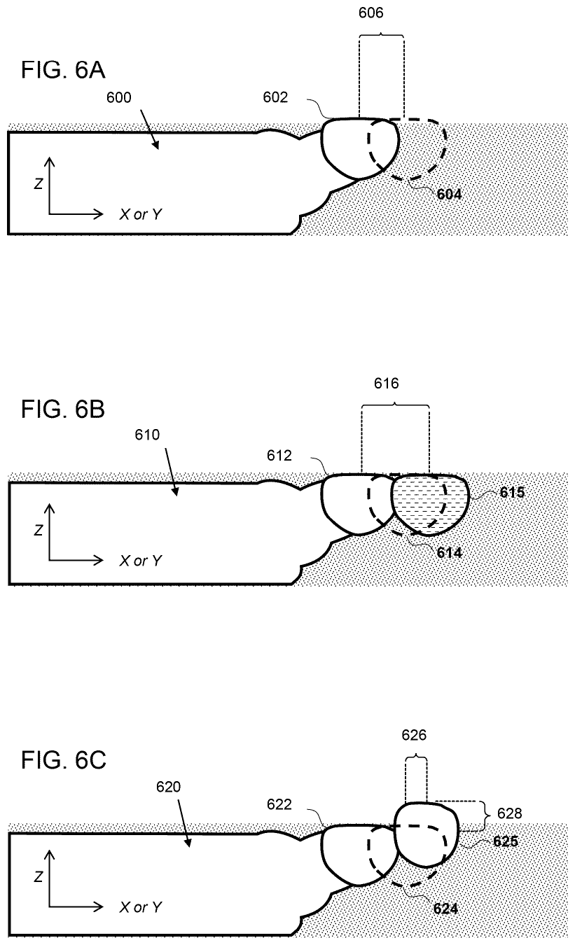

FIG. 6A depicts an example of a portion of a 3D object 600, having a prior-formed (e.g., hardened) portion 602. In some embodiments, a prior-formed portion may comprise a hardened melt-pool. Formation of a 3D object may proceed in a sequence of transformations. The sequence of transformations may have a requested offset (e.g., distance) that separates a given transformation from another (e.g., following) transformation. In the example of FIG. 6A, another (e.g., following) transformation 604 is requested (e.g., programmed) to occur at a distance 606 from (e.g., the center of) the portion 602. In the example of FIG. 6B, a portion of a 3D object 610 comprises a transforming portion 615 that is mis-located from a requested position 614, and is at a distance 616 from a prior-formed portion 612. In the example of FIG. 6C, a portion of a 3D object 620 comprises a hardened portion 625 that is in contact with a prior-formed portion 622, and is mis-located from a requested transformation position 624 (e.g., by distances 626 and 628). The mis-location (e.g., balling) may be due to a deformation. In some embodiments, a mis-location may occur due to a deformation of (e.g., at least a portion of) a forming 3D object. For example, a prior-formed portion may be at a location other than (e.g., that deviates from) and expected location for the prior-formed portion. A transforming portion may be properly located (e.g., according to its requested position), and still generate an excessive material addition as a result of the deformation (e.g., causing the prior-formed portion to be at an unexpected location).

A (e.g., individual unit of a) transformed portion (e.g., melt pool) may have a characteristic size. For example, an FLS of a (e.g., discrete) transformed portion may be at least 50 microns (μm), 75 μm, 100 μm, 150 μm, 300 μm, 500 μm, 700 μm, 1000 μm, 1500 μm or 2000 μm. The FLS of the transformed portion may be any value between the afore-mentioned values (e.g., from about 50 μm to about 2000 μm, from about 50 μm to about 700 μm, of from about 700 μm to about 2000 μm). An FLS of the transformed portion may be related to an FLS of a pre-transformed material from which the transformed portion is formed. In some embodiments, an FLS of a pre-transformed material may be at least 1 μm, 5 μm, 10 μm, 20 μm, 50 μm, 100 μm, 250 μm, or 500 μm. The FLS of the pre-transformed material may be any value between the afore-mentioned values (e.g., from about 1 μm to about 500 μm, from about 1 μm to about 100 μm, of from about 100 μm to about 500 μm).

In some embodiments, a formation failure estimate comprises a distance corresponding to a mis-location of a transformed portion. A mis-location value (e.g., distance) may be related to the FLS of the transformed portion. For example, a mis-location distance (e.g., with respect to requested transformation position) may be at least about 0.15*FLS of the transformed portion, 0.25*FLS of the transformed portion, 0.4*FLS of the transformed portion, 0.75*FLS of the transformed portion, or 1*FLS of the transformed portion (where denotes the multiplication mathematical operation). A mis-location distance may be any value between the afore-mentioned values (e.g., from about 0.15*FLS of the transformed portion to about 1*FLS of the transformed portion, from about 0.15*FLS of the transformed portion to about 0.4*FLS of the transformed portion, or from about from about 0.4*FLS of the transformed portion to about 1*FLS of the transformed portion.

At times, at least two different portions of a 3D object are formed using (e.g., two) different (e.g., default) forming (e.g., printing) processes. For example, an interior (e.g., main body or core) portion of a 3D object can be formed using a different process than a process used to form an overhang and/or skin portion. The transforming agent may transform a pre-transformed material into a transformed material to form one or more 3D objects (or portions thereof). In some embodiments, a (e.g., transforming agent of a) forming process is able to transform (e.g., print) at a throughput (e.g., formation rate) of at least about 6 cubic centimeters of transformed material per hour (cc/hr), 12 cc/hr, 35 cc/hr, 50 cc/hr, 120 cc/hr, 480 cc/hr, 600 cc/hr, 1000 cc/hr, or 2000 cc/hr. The transforming agent may print at any rate within a range of the afore-mentioned values (e.g., from about 6 cc/hr to about 2000 cc/hr, from about 6 cc/hr to about 120 cc/hr, or from about 120 cc/hr to about 2000 cc/hr). At times a choice of a plurality of forming processes may enable formation of a 3D object that is not possible by another forming process (e.g., a conventional forming process and/or one of the plurality of forming processes), e.g., a 3D object comprising a non-supported bottom skin such as, for example, of an overhang structure, and/or of a cavity ceiling. At times, a non-supported bottom skin portion is formed by a forming process that differs from that of an interior portion of a 3D object. In some embodiments, different portions of a given overhang and/or cavity ceiling are formed using different transformation (e.g., forming) processes. The different process may at least partially consider an angle relative to the layering plane, and/or global vector). For example, a first portion of an overhang (and corresponding bottom skin portion) may be formed using a first transformation process, and a second portion of the overhang and/or cavity ceiling (and corresponding bottom skin portion) may be formed using a second transformation process that is different than the first transformation process. At times, auxiliary support structures may be generated to support at least a portion of a 3D object during its formation. In some embodiments, support structures are generated for at least a portion of an overhang and/or cavity ceiling portion of a 3D object. In some embodiments, a particular forming process (e.g., of a plurality of forming processes) is selected for generating a given portion of a 3D object according to a forming parameter. In some embodiments, a forming parameter comprises: (i) an angle of a surface (e.g., of the 3D object, with respect to a global vector), (ii) a surface roughness, (iii) a rate of formation, (iv) a material composition, or (v) a dimensional fidelity (e.g., of the formed 3D object to the geometric model), any of which may be requested. Different forming processes may generate different portions of the formed 3D object to have different material properties (e.g., microstructure, density and/or surface roughness). At times, at least two different forming processes may generate at least two different portions of the formed 3D object respectively. At times, at least two different forming processes may generate one portion of the formed 3D object. The different processes may be used to generate different material characteristics of the 3D object portions (e.g., microstructure, density and/or surface roughness). A forming process may be suitable to a particular geometry of a 3D object or a portion thereof. At times, different processes may generate the same material characteristics of the 3D object portions. At times, the same forming process may generate at least two different portions of the formed 3D object. In some embodiments, a formed 3D object comprises a functionally graded material. For example, an internal portion of a (e.g., formed) 3D object may have a first property, and an external portion of the formed 3D object (e.g., overhang, and corresponding bottom skin) may have a second property that is different than the first property. The property can be a material characteristic (e.g., density, porosity, surface roughness, and/or microstructure). The property may be a geometry. In some embodiments, a 3D object can have at least 2, 3, 4, 5, 10, 100, or 1000 regions of different geometry and/or material properties (e.g., microstructure, density and/or surface roughness). At times the process forming the auxiliary support(s) may be the same as the process used to form at least a portion of the 3D object). At times the process forming the auxiliary support(s) may be different as any of the process(es) used to form the 3D object.

At times, at least one 3D object is formed in a material bed, mold, and/or above a platform. The FLS (e.g., width, depth, and/or height) of the material bed or mold can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS of the material bed or mold can be between any of the afore-mentioned values (e.g., from about 50 mm to about 5 m, from about 250 mm to about 500 mm, from about 280 mm to about Im, or from about 500 mm to about 5 m). The FLS of the platform can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS of the platform can be at most about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS of the platform can be between any of the afore-mentioned values (e.g., from about 50 mm to about 5 m, from about 250 mm to about 500 mm, from about 280 mm to about Im, or from about 500 mm to about 5 m).

At times, an estimation analysis of a likelihood of failure to form a 3D object comprises (e.g., potential failure) feedback prior to commitment of substantial (e.g., human, computer, and/or material) resources for the preparation or formation of the designed 3D object (e.g., “failure analysis”). In some embodiments, a (e.g., requested) 3D object may be (e.g., additively) generated in a period of at most about 14 days, 7 days, 4 days, 3 days, 2 days, 1 day, 12 hours, 6 hours, 1 hour, 30 min, 20 min, 10 min, 5 min, 1 min, 30 seconds, or 10 seconds. The 3D object may be additively generated in a period between any of the aforementioned time periods (e.g., from about 10 seconds to about 14 days, from about 10 seconds to about 12 hours, from about 12 hours to about 14 days, or from about 12 hours to about 10 minutes). The failure analysis may be characterized as a proportion (e.g., fraction) of the (e.g., average) time required to form the requested 3D object (e.g., average formation time, “AFT”). In some embodiments, a failure analysis for a given requested 3D object is generated in at most about 0.5*AFT, 0.2*AFT, 0.15*AFT, 0.1*AFT, 0.08*AFT, 0.05*AFT, 0.02*AFT, or 0.01*AFT (e.g., of the given 3D object). The failure analysis may be generated between any value of the afore-mentioned values (e.g., from about 0.5*AFT to about 0.01*AFT, from about 0.2*AFT to about 0.1*AFT, from about 0.2*AFT to about 0.01*AFT, or from about 0.1*AFT to about 0.01*AFT). The failure analysis may comprise analyzing any failure of at least a portion of the three-dimensional object, which failure may arise during and/or after the formation of the three-dimensional object, and/or as a consequence of such formation. The failure analysis may comprise analyzing any excessive material addition (e.g., balling) that occurs during formation of at least a portion of the 3D object; which balling may or may not lead to failure of at least a portion of the three-dimensional object, which failure may arise during and/or after the formation of the three-dimensional object, and/or as a consequence of such formation.

In some embodiments, a formation preparation of a (e.g., requested) 3D object (e.g., by a forming system) may comprise a simulation of (e.g., at least a portion of) the 3D object, and/or generation of formation instructions. In some embodiments, a formation (e.g., print) reparation may be performed over a period of at most about 7 days, 4 days, 3 days, 2 days, 1 day, 12 hours, 6 hours, 1 hour, 30 min, 20 min, 10 min, 5 min, 1 min, 30 seconds, or 10 seconds. The formation preparation of the 3D object may be in a period between any of the aforementioned time periods (e.g., from about 10 seconds to about 7 days, from about 10 seconds to about 12 hours, from about 12 hours to about 7 days, or from about 12 hours to about 10 minutes). Failure analysis may be characterized as a proportion (e.g., fraction) of the (e.g., average) time required to complete the formation preparation of the requested 3D object (e.g., average preparation time, “APT”). In some embodiments, a failure analysis is generated in at most about 0.8 ATP, 0.5 APT, 0.2*APT, 0.15*APT, 0.1*APT, 0.08*APT, 0.05*APT, 0.02*APT, or 0.01*APT. The failure analysis may be generated between any value of the afore-mentioned values (e.g., from about 0.8*APT to about 0.01*APT, from about 0.5*APT to about 0.01*APT, from about 0.2*APT to about 0.01*APT, from about 0.2*APT to about 0.1*APT, or from about 0.1*APT to about 0.01*APT). In some embodiments, a failure analysis is generated in at most about 10 seconds (sec), 30 sec, 45 sec, 1 minute, 2 minutes, 5 minutes, or 10 minutes. The failure analysis may be generated between any value of the afore-mentioned values (e.g., from about 10 minutes to about 10 sec, from about 10 minutes to about 2 minutes, or from about 2 minutes to about 10 sec). In some embodiments, the failure analysis is done with at least 50%, 60%, 70%, 80%, 90%, 95%, or 99% accuracy with respect to the formed 3D object. The failure analysis may be done with any value between the afore-mentioned values (e.g., from about 50% to about 99%, from about 50% to about 70%, or from about 70% to about 99%).

The 3D object (e.g., solidified material) can have an average deviation value from the intended dimensions of at most about 0.5 microns (μm), 1 μm, 3 μm, 10 μm, 30 μm, 100 μm, 300 μm or less. The deviation can be any value between the aforementioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and K_{dv} is a constant. Dᵥ can have a value of at most about 300 μm, 200 μm, 100 μm, 50 μm, 40 μm, 30 μm, 20 μm, 10 μm, 5 μm, 11 μm, or 0.5 μm. Dᵥ can have a value of at least about 0.5 μm, 1 μm, 3 μm, 5 μm, 10 μm, 20 μm, 30 μm, 50 μm, 70 μm, 100 μm, 300 μm or less. Dᵥ can have any value between the aforementioned values. Dᵥ can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the aforementioned values. K_{dv} can have a value that is from about 3000 to about 500, from about 1000 to about 2500, from about 500 to about 2000, from about 1000 to about 3000, or from about 1000 to about 2500.

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). Ra may use absolute values. The 3D object can have a Ra value of at least about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 11 μm, 500 nm, 400 nm, 300 nm, 200 nm, 100 nm, 50 nm, 40 nm, or 30 nm. The 3D object can have a Ra value between any of the aforementioned Ra values. For example, the Ra value can be from about 30 nm to about 50 μm, from about 5 μm to about 40 μm, from about 3 μm to about 30 μm, from about 10 nm to about 50 μm, or from about 15 nm to about 80 μm. The Ra values may be measured by electron microscopy (e.g., scanning electron microscopy), scanning tunneling microscopy, atomic force microscopy, optical microscopy (e.g., confocal, laser), or ultrasound. The Ra values may be measured by a contact or by a non-contact method.

In some instances, it is requested to have a 3D object (or portion thereof) that has a certain amount (e.g., certain degree) of porosity. The 3D object (e.g., its transformed (e.g., and hardened) material) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object may have a porosity of at least about 0.05 percent (%), 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object may have a porosity between any of the afore-mentioned porosity percentages (e.g., from about 0.05% to about 0.2%, from about 0.05% to about 0.5%, from about 0.05% to about 20%, from about from about 0.05% to about 50%, or from about 30% to about 80%).

At times, a failure estimation is performed for a complex 3D object. In some embodiments, a complexity of a 3D object may be characterized according to a ratio of the object's surface area to the object's volume (“sa/vol”). In some embodiments, value of sa/vol may be determined (e.g., calculated) for a given object according to (e.g., a numerical estimate of) a ratio of a surface integral and a volume integral, of the given object. The sa/vol has units of inverse length (“L-1”), where length may be expressed in any suitable unit (e.g., meter, centimeter, micrometer, nanometer, yard, foot, inch, or micro-inch). In some embodiments, a complex 3D object has a sa/vol of at least about 10 L−1, 25 L−1, 50 L−1, 100 L−1, or 200 L−1. The complex 3D object may have a sa/vol value that is between any of the afore-mentioned values (e.g., from about 10 L−1 to about 200 L−1, from about 10 L−1 to about 50 L−1, or from about 50 L−1 to about 200 L−1). In some embodiments, at least one (e.g., a smallest) dimension of a (e.g., complex) formed 3D object has a lower bound (e.g., a smallest permitted value). For example, a lower bound of a smallest dimension of a formed 3D object may be at least 1*(FLS of a transformed portion), 1.5*(FLS of a transformed portion), 2*(FLS of a transformed portion), 5*(FLS of a transformed portion), 10*(FLS of a transformed portion), or 25*(FLS of a transformed portion). The lower bound of a smallest dimension of a formed 3D object may be any value between the afore-mentioned values (from about 1*(FLS of a transformed portion) to about 25*(FLS of a transformed portion), from about 1*(FLS of a transformed portion) to about 5*(FLS of a transformed portion), or from about 5*(FLS of a transformed portion) to about 25*(FLS of a transformed portion)).

At times, a complexity of a 3D object is characterized (e.g., quantified) according to a geometric model of the 3D object. For example, a complexity of a 3D object may be characterized by a mesh of (e.g., a geometric model of) the 3D object. A mesh may comprise a discrete representation of a (e.g., 3D) object. In some embodiments, geometric characteristics of the geometric model are associated with (e.g., data points) of a mesh. In some embodiments, geometric characteristic data are stored at nodes and/or edges of fundamental components (e.g., cells) of a mesh. A cell of a mesh may be a geometric structure such as a polygon (e.g., 2D or 3D polygon). The polygon may be a space filling polygon. The geometric structure may be a tessellation. In some embodiments, the cell comprises a symmetric polygon. In some embodiments, the cell comprises an equilateral polygon. In some embodiments, the cell comprises a triangle, a tetragon, or a hexagon. In some embodiments, the tetragon comprises a concave or a convex tetragon. In some embodiments, the tetragon comprises a rectangle. For example, the cell may comprise a square, rectangle, triangle, pentagon, hexagon, heptagon, octagon, nonagon, octagon, circle, or icosahedron. The cell may comprise one or more 3D space filling shapes. The cell may comprise a cuboid (e.g., cube), or a tetrahedron. The cell may comprise a polyhedron. The polyhedron may be a prism (e.g., hexagonal prism), or octahedron (e.g., truncated octahedron). The cell may comprise a Platonic solid. The cell may comprise octahedra, truncated octahedron, or a cube. The cell may comprise convex polyhedra (e.g., with regular faces). The cell may comprise a triangular prism, hexagonal prism, cube, truncated octahedron, or gyrobifastigium. The cell may comprise a pentagonal pyramid. The cell may be an indentation of the 3D shape (e.g., a V-groove is an indentation of a cone). The cell may comprise space-filling polyhedra. The cell may exclude a pentagonal pyramid. The cell may comprise 11-hedra, dodecahedra, 13-hedra, 14-hedra, 15-hedra, 16-hedron 17-hedra, 18-hedron, icosahedra, 21-hedra, 22-hedra, 23-hedra, 24-hedron, or 26-hedron. The cell may comprise at least 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 faces. The cell may comprise at most 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 faces. The cell may comprise any number of faces between the aforementioned number of faces (e.g., from 4 to 38, from 4 to 20, from 20 to 40, or from 10 to 30 faces).

In some embodiments, a meshing scheme comprises isotropic or anisotropic meshing. In some embodiments, a mesh (e.g., scheme) may comprise a surface mesh or a volumetric mesh. In some embodiments, a surface mesh may be used (a) to generate a display of the geometric model, and/or (b) to slice a volume of the geometric model. In some embodiments, a volumetric mesh may be used for simulating at least one behavior of the 3D object (e.g., according to a numerical simulation), which behavior may be during and/or after the formation of the 3D object. The behavior may refer to thermal and/or mechanical behavior. In some embodiments, a relationship may exist between a surface mesh and a volumetric mesh (e.g., for a given geometric model). For example, a volumetric mesh may be formed considering a (e.g., surface) boundary described by a surface mesh. In some embodiments, formation of a volumetric mesh does not consider a surface mesh (e.g., boundary).

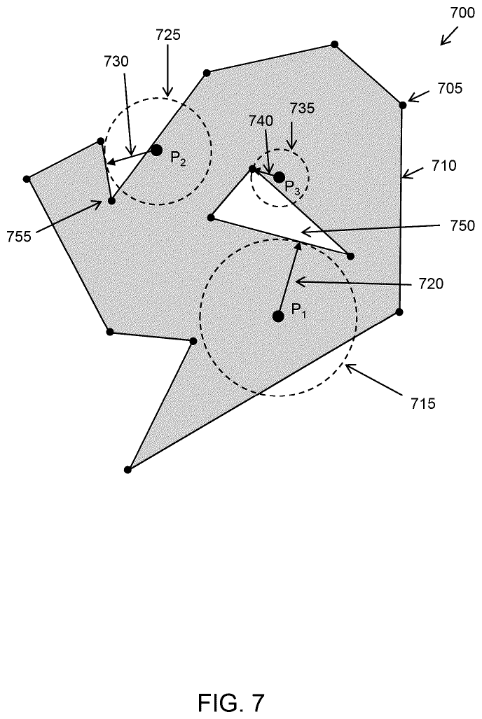

At times, a meshing scheme has an associated mesh sizing function. At times, for an object having a domain (e.g., surface or volume) that is described by a set of mesh cells, a mesh sizing function may provide a relationship between a location in the domain and a shape (e.g., size) of a given cell at that location. In some embodiments, an “optimal” mesh sizing function may be a function that describes a geometry of a given domain (e.g., to a threshold accuracy) with an optimal set of mesh cells. Optimal may be with regard to (i) a number (e.g., fewest number of cells), (ii) a size (e.g., according to specified sizing function), (iii) a fidelity to a selected geometry of the object (e.g., a perimeter), and/or (iv) any combination thereof, of the mesh elements. In some embodiments, mesh elements of a mesh may be continuous (e.g., 1-Lipschitz continuous). In some embodiments, an optimal mesh sizing function may be given (e.g., approximated) according to a local feature size. In some embodiments, a local feature size (“Ifs”) may refer to function whose value at any point within a domain (e.g., surface or volume) is equal to the radius of a circle (or sphere) having a surface that is tangent to the two nearest non-adjacent features of the boundary of the domain (e.g., polygon). In the example of FIG. 7, a domain 700 comprises vertices 705 and edges 710. In the example of FIG. 7, a local feature size at a first location (e.g., point P₁) of the domain is given by a circle 715 having a size (e.g., radius) 720; a local feature size at a second location (e.g., point P₂) of the domain is given by a circle 725 having a size (e.g., radius) 730; and a local feature size at a third location (e.g., point P₃) of the domain is given by a circle 735 having a size (e.g., radius) 740. A feature of a mesh may correspond to an edge (e.g., 710), curve, vertex (e.g., 705), embossing, extrusion, hole (e.g., 750), fillet, chamfer and/or bezel of the (e.g., surface of the) 3D object that is modeled by the mesh. At times, a complexity of a surface (e.g., or volume) of a 3D object (e.g., its number, density and/or variety of features) influences the feature size(s) and/or the number of mesh cells required by a mesh for accurate description of the 3D object. For example, sharp(er) angles (e.g., vertices having an acute angle, 755) and/or small(er) FLS of cavities (e.g., holes) and/or fillets may require a correspondingly small(er) mesh cell (e.g., and increased number of mesh cells overall). For example, the sharper the angles (e.g., vertices having an acuter angle, 755) and/or the smaller the FLS of cavities and/or fillets the more complex the object may be, e.g., since it may require increased number of mesh cells to characterize it.

In some embodiments, a mesh cell size (e.g., FLS) is constrained (e.g., has a lower bound value). In some embodiments, a lower bound value corresponds to a size of an allowed mesh cell. In some embodiments, a mesh cell size is proportional to a fundamental length scale (FLS) of a transformed portion (e.g., corresponding to a given transformation agent). For example, a lower bound of an allowed mesh cell size may be proportional to an FLS of a transformed portion (e.g., melt pool). In some embodiments, a lower bound size of an allowed mesh cell size is at most about 1*FLS of a transformed portion, 1.5*FLS of a transformed portion, 2*FLS of a transformed portion, 3*FLS of a transformed portion, 5*FLS of a transformed portion, or 10*FLS of a transformed portion. The lower bound of an allowed mesh cell size may be any value between the afore-mentioned values (e.g., from about 1*FLS of a transformed portion to about 10*FLS of a transformed portion, from about 1*FLS of a transformed portion to about 5*FLS of a transformed portion, or from about 5*FLS of a transformed portion to about 10*FLS of a transformed portion).

At times, a complexity of a requested 3D object (e.g., a number and/or density of its features) may be related to a number of mesh cells (e.g., that are required) to form the mesh for a model of the 3D object. In some embodiments, for a given set of dimensions (e.g., area and/or volume): (i) a 3D object of moderate complexity may comprise a mesh having M mesh cells, (ii) a 3D object of low complexity (e.g., having a reduced number of features, with respect to the moderate complexity) may comprise a mesh having at most about q*M mesh cells, and/or (iii) a 3D object of high complexity (e.g., having an increased number of features, with respect to the moderate complexity) may comprise a mesh having at least about 10q′*M mesh cells. The value of q and q′ may be at most about 0.15, 0.2, 0.4, 0.6, or 0.8. The value of q and q′ may be at least about 0.15, 0.2, 0.4, 0.6, or 0.8. The value of q and q′ may be any value between the aforementioned values (e.g., from about 0.15 to about 0.8). The values of q′ and q may be different. The value of n and n′ may be the same. For example, q and q′ may have a value of about 0.2. In some embodiments, a 3D object of low complexity comprises a mesh having at most about 0.01*M mesh cells, 0.05*M mesh cells, 0.1*M mesh cells, 0.15*M mesh cells, or 0.2*M mesh cells. The 3D object of low complexity may comprise a mesh of any value between the afore-mentioned values (e.g., from about 0.01*M mesh cells to about 0.2*M mesh cells, from about 0.01*M mesh cells to about 0.1*M mesh cells, or from about 0.1*M mesh cells to about 0.2*M mesh cells). In some embodiments, a 3D object of high complexity comprises a mesh having at least about 1.5*M mesh cells, 1.7*M mesh cells, 2*M mesh cells, 5*M mesh cells, 10*M mesh cells, 25*M mesh cells, 50*M mesh cells, or 100*M mesh cells. The 3D object of high complexity may comprise a mesh of any value between the afore-mentioned values (e.g., from about 1.5*M mesh cells to about 100*M mesh cells, from about 1.5*M mesh cells to about 25*M mesh cells, or from about 25*M mesh cells to about 100*M mesh cells). In some embodiments, for a 3D object having a volume of about 100 cubic centimeters, and for a transforming agent having a transformed portion FLS of about 200 microns, M may be from about 350,000, 400,000, 500,000, 600,000, or 700,000 mesh cells. M may vary in relation to (e.g., in proportion to) a size of a given 3D object. M may be any value between the afore-mentioned values (e.g., from about 350,000 to about 700,000, from about 350,000 to about 500,000, or from about 500,000 to about 700,000).

At times, accuracy of the mesh may be regarding an error bound between the 3D object and the mesh. The error of the boundary value may consider a relationship between an arc length of a given portion of a surface (e.g., or volumetric portion) of the 3D object, and an edge of a mesh cell describing the given portion, e.g., as in Equation 4:

$$ϵ = \frac{l - {l}^{′}}{l}$$

where ε is a (e.g., normalized) error bound, l is an arc length, and l′ is an edge length of a mesh cell edge that describes the arc at that portion of a given 3D object (e.g., surface). For example, an accurate mesh may have an error of at most about 0.35, 0.3, 0.25, 0.2, 0.15, 0.1, 0.05, 0.02, 0.01, or 0.001. An error of the mesh may be any value between the afore-mentioned values (e.g., from about 0.35 to about 0.001, from about 0.35 to about 0.2, or from 0.2 to about 0.001).

In some embodiments, a (e.g., optimal) number of mesh elements may be estimated for a given domain, e.g., according to the following Equation 5:

$$N = {\int }_{Ω} \frac{1}{π {f ( p )}^{2}} d Ω ;$$

where N is an (e.g., optimal) number of mesh cells, Ω is a domain (e.g., of a surface or volume), and f(p) describes a (e.g., local feature) size of a mesh element as a function of position ‘p’ within the domain.

In some embodiments, for a 3D object having an optimal set of mesh elements, a time required (e.g., algorithm running time) to generate an (e.g. optimal) mesh of the 3D object may be given (e.g., also refereed herein as “big O notation”) by O (n log n), where ‘n’ is equal to the (e.g., optimal) number of mesh elements of the mesh. In some embodiments, optimal may refer to a minimal number of mesh elements (e.g., cells) that may represent a surface (e.g., or volume) of an object at a given error bound (e.g., as provided in Equation 4).

In some embodiments, one or more operations of the forming instructions engine may be limited to at least one portion of the 3D object. At least one portion of the 3D object may have a mesh different than another portion of the 3D object. The difference may comprise a difference in (i) mesh resolution or (ii) cell structure of the mesh. For example, a first portion of the mesh may have a low resolution and a second portion of the mesh may have a high resolution. For example, a first portion of the mesh may have a high resolution, a second portion of the mesh may have a medium resolution, and a second portion of the mesh may have a high resolution, wherein low, medium, and high are terms relative to each other. The resolution designated to at least one portion of the 3D object may be (i) assigned automatically, (ii) recommended (e.g., to a user), and/or (iii) altered (e.g., by a user). The alteration may be during usage of the forming instructions engine. For example, a mesh of a ledge of a 3D object may have a higher resolution than a mesh of the core of a 3D object. Operation of the forming instructions engine (e.g., a simulation) may be performed in greater detail in at least one portion of the 3D object as compared to another. The time required for the execution of the operation by the forming instructions engine may be related to the mesh (e.g., resolution and/or cell structure). The detail of the operation (and/or speed) designated to at least one portion of the 3D object may be (i) assigned automatically, (ii) recommended (e.g., to a user), and/or (iii) altered (e.g., by a user). The alteration may be during usage of the forming instructions engine. For example, a simulation of a ledge of a 3D object may be assigned to be more detailed than a simulation of the core of a 3D object. The operation (e.g., simulation) detail may be coarse, medium, or detailed. In some embodiments, for a portion of the 3D object: the coarse type operation takes less time than the medium type operation, which takes less time than the detailed type operation. The operation may comprise object pre-print correction (OPC). The operation may comprise prediction of a formation failure of the 3D object.

In some embodiments, an interior portion of a 3D object may be formed using a process that has a relatively high formation rate (e.g., throughput) for transforming the pre-transformed material to form (e.g., at least a portion of) the 3D object. Relatively high may be with respect to another forming process available to a particular manufacturing device (e.g., a three-dimensional printer). The other forming process may be a conventional and/or non-optimal forming process. Optimal can be evaluated by the ability of the forming process to form the 3D object according to its requested parameters, e.g., of size and/or material specifications and/or tolerances. The other forming process may be any (e.g., conventional) forming process disclosed herein. For example, a relatively high formation rate may be with respect to an average of formation rate (AFR) of another forming processes that could potentially be used for formation of the at least one 3D object. In some embodiments, a relatively high formation rate may be at least 1.1*AFR, 1.5*AFR, 2*AFR, 4*AFR, 6*AFR, 10*AFR, 15*AFR, or 20*AFR. The relatively high formation rate may be any value between the afore-mentioned values (e.g., from about 1.1*AFR to about 20*AFR, from about 1.1*AFR to about 10*AFR, or from about 10*AFR to about 20*AFR). In some embodiments, an estimation of a formation failure considers (e.g., any) portions of a 3D object that are requested to be transformed at a relatively high formation rate. At times, a transformed material formed at a relatively high formation rate may have an increased likelihood of formation failure (e.g., with respect to material formed by a conventional and/or non-optimized forming process).

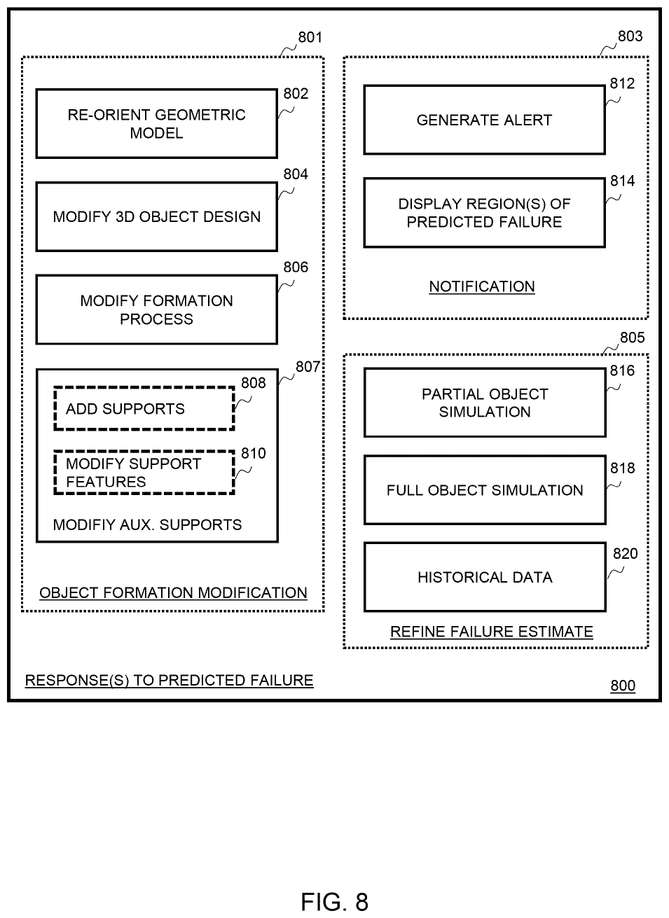

In some embodiments, estimating a likelihood of failure in forming a 3D object comprises an operation of responding to a predicted (e.g., estimated) failure mode. The response to a predicted failure mode may comprise: (i) an object formation modification, (ii) a notification, or (iii) a refinement of a failure estimate. An object formation modification may be geared to: (a) re-orient a geometric model, (b) modify a design of the 3D object, (c) modify a formation process (e.g., by which at least a portion of the 3D object is formed), and/or (d) modify auxiliary support. To modify auxiliary support may include an addition of support(s) and/or to modify (e.g., at least one) support feature allocated to the 3D object model (or portion thereof). A notification may include generation of an alert and/or a display of any portion(s) (e.g., regions) of predicted failure. A refinement to a failure estimate may include a partial 3D object simulation, a full 3D object simulation, and/or (e.g., an analysis of) historical data (e.g., of a same or similar prior-formed 3D object). In the example of FIG. 8, an operation 800 of a response to a predicted failure mode includes: (i) an object formation modification (e.g., 801), (ii) a notification (e.g., 803), and/or (iii) a refinement of a failure estimate (e.g., 805). In the example of FIG. 8, an object formation modification includes to: re-orient a geometric model (e.g., 802); modify a design of the 3D object (e.g., 804); modify a formation process (e.g., 806, e.g., by which at least a portion of the 3D object is formed); and/or modify auxiliary support (e.g., 807). In the example of FIG. 8, to modify auxiliary support includes an addition of support(s) (e.g., 808) and/or to modify (e.g., at least one) support feature (e.g., 810). In the example of FIG. 8, a notification includes generation of an alert (e.g., 812), and/or a display of any portion(s) (e.g., regions) of predicted failure (e.g., 814). In the example of FIG. 8, a refinement to a failure estimate includes a partial 3D object simulation (e.g., 816), a full 3D object simulation (e.g., 818), and/or (e.g., an analysis of) historical data (e.g., 820, e.g., of a same or similar prior-formed 3D object).

In some embodiments, an (e.g., any) object modification causes a subsequent failure estimation to be performed (e.g., a refined failure estimation). At times, a re-orientation of a geometric object (e.g., with respect to a global vector) alters an angle of at least one overhang and/or cavity (e.g., ceiling) of the 3D object. In some embodiments, a re-orientation of a geometric object may alter a requirement of auxiliary support for at least a portion of the 3D object. For example, a requirement for support may be increased, reduced, or experience a change in (e.g., relative) number and/or placement on the 3D object. In some embodiments, a modification in 3D object design comprises a change in at least one dimension of the 3D object. A modification to formation of a 3D object may modify (i) (e.g., reduce or increase) a requested surface characteristic (e.g., surface roughness and/or fidelity of formed geometry to model), and/or (ii) a requested material property (e.g., by modifying forming instructions for the 3D object).

In some embodiments, a modification to at least one auxiliary support is suggested (e.g., performed) in response to a predicted formation failure due to (a) insufficient support, and/or (b) cracking, tearing, and/or plastically yielding (e.g., of an auxiliary support and/or intra-object). For example, a modification may be made to (i) a number, (ii) a placement, (iii) an arrangement (e.g., relative spacing between auxiliary supports, and/or with respect to placement on a surface of the 3D object), (iv) a formation process used to form at least one auxiliary support, (v) an auxiliary support feature (e.g., density, porosity, and/or dimension), or (vi) any combination thereof.

In some embodiments, a modification to instruction to perform a forming process comprises a change in instruction to select the forming process for forming one or more portions of the 3D object, e.g., a core and/or (e.g., bottom) skin process. For example, in response to an estimated deformation (e.g., destructive and/or adjustive) failure, a forming instruction to a high formation rate process may be modified to a (e.g., relatively) lower formation rate process. For example, in response to a portion of the 3D object estimated to (i) crack (e.g., tear and/or plastically yield), (ii) have a material property other than intended (e.g., requested), and/or (iii) have a residual stress above a threshold value; a forming process that is prescribed for the portion(s) having the (e.g., high) residual stress may be altered, and/or an annealing process may be suggested. In some embodiments, at least two portion(s) of a 3D objects may have at different response to a predicted failure mode. In some embodiments, at least two portions(s) of a 3D object have different object formation modifications.

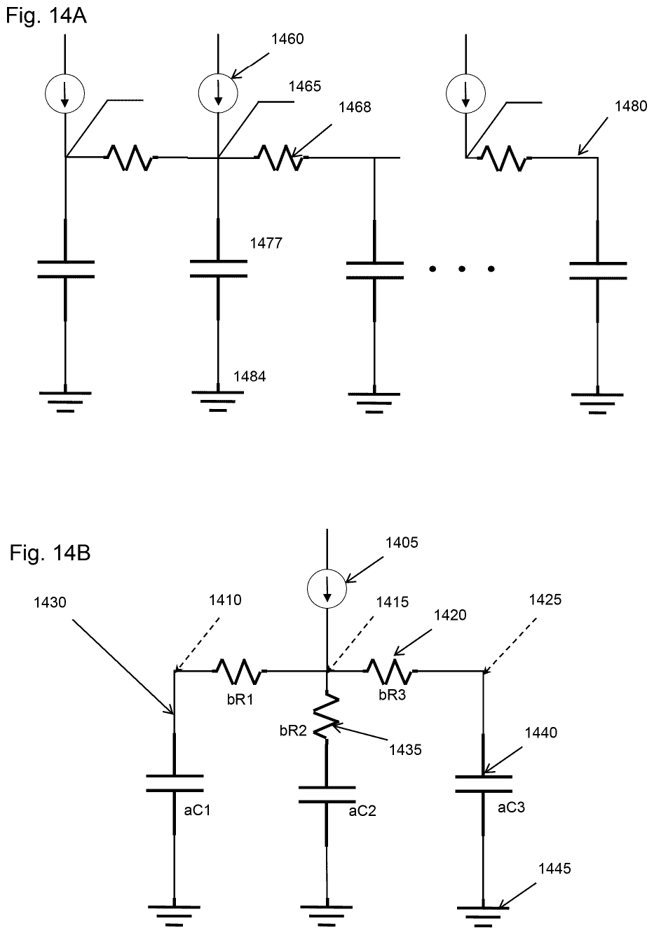

In some embodiments, a refinement in the analysis of a failure mode (e.g., estimation of failure) comprises a modification to a simulation of the 3D object. In some embodiments, an initial simulation may be relatively fast, due to a simplified (e.g., equivalent) model (e.g., FIG. 14A), a selection of only a portion of a 3D object, and/or a selected (e.g., coarse) mesh with which the 3D object is modeled. In some embodiments, a (e.g., relatively fast) simulation may be further refined by increasing an accuracy (e.g., reducing an allowed error) of a mesh that models the 3D object, by considering a (e.g., relatively) more complex numerical model, and/or by increasing the portion of the 3D object that is simulated (e.g., a full object simulation). In some embodiments, a refinement in the analysis of a failure mode (e.g., estimation) comprises a modification to a simplification scheme used in the analysis used for the failure prediction. For example, alteration of the failure mode(s) selected for the analysis (e.g., see FIG. 3). The option to refine the simulation (e.g., by increasing accuracy, including other failure modes, and/or increasing various tolerances, may be provided to a user (e.g., before and/or after performing the initial (e.g., rapid) failure analysis). The modification may be to at least a portion of the 3D object (e.g., several portions or the entire 3D object). The modification may be performed before, during and/or after operation of the forming instructions engine. The modification may be pre-defined, suggested, and/or executed by a user. The modification may be controlled (e.g., automatically by a controller and/or manually). Pre-definition of the modification may consider (i) a result of a failure prediction, (ii) type of failure mode, and/or (iii) object geometry. The object geometry may comprise geometries of one or more portions of the 3D object.

In some embodiments, an analyzed (e.g., estimated and/or predicted) formation failure (e.g., build error) generates a failure condition output. The failure condition may prompt a notification (e.g., a generated alert) of the analyzed formation failure output (e.g., on a display, as a message). The analyzed formation failure may be recorded (e.g., in a data log), along with associated build parameters. In some embodiments, a state of a (e.g., forming) 3D object that is formed according to generated forming instructions is monitored during the formation of the 3D object. In some embodiments, an analyzed formation failure causes a modification to the forming instructions that were generated to form the 3D object. In some embodiments, an analyzed formation failure considers an estimate of a failure condition of the forming 3D object. In some embodiments, a geometric model of a requested 3D object is rendered for display (e.g., on a computer monitor, or as a hard print). The displayed model may comprise at least a portion (e.g., all) of a 3D object corresponding to the geometric model. The displayed model may comprise an interactive model. The interactive model may facilitate altering the position of at least a portion of the geometric model of the 3D object displayed (e.g., by rotation, movement, and/or mirroring). The interactive model may facilitate altering a dimension of at least a portion of the geometric model of the 3D object displayed (e.g., by enlarging or shrinking it). An interactive model may be configured to enable selection (e.g., designation) of and/or modification to at least a portion to the 3D object. The interactive model alterations may be performed by a user (e.g., operator and/or client).

One or more forming processes may be designated for the 3D object. One or more failure mode analyses (e.g., estimations) may be designated for the 3D object. For example, a failure mode estimation may comprise suppression or coercion of any failure mode analysis. In some embodiments, a (e.g., interactive) display of a geometric model comprises an indication of any failure mode analyses that have been designated. The indication may comprise a highlight (e.g., a displayed color that differs from a surrounding displayed color) or a (e.g., blinking or pulsing) border. In some embodiments, an interactive display comprises one or more (e.g., 2D and/or 3D) zoom and/or sectional views of the geometric model. The one or more views are pre-determined and/or (e.g., manually) selected (e.g., by a user). In some embodiments, (e.g., views of) the geometric model may be freely rotated and/or panned (e.g., by a user).

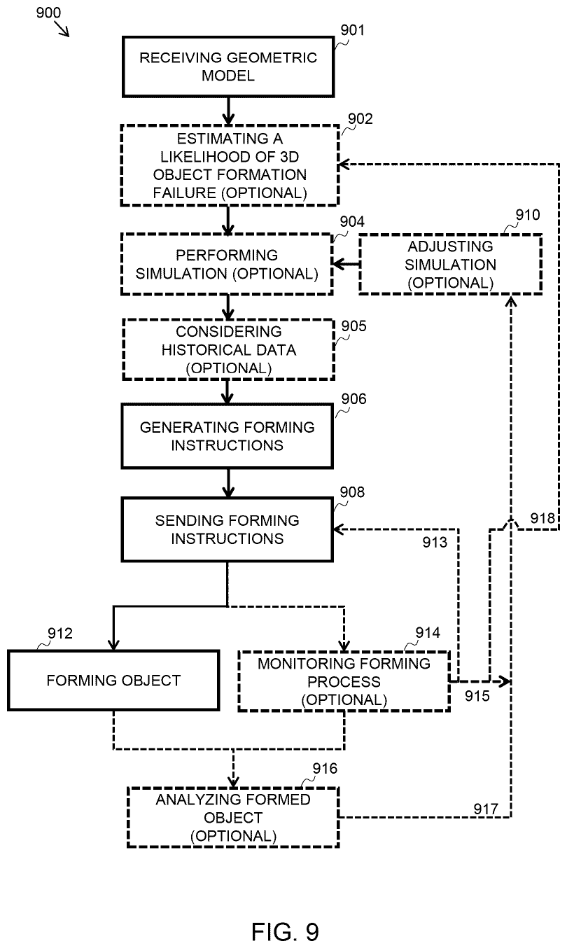

In some embodiments, forming instructions comprise control of one or more characteristics of (a) a material dispenser, (b) a platform (e.g., configured to support a forming 3D object during formation), (c) a gas flow (e.g., within an enclosure in which the 3D object is printed), and/or (d) a transforming agent (e.g., an energy beam). Characteristics of transforming agent may comprise (i) transformation rate (e.g., power density of an energy beam, flow rate of a binding agent, flow rate of the pre-transformed material, and/or flow rate of the transformed material), or (ii) path (e.g., trajectory of the transforming agent on the target surface. Characteristics of an energy beam may comprise power density at the target surface, wavelength, cross section, path (e.g., trajectory), irradiation spot size, scan speed, dwell time, intermission time, and/or power of the energy source generating the energy beam. In some embodiments, the forming instructions are generated (e.g., automatically) by default. In some embodiments, the forming instructions are suggested, and a user may select one or more forming procedure options (e.g., forming process(es) and/or forming feature(s)). The default, suggestive, or user selection of the forming instruction options may consider a curvature, an angle, a material property, a rate of formation, and/or a surface property, of the requested 3D object to be formed. Generation of the default/suggested forming instructions may comprise (e.g., preferred) historical selection by a given user, (e.g., preferred) historical selection by an average user, (e.g., preferred) historical selection by a group of users (e.g., all users). Generation of the default/suggested forming instructions may take into consideration an intended use of the 3D object to be formed. In some embodiments, the generated forming instructions are sent to one or more forming tools (e.g., printer, or welders). FIG. 9 depicts an example flowchart 900 comprising: receiving a geometric model (e.g., 901); an optional operation 902 for estimating a likelihood of 3D object formation failure; an optional operation 904 for performing a simulation (e.g., of the forming and/or the formed 3D object); an optional operation 905 for considering historical data (e.g., of a same or similar formed 3D object); and generating forming instructions (e.g., 906). In some cases, performing the simulation (e.g., FIG. 9, 904), generating forming instructions (e.g., FIG. 9, 906), and/or sending the print instructions (e.g., FIG. 9, 908) is/are performed during at least a portion of the printing. In some cases, performing the simulation (e.g., FIG. 9, 904), generating forming instructions (e.g., FIG. 9, 906), and/or sending the forming instructions (e.g., FIG. 9, 908) is/are performed before and/or during the printing. The simulation may consider the forming process of the 3D object, its physical behavior during and/or after the printing, and any structural correction. The simulation may comprise a computational model. The computational model may comprise the use of mathematics, statistics, physics or computer science. The computational model may consider historical data. The computational model may utilize machine learning. Examples of machine learning can be found in patent application serial number PCT/US17/54043, that is incorporated herein by reference in its entirety. The computational model may consider a physics model (e.g., of 3D object's forming). The structural correction may comprise any pre-print correction (abbreviated herein as “OPC”) to the model of the requested 3D object that may result in reduced deformation of the formed 3D object and adherence to the requested dimensionality constraints of the 3D object that is formed. The structural correction may comprise a geometric correction to the geometric model of the requested 3D object. Examples of structural correction can be found in patent application serial number PCT/US16/34857, titled “THREE-DIMENSIONAL PRINTING AND THREE-DIMENSIONAL OBJECTS FORMED USING THE SAME” that was filed on May 27, 2016; patent application serial number PCT/US17/18191, titled “ACCURATE THREE-DIMENSIONAL PRINTING” that was filed on Feb. 16, 2017; patent application serial number U.S. Ser. No. 15/435,065, titled “ACCURATE THREE-DIMENSIONAL PRINTING” that was filed on Feb. 16, 2017; patent application serial number EP17156707, titled “ACCURATE THREE-DIMENSIONAL PRINTING” that was filed on Feb. 17, 2017; and/or patent application serial number PCT/US17/54043, titled “THREE-DIMENSIONAL OBJECTS AND THEIR FORMATION” that was filed on Sep. 28, 2017; each of which is incorporated herein by reference in its entirety. The physical simulation may comprise thermal and/or mechanical simulation of the 3D object during its formation. Examples of physical simulation can be found in patent application serial number PCT/US16/59781, titled “ADEPT THREE-DIMENSIONAL PRINTING” that was filed on Oct. 31, 2016; patent application serial number PCT/US17/18191; patent application serial number U.S. Ser. No. 15/435,065; patent application serial number EP17156707; and/or patent application serial number PCT/US17/54043; each of which is incorporated herein by reference in its entirety. One or more objects can be formed (e.g., printed) (e.g., FIG. 9, 912) using one or more manufacturing devices (e.g., forming tools such as printers). In some embodiments, formation of the 3D object is optionally monitored (e.g., FIG. 9, 914). The monitoring can comprise using one or more detectors that detect one or more outputs (e.g., thermal, optical, chemical and/or tactile signals). The detector can comprise a sensor. In some cases, monitoring is performed in real-time during formation of the one or more 3D objects. In some cases, monitoring is done before, during and/or after printing. The monitoring may use historical measurements (e.g., as an analytical tool and/or to set a threshold value). Monitoring of one or more aspects of formation can optionally be used to (e.g., directly) modify the forming instructions (e.g., FIG. 9, 913), provide real-time (e.g., during formation) estimation of a likelihood of formation failure (e.g., FIG. 9, 918, and/or adjust the one or more simulations (e.g., FIG. 9, 915). For example, a quality of a material addition (e.g., dispense) may be monitored (e.g., planarity of a material bed). For example, one or more thermal detectors may gather (e.g., real time) thermal signals (e.g., real time thermal signature curve) at and/or in a vicinity of an irradiation spot on the target surface during printing of a 3D object. In the vicinity of the irradiation spot may include an area of at least about 1, 1.5, 2, 2.5, 3, 3.5, 4, 4.5, 5, 5.5, 6, 6.5, 7, 7.5, 8, 8.5, 9, 9.5, or 10 FLS (e.g., diameter) of a melt pool. The vicinity of the irradiation spot may include an area between any of the afore-mentioned values (e.g., from about 1 FLS to about 10 FLS, from about 1 FLS to about 5 FLS, from about 5 FLS to about 10 FLS, or from about 1 FLS to about 6 FLS) of irradiation spots. The thermal signals can be compared to a target thermal signal (e.g., target thermal signature curve) during the printing. One or more characteristics of the energy beam (e.g., power density at the target surface, wavelength, cross section, path, irradiation spot size, scan speed, dwell time, intermission time, and/or power of the energy source generating the energy beam) may be altered during formation of the 3D object to adjust the (e.g., real time) thermal signal to (e.g., substantially) match the target thermal signature (e.g., within a (pre-determined) tolerance). In some embodiments, a target thermal signal is obtained from one or more simulations (e.g., FIG. 9, 904). The target signal may be a value, a set of values, or a function (e.g., a time dependent function). The one or more 3D objects may optionally be analyzed (e.g., FIG. 9, 916). In some embodiments, a target (e.g., thermal) signal is obtained from historical data of 3D objects (or portions thereof) that have been analyzed. In some embodiments, the object(s) or portion(s) thereof is analyzed using an inspection tool (e.g., optical camera, x-ray instrument, sensor, and/or a microscope). The microscope may comprise an optical, or an electron microscope. The microscope may comprise a scanning tunneling, scanning electron, or a transmission electron microscope. The measurement may be conducted using a method comprising X-ray tomography, tensile tester, fatigue tester, eStress system, or X-ray diffraction (XRD). The measurements may be conducted at ambient temperature. The roughness can be measured with a surface profilometer. In some cases, the analysis provides data concerning geometry of the object(s). In some cases, the analysis provides data concerning one or more material properties (e.g., porosity, surface roughness, grain structure, internal strain and/or chemical composition) of the object(s). In some embodiments, the analysis data is compared to requested data. For example, a geometry of the printed object(s) may be compared with the geometry of the requested object(s). In some embodiments, the analysis data is used (e.g., FIG. 9, 917) to adjust the simulation (e.g., FIG. 9, 910). The adjusted simulation may be used, for example, in formation of subsequent object(s).

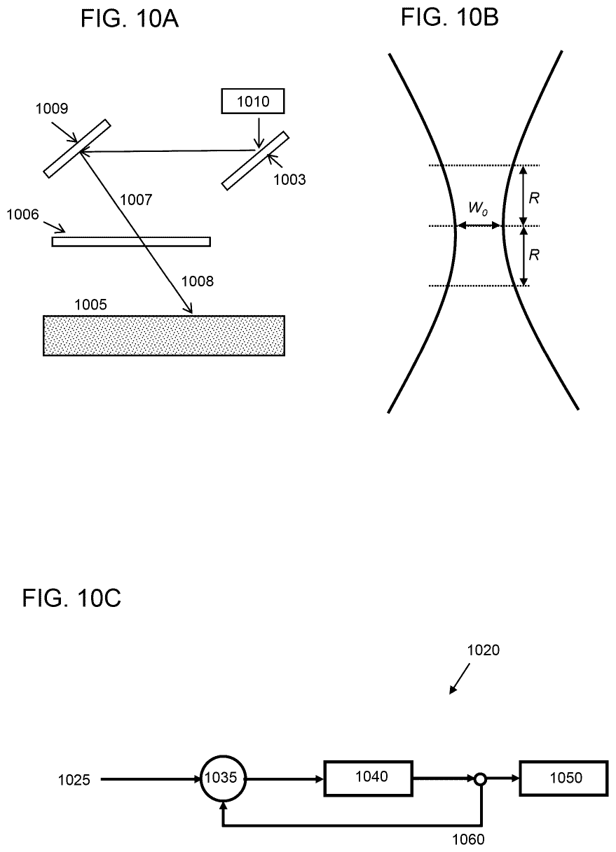

In some embodiments, the printer includes an optical system. The optical system may be used to control the one or more transforming agents (e.g., energy beams). The energy beams may comprise a single mode beam (e.g., Gaussian beam) or a multi-mode beam. The optical system may be coupled with or separate from an enclosure. The optical system may be enclosed in an optical enclosure (e.g., FIG. 1, 131). FIG. 10A shows an example of an optical system in which an energy beam is projected from the energy source 1010, is deflected by two mirrors 1003 and 1009, and travels through an optical element 1006 prior to reaching target 1005 (e.g., an exposed surface of a material bed comprising a pre-transformed material and/or hardened or partially hardened material such as from a previous transformation operation). The optical system may comprise more than one optical element. In some cases, the optical element comprises an optical window (e.g., for transmitting the energy beam into the enclosure). In some embodiments, the optical element comprises a focus altering device, e.g., for altering (e.g., focusing or defocusing) an incoming energy beam (e.g., FIG. 10A, 1007) to an outgoing energy beam (e.g., FIG. 10A, 1008). The focus altering device may comprise a lens. In some embodiments, aspects of the optical system are controlled by one or more controllers of the printer. For example, one or more controllers may control one or more mirrors (e.g., of galvanometer scanners) that directs movement of the one or more energy beams in real time. Examples of various aspects of optical systems and their components can be found in U.S. patent application Ser. No. 15/435,128, filed on Feb. 16, 2017, titled “ACCURATE THREE-DIMENSIONAL PRINTING;” international patent application number PCT/US17/18191, filed on Feb. 16, 2017, titled “ACCURATE THREE-DIMENSIONAL PRINTING;” European patent application number EP17156707.6, filed on Feb. 17, 2017, titled “ACCURATE THREE-DIMENSIONAL PRINTING;” international patent application number PCT/US17/64474, filed Dec. 4, 2017, titled “OPTICS, DETECTORS, AND THREE-DIMENSIONAL PRINTING;” and international patent application number PCT/US18/12250, filed Jan. 3, 2018, titled “OPTICS IN THREE-DIMENSIONAL PRINTING,” each of which is entirely incorporated herein by reference.

In some cases, the optical system modifies a focus of the one or more energy beams at the target surface (or adjacent thereto, e.g., above or below the target surface to form a defocused beam spot at the target surface). In some embodiments, the energy beam is (e.g., substantially) focused at the target surface. In some embodiments, the energy beam is defocused at the target surface. An energy beam that is focused at the target surface may have a (e.g., substantially) minimum spot size at the target surface. An energy beam that is defocused at the target surface may have a spot size at the target surface that is (e.g., substantially) greater than the minimum spot size, for example, by a pre-determined amount. For example, a Gaussian energy beam that is defocused at the target surface can have spot size that is outside of a Rayleigh distance from the energy beams focus (also referred to herein as the beam waist). FIG. 10B shows an example profile of a Gaussian beam as a function of distance. The target surface of a focused energy beam may be within a Rayleigh distance (e.g., FIG. 10B, R) from the beam waist (e.g., FIG. 10B, Wo).

In some cases, one or more controllers control the operation of one or more components of a manufacturing device. For example, one or more controllers may control one or more aspects (e.g., movement and/or speed) of a layer forming apparatus. One or more controllers may control one or more aspects of an energy source (e.g., energy beam power, scan speed and/or scan path). One or more controllers may control one or more aspects of an energy beam optical system (e.g., energy beam scan path and/or energy beam focus). One or more controllers may control one or more operations of a gas flow system (e.g., gas flow speed and/or direction). In some embodiments, one or more controllers control aspects of multiple components or systems. For example, a first controller can control aspects of the energy source(s), a second controller can control aspects of a layer forming apparatus(es), and a third controller can control aspects of a gas flow system. In some embodiments, one or more controller controls aspect of one component or system. For example, multiple controllers may control aspects of an optical system. For instance, a first controller can control the path of the one or more energy beams, a second controller may control scan speed of the one or more energy beams, and a third controller may control a focus of the one or more energy beams. As another example, multiple controllers may control aspects of an energy source. For instance, a first controller can control the power of one or more energy beams, a second controller may control pulsing (e.g., pulse versus continuous, or pulse rate) of the one or more energy beams, and a third controller may control a power profile over time (e.g., ramp up and down) one or more energy beams. At times, the first controller, second controller, and the third controller are the same controller. At times, at least two of the first controller, second controller, and the third controller are different controllers. Any combination of one or more controllers may control aspects of one or more components or systems of a printer. The one or more controllers may control the operations before, during, and/or after the printing, or a portion of the printing (irradiation operation). The controller may comprise an electrical circuitry, one or more electrical wiring, a signal receiver, and/or a signal emitter. The controller may be operatively coupled to one or more components of the forming apparatus via a connecter and/or signal communication. The connection may be wired and/or wireless. The controller may communicate via signal receipt and/or transmission. The signal may comprise electrical, optical or audio signal.

In some instances, the controller(s) can include (e.g., electrical) circuitry that is configured to generate output (e.g., voltage signals) for directing one or more aspects of the apparatuses (or any parts thereof) described herein. FIG. 10C shows a schematic example of a (e.g., automatic) controller (e.g., a control system, or a controller) 1020 that is programmed or otherwise configured to facilitate formation of one or more 3D objects. The controller may comprise an electrical circuitry. The controller may comprise a connection to an electrical power. The controller (e.g., FIG. 10C, 1020) can comprise a subordinate-controller 1040 for controlling formation of at least one 3D object (e.g., FIG. 10C, 1050). The controller may comprise one or more loop schemes (e.g., open loop, feed-forward loop and/or feedback loop). In the example of FIG. 10C, the controller optionally includes feedback control loop 1060. The subordinate-controller may be an internal-controller. The controller (e.g., or subordinate controller) may comprise a proportion-integral-derivative (PID) loop. The subordinate-controller can be a second controller as part of the first controller. The subordinate-controller can be a linear controller. The controller may be configured to control one or more components of the forming tool. The controller may be configured to control a transforming agent generator (e.g., an energy source, a dispenser of the binding agent and/or reactive agent), a guidance mechanism (e.g., scanner and/or actuator), at least one component of a layer dispenser, a dispenser (e.g., of a pre-transformed material and/or a transforming agent), at least one component of a gas flow system, at least one component of a chamber in which the 3D object is formed (e.g., a door, an elevator, a valve, a pump, and/or a sensor). The controller may control at least one component of the forming apparatus such as the forming agent (e.g., transforming agent). For example, the controller (e.g., FIG. 10C, 1020) may be configured to control (e.g., in real time, during at least a portion of the 3D printing) a controllable property comprising: (i) an energy beam power (e.g., delivered to the material bed), (ii) temperature at a position in the material bed (e.g., on the forming 3D object), (iii) energy beam speed, (iv) energy beam power density, (v) energy beam dwell time, (vi) energy beam irradiation spot (e.g., on the exposed surface of the material bed), (vii) energy beam focus (e.g., focus or defocus), or (viii) energy beam cross-section (e.g., beam waist). The controller (e.g., FIG. 10C, 1020) may be configured to control (e.g., in real time, during at least a portion of the 3D printing) a controllable (e.g., binding and/or reactive agent) property comprising: (i) strength (e.g., reaction rate), (ii) volume (e.g., delivered to the material bed), (iii) density (e.g., on a location of the material bed), or (iv) dwell time (e.g., on the material bed). The controllable property may be a control variable. The control may be to maintain a target parameter (e.g., temperature) of one or more 3D objects being formed. The target parameter may vary in time (e.g., in real time) and/or in location. The location may comprise a location at the exposed surface of the material bed. The location may comprise a location at the top surface of the (e.g., forming) 3D object. The target parameter may correlate to the controllable property. The (e.g., input) target parameter may vary in time and/or location in the material bed (e.g., on the forming 3D object). The subordinate-controller may receive a pre-determined power per unit area (of the energy beam), temperature, and/or metrological (e.g., height) target value. For example, the subordinate-controller may receive a target parameter (e.g., FIG. 10C, 1025) (e.g. temperature) to maintain at least one characteristic of the forming 3D object (e.g., dimension in a direction, and/or temperature). The controller can receive multiple (e.g., three) types of target inputs: (i) characteristic of the transforming agent (e.g., energy beam power), (ii) temperature, and (iii) geometry. Any of the target input may be user defined. The geometry may comprise geometrical object pre-print correction (OPC). The geometric information may derive from the 3D object (or a correctively deviated (e.g., altered) model thereof). The geometry may comprise geometric information of a previously printed portion of the 3D object (e.g., comprising a local thickness below a given layer, local build angle, local build curvature, proximity to an edge on a given layer, or proximity to layer boundaries). The geometry may be an input to the controller (e.g., via an open loop control scheme). Some of the target values may be used to form 3D forming instructions for generating the 3D object (e.g., FIG. 10C, 1050). The forming instructions may be dynamically adjusted in real time. The controller may monitor (e.g., continuously) one or more signals from one or more sensors for providing feedback (e.g., FIG. 10C, 1060). For example, the controller may monitor the energy beam power, temperature of a position in the material bed, and/or metrology (e.g., height) of a position on the target surface (e.g., exposed surface of a material bed). The position on the target surface may be of the forming 3D object. The monitor may be continuous or discontinuous. The monitor may be in real-time during the 3D printing. The monitor may be using the one or more sensors. The forming instructions may be dynamically adjusted in real time (e.g., using the signals from the one or more sensors). A variation between the target parameter and the sensed parameter may be used to estimate an error in the value of that parameter (e.g., FIG. 10C, 1035). The variation (e.g., error) may be used by the subordinate-controller (e.g., FIG. 10C, 1040) to adjust the forming instructions. The controller may control (e.g., continuously) one or more parameters (e.g., in real time). The controller may use historical data (e.g., for the parameters). The historical data may be of previously printed 3D objects, or of previously printed layers of the 3D object. Configured may comprise built, constructed, designed, patterned, or arranged. The hardware of the controller may comprise the control-model. The control-model may be linear or non-linear. For example, the control-model may be non-linear. The control-model may comprise linear or non-linear modes. The control-model may comprise free parameters which may be estimated using a characterization process. The characterization process may be before, during and/or after the 3D printing. The control-model may be wired to the controller. The control model can be configured into the controller (e.g., before and/or during the 3D printing). Examples of a controller, subordinate controller, and/or control-model can be found in patent application serial number PCT/US16/59781; patent application serial number PCT/US17/18191; patent application serial number U.S. Ser. No. 15/435,065; patent application serial number EP17156707; and/or patent application serial number PCT/US17/54043; each of which is incorporated herein by reference in its entirety.

In some embodiments, the physical behavior (e.g., embedded in a physical model) is represented by an analogous model (e.g., an electrical model, an electronic model, and/or a mechanical model). FIGS. 14A-14B illustrate examples of an electrical analogous model. FIG. 14A illustrates an example of a simplified electrical analogous model (e.g., a first order of complexity model). The electrical model may represent a simplified physics model (e.g., be used for a simplified simulation). The electrical model may include one or more basic elements, for example, a current source (e.g., FIG. 14A, 1460), a resistor (e.g., FIG. 14A, 1468), a capacitor (e.g., FIG. 14A, 1477), an inductor, and/or a ground component (e.g., FIG. 14A, 1484). The basic elements may represent one or more physical properties of forming a 3D object. At times, the basic elements may represent one or more components of the 3D printer. For example, the energy beam may be represented by a current source. In some examples, the angle of at least a portion of the 3D object (e.g., a given overhang thereof) may affect the capacitance and/or resistor values representing a point on the edge of that at least a portion of the 3D object (e.g., the given overhang). For example, the larger the overhang angle with respect to the target (e.g., exposed) surface (e.g., the steeper the overhang), the smaller the resistor will be in the physical-model, and the larger the capacitance in the physical-model. The value of at least one resistor and/or capacitance may be related to (i) the discretization distance and/or (ii) the fundamental material properties forming the 3D object. The discretization distance may be the physical length of a unit element (e.g., electrical element) which is represented by the basic discrete elements. The fundamental material properties of the build material may comprise the thermal conductivity, the heat capacity, or the density of the build material (e.g., material forming the 3D object). In some examples, the measured voltage probe points (in the physical model), such as 1465, represent a measurement of the surface temperature (in the forming/formed 3D object). Closed loop and/or feedback control may be modeled by a change of the current source as a response to a change in the measured voltage, at the probe point (e.g., 1465). The model can also predict the measured voltages (e.g., that can represent measured temperature). The simplified (e.g., reduced) model may not be limited to simple and/or constant value components. As an example, the capacitors and/or resistors can depend on the voltage, C(V) and/or R(V), respectively. Additional components that can be used are, for example, a current multiplier. The value of the current multiplier can represent in the physical model a change in the absorption efficiency of the energy beam by the material in the 3D printing. For example, as the value of the current multiplier can depend on the voltage (imitating the physical property of the absorption that can depend on the temperature). The voltage may be used to simulate a dependence (e.g., a temperature) of the capacitor and/or the resistor (e.g., C(V), and/or R(V)).

In some embodiments, the physical model comprises an analog or digital model. The model may comprise an electronic model. The model may comprise a basic element. The basic element may be an electrical (e.g., electronic) element. The electrical element may comprise active, passive, or electromechanical components. The active components may comprise a diode, transistor, an integrated circuit, an optoelectronic device, display device, vacuum tube, discharge device, or a power source. The passive components may comprise a resistor, a capacitor, a magnetic (inductive) device, a memristor, a network, a transducer, a sensor, a detector, an antenna, an oscillator, a display device, a filter (e.g., electronic filter), a wire-wrap, or a breadboard. The electromechanical components may comprise a mechanical accessory, a (e.g., printed) circuit board, or a memristor. The basic elements may be variable devices and/or have a variable value (for example, a variable resistor, and/or a variable capacitor). The resistor may be a linear resistor, non-linear resistor, carbon composition resistor, wire wound resistor, thin film resistor, carbon film resistor, metal film resistor, thick film resistor, metal oxide resistor, cermet oxide resistor, fusible resistor, variable resistor, potentiometer, rheostat, trimmer, thermistor, varistor, light dependent resistor, photo resistor, photo conductive cell, or a surface mount resistor. The capacitor may be a ceramic, film, paper, polarized, non-polarized, aluminum electrolytic, a tantalum electrolytic, niobium electrolytic, polymer, double layer, pseudo, hybrid, silver, mica, silicon, air gap, or a vacuum capacitor. The inductor may be an air core inductor, ferro magnetic core inductor, iron core inductor, ferrite core inductor, toroidal core inductor, bobbin based inductor, multi-layer inductor, thin film inductor, coupled inductor, plastic molded inductor, ceramic molded inductor, power inductor, high frequency inductor, radio frequency inductor, choke, surface mount inductor, or a laminated core inductor. The physical model may be incorporated in a processor (e.g., computer). The physical model may comprise a circuit analog (e.g., in a processor). For example, the physical model may comprise a virtual circuit analog. The physical model may comprise a tangible circuit. The physical model may comprise a circuit board. The circuit boards may comprise the one or more electrical elements.

FIG. 14B illustrates an example of a more complex electrical analogous model (e.g., a second order of complexity model) relative to the one in FIG. 14A. The more complex electrical analogous model may include one or more basic electrical elements (e.g., a current source 1405, a resistor 1420, a capacitor 1440, and/or a ground element 1445). The basic element may include a multiplier (e.g., a constant value represented in the FIG. 14B, as “a” for the capacitor or “b” for the resistor). The multiplier may be variable. At times, the complex electrical analogous model may be (e.g., substantially) complete (e.g., include representation for all dimensions, and/or properties of a physical model of the 3D object). Substantially may be relative to the intended purpose of the 3D object. The complex (e.g., more complex) electrical analogous model may include input from one or more sensors and/or detectors. A sensor or detector may sense or detect (respectively) a physical property of at least one position on the target surface (e.g., temperature of the target surface (e.g., temperature distribution thereof), power density of the energy beam, thermal map of the path of the energy beam, thermal map of the forming 3D object, and/or thermal map of the material bed). The sensor/detector input may be fed (e.g., FIG. 14B, 1410, 1415, 1425) into one or more branches (e.g., FIG. 14B, 1430) of the analogous electrical model (for example, a single branch may receive input from a single sensor, a single branch may receive input from more than one sensor, or multiple branches may receive input from a single sensor). Examples of analogous models can be found in U.S. patent application Ser. No. 15/435,090, titled “ACCURATE THREE-DIMENSIONAL PRINTING” that was filed Feb. 16, 2017, which is incorporated herein by reference in its entirety.

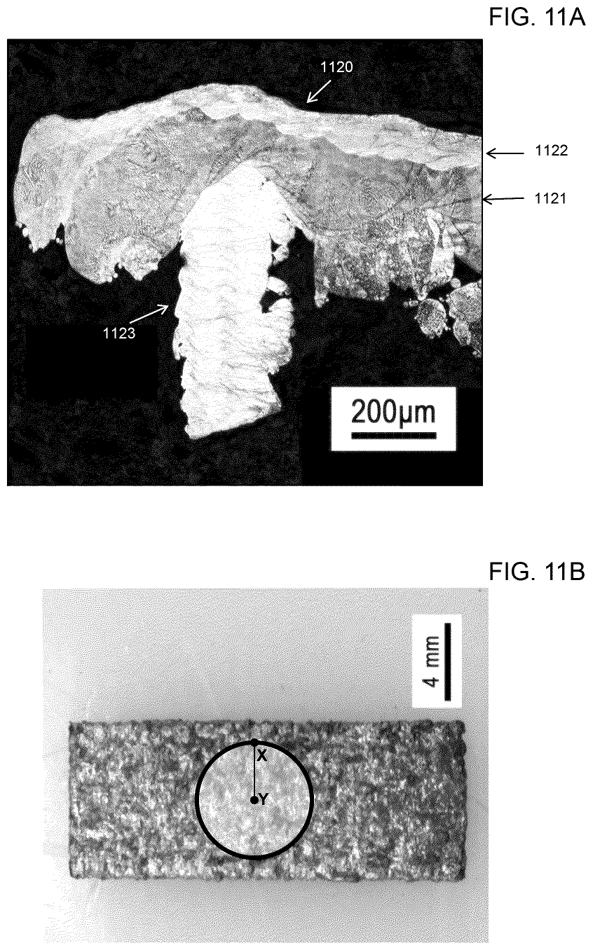

In some cases, the supports (or a portion thereof) are removed from the 3D object after formation (e.g., after printing, e.g., post processing). Removal can comprise machining (e.g., cutting, sawing and/or milling), polishing (e.g., sanding) and/or etching. Removal can comprise beam (e.g., laser) etching or chemical etching. In some cases, the supports (or a portion thereof) remain in and/or on the 3D object after printing. In some cases, the one or more supports leave respective one or more support marks on the 3D object that are indicative of a presence or removal of the one or more supports. FIG. 11A shows an example of a vertical cross section of a 3D object that includes a main portion 1120 coupled with a support 1123. In some cases, the main portion comprises multiple layers (e.g., 1121 and 1122) that were sequentially added (e.g., after formation of the support) during a printing operation. In some cases, the support causes one or more layers of the portion of the 3D object to deform during printing. Sometimes, the deformed layers form a detectable (e.g., visible) mark. The mark may be a region of discontinuity in the layer, such as a microstructure discontinuity and/or an abrupt microstructural variation (e.g., FIG. 11A). The discontinuity in the microstructure may be explained by an inclusion of a foreign object (e.g., the support). The microstructural variation may include (e.g., abruptly) altered melt pools and/or grain structure (e.g., crystals, e.g., dendrites) at or near the attachment point of the support. The microstructure variation may be due to differential thermal gradients due to the presence of the support. The microstructure variation may be due to a forced melt pool and/or layer geometry due to the presence of the support. The discontinuity may be at an external surface of the 3D object. The discontinuity may arise from inclusion of the support to the surface of the 3D object (e.g. and may be visible as a breakage of the support when removed from the 3D object (e.g., after printing). In some instances, the 3D object includes two or more support and/or support marks. If more than one support is used, the supports may be spaced apart by a (e.g., pre-determined) distance. FIG. 11B shows an example 3D object having points X and Y on a surface of the 3D object. In some embodiments, X is spaced apart from Y by a support spacing distance. For example, a sphere of radius XY that is centered at X may lack one or more supports (or one or more support marks).

In some embodiments, an overhang is formed on a previously transformed portion (also referred to herein as rigid portion) of the object. FIG. 12A shows an example schematic depiction of an overhang 1222 connected to a rigid portion 1220. The rigid portion may be connected (e.g., anchored) to a platform (e.g., FIG. 12A, 1215) (e.g., base of the platform). The overhang may be printed without auxiliary supports other than the connection to the one or more rigid portions (e.g., that are part of the 3D object). The overhang may be formed at an angle (e.g., FIG. 12A, 1230) with respect to the build plane and/or platform (e.g., FIG. 12A, 1215). The overhang and/or the rigid portion may be formed from the same or different pre-transformed material (e.g., powder). The overhang can form a first angle (e.g., FIG. 12A, 1225) with respect to the rigid portion (e.g., FIG. 12A, 1220). The overhang can form a second angle (e.g., FIG. 12A, 1230) with respect to a plane (e.g., FIG. 12A, 1231) that is (e.g., substantially) parallel with the support surface of the platform, to the layering plane, and/or normal to global vector (e.g., were the layer refer to the layerwise deposition of the transformed material to form the 3D object). In some embodiments, a plane (e.g., FIG. 12A, 1231) that is (e.g., substantially) parallel with the support surface of the platform corresponds to a layering plane.

In some embodiments, 3D printing methodologies are employed for forming (e.g., printing) at least one 3D object that is substantially two-dimensional, such as a wire or a planar object. The 3D object may comprise a plane-like structure (referred to herein as “planar object,” “three-dimensional plane,” or “3D plane”). The 3D plane may have a relatively small thickness as compared to a relatively large surface area. The 3D plane may have a relatively small height relative to its width and length. For example, the 3D plane may have a small height relative to a large horizontal plane. FIG. 12B shows an example of a 3D plane that is substantially planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface. The one or more layers within the 3D object may be substantially planar (e.g., flat). The planarity of a surface or a boundary the layer may be (e.g., substantially) uniform. Substantially uniform may be relative to the intended purpose of the 3D object. The height of the layer at a position may be compared to an average layering plane. The layering plane can refer to a plane at which a layer of the 3D object is (e.g., substantially) oriented during printing. A boundary between two adjacent (printed) layers of hardened material of the 3D object may define a layering plane. The boundary may be apparent by, for example, one or more melt pool terminuses (e.g., bottom or top). A 3D object may include a plurality of layering planes (e.g., with each layering plane corresponding to each layer). In some embodiments, the layering planes are (e.g., substantially) parallel to one another. An average layering plane may be defined by a linear regression analysis (e.g., least squares planar fit of the top-most part of the surface of the layer of hardened material). An average layering plane may be a plane calculated by averaging the material height at each selected point on the top surface of the layer of hardened material. The selected points may be within a specified region of the 3D object. The deviation from any point at the surface of the planar layer of hardened material may be at most 20% 15%, 10%, 5%, 3%, 1%, or 0.5% of the height (e.g., thickness) of the layer of hardened material.

FIG. 12C shows an example of a first (e.g., top) surface 1260 and a second (e.g., bottom) surface 1262 of a 3D object. At least a portion of the first and second surface may be separated by a gap. At least a portion of the first surface may be separated from at least a portion of the second surface (e.g., to constitute a gap). The gap may be filled with pre-transformed or transformed (e.g., and subsequently hardened) material, e.g., during the formation of the 3D object. The second surface may be a bottom skin layer. FIG. 12C shows an example of a vertical gap distance 1240 that separates the first surface 1260 from the second surface 1262. Point A (e.g., in FIG. 12C) may reside on the top surface of the first portion. Point B may reside on the bottom surface of the second portion. The second portion may be a cavity ceiling or hanging structure as part of the 3D object. Point B (e.g., in FIG. 12C) may reside above point A. Above (e.g., top) may be with respect to a global vector 1200. For example, for two positions in a 3D printing system, a (e.g., second) position (e.g., FIG. 12C, B) that has a lower global vector value than a (e.g., first) position (e.g., FIG. 12, A) is above the (e.g., second) position. The gap may be the (e.g., shortest) distance (e.g., vertical distance) between points A and B. FIG. 12C shows an example of the gap 1268 that constitutes the shortest distance d_{AB} between points A and B. There may be a first normal to the bottom surface of the second portion at point B. FIG. 12C shows an example of a first normal 1272 to the surface 1262 at point B. The angle between the first normal 1272 and a direction of global vector 1270 may be any angle γ. A global vector may be (a) directed to a gravitational center, (b) directed opposite to the direction of a layer-wise deposition to print a three-dimensional object, and/or (c) normal to a platform configured to support the three-dimensional object during its printing, and directed opposite to a surface of the platform that supports the three-dimensional object. Point C may reside on the bottom surface of the second portion. There may be a second normal to the bottom surface of the second portion at point C. FIG. 12C shows an example of the second normal 1274 to the surface 1262 at point C. The angle between the second normal 1272 and the global vector 1270 may be any angle δ. Vectors 1280, and 1281 are parallel to the global vector 1270. The angles γ and δ may be the same or different. The angle between the first normal 1272 and/or the second normal 1274 to the global vector 1200 may be any angle alpha disclosed herein. For example, the angle alpha (α) may be at most about 45°, 40°, 30°, 20°, 100, 5°, 3°, 2°, 1°, or 0.5°. The angle alpha may be any value of the afore-mentioned values (e.g., at most about 45° to about 0.5°, from about 45° to about 20°, or from about 20° to about 0.5°). Examples of an auxiliary support structure and auxiliary support feature spacing distance (e.g., the shortest distance between points B and C) can be found in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. FIG. 12C shows an example of the shortest distance BC (e.g., 1290, d_{BC}). The bottom skin layer may be the first surface and/or the second surface. The bottom skin layer may be the first formed layer of the 3D object. The bottom skin layer may be a first formed hanging layer in the 3D object (e.g., that is separated by a gap from a previously formed layer of the 3D object). The vertical distance of the gap may be at least about 30 μm, 35 μm, 40 μm, 50 μm, 60 μm, 70 μm, 80 μm, 90 μm, 100 μm, 150 μm, 200 μm, 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm or 20 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about 0.05 mm to about 20 mm, from about 0.05 mm to about 0.5 mm, from about 0.2 mm to about 3 mm, from about 0.1 mm to about 10 mm, or from about 3 mm to about 20 mm).

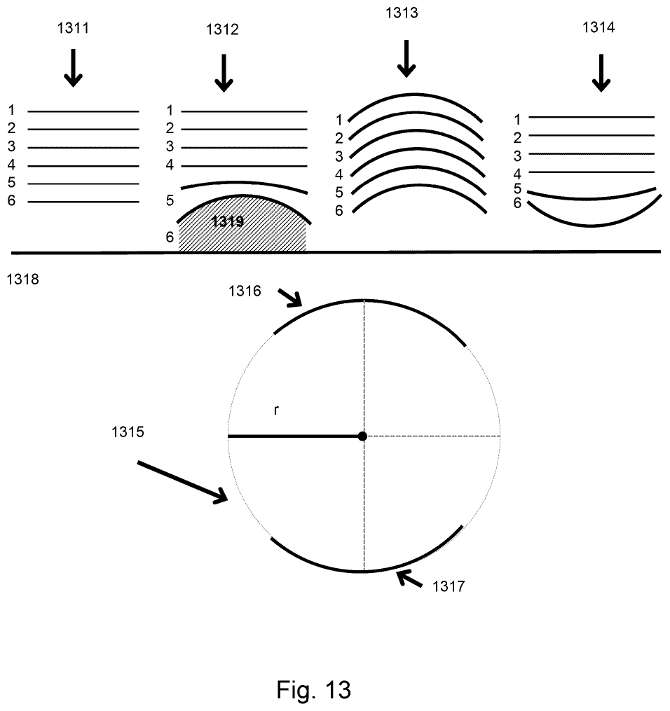

The one or more layers within the 3D object may be substantially planar (e.g., flat). The planarity of the layer may be substantially uniform. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The substantially planar one or more layers may have a (e.g., large radius of) curvature. The curvature can be positive or negative with respect to a normal to the global vector, platform and/or the exposed surface of a material bed in which the 3D object is formed. FIG. 13 shows an example of a vertical cross section of a 3D object 1312 comprising planar layers (layers numbers 1-4) and non-planar layers (e.g., layers numbers 5-6) that have a radius of curvature. An example of a vertical cross section of a 3D object 1311 comprises layers 1 to 6, each of which are substantially planar. A curvature (e.g., of a layer) can be positive or negative with respect to the platform and/or the exposed surface of the material bed. For example, layered structure 1312 comprises layer number 6 that has a curvature that is negative, as the volume (e.g., area in a vertical cross section of the volume) bound from the bottom of it to the platform 1318 is a convex object 1319. Layer number 5 of 1312 has a curvature that is negative. Layer number 6 of 1312 has a curvature that is more negative (e.g., has a curvature of greater negative value) than layer number 5 of 1312. Layer number 4 of 1312 has a curvature that is (e.g., substantially) zero. Layer number 6 of 1314 has a curvature that is positive. Layer number 6 of 1312 has a curvature that is more negative than layer number 5 of 1312, layer number 4 of 1312, and layer number 6 of 1314. Layer numbers 1-6 of 1313 are of substantially uniform (e.g., negative curvature). FIGS. 13, 1316 and 1317 are super-positions of curved layer on a circle 1315 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or infinity (i.e., flat, or planar layer). The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object has the radius of curvature mentioned herein.

In some embodiments, the forming agent (e.g., transforming agent) is an energy beam. At times, the energy beam is directed onto a specified area of at least a portion of the target surface for a specified time period. The (e.g., pre-transformed) material in or at the target surface (e.g., powder material such as in a top surface of a powder bed) can absorb the energy from the energy beam and, and as a result, a localized region of the material can increase in temperature. In some instances, one, two, or more 3D objects are generated in a material bed (e.g., a single material bed; the same material bed). The plurality of 3D objects may be generated in the material bed simultaneously or sequentially. At least two 3D objects may be generated side by side. At least two 3D objects may be generated one on top of the other. At least two 3D objects generated in the material bed may have a gap between them (e.g., gap filled with pre-transformed material). At least two 3D objects generated in the material bed may contact (e.g., not connect to) each other. In some embodiments, the 3D objects may be independently built one above the other. The generation of a multiplicity of 3D objects in the material bed may allow continuous creation of 3D objects.

A pre-transformed material may be a powder material. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) may have any value of the afore-mentioned layer thickness values (e.g., from about 0.1 μm to about 1000 μm, from about 1 μm to about 800 μm, from about 20 μm to about 600 μm, from about 30 μm to about 300 μm, or from about 10 μm to about 1000 μm).

At times, the pre-transformed material comprises a powder material. The pre-transformed material may comprise a solid material. The pre-transformed material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprises particles having an average FLS of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. In some embodiments, the powder may have an average fundamental length scale of any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The powder in a material bed may be flowable (e.g., retain its flowability) during the printing.

At times, the powder is composed of individual particles. The individual particles can be spherical, oval, prismatic, cubic, or irregularly shaped. The particles can have a FLS. The powder can be composed of a homogenously shaped particle mixture such that all of the particles have substantially the same shape and fundamental length scale magnitude within at most about 1%, 5%, 8%, 10%, 15%, 20%, 25%, 30%, 35%, 40%, 50%, 60%, or 70%, distribution of FLS. In some embodiments, the powder may have a distribution of FLS of any of the values of the average particle FLS listed above (e.g., from at most about 1% to about 70%, about 1% to about 35%, or about 35% to about 70%). In some embodiments, the powder can be a heterogeneous mixture such that the particles have variable shape and/or fundamental length scale magnitude.

At times, at least parts of the layer are transformed to a transformed material that subsequently forms at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may comprise vertical or horizontal deviation.

At times, the pre-transformed material is requested and/or pre-determined for the 3D object. The pre-transformed material can be chosen such that the material is the requested and/or otherwise predetermined material for the 3D object. A layer of the 3D object may comprise a single type of material. For example, a layer of the 3D object may comprise a single metal alloy type. In some examples, a layer within the 3D object may comprise several types of material (e.g., an elemental metal and an alloy, several alloy types, several alloy phases, or any combination thereof). In certain embodiments, each type of material comprises only a single member of that type. For example, a single member of metal alloy (e.g., Aluminum Copper alloy). In some cases, a layer of the 3D object comprises more than one type of material. In some cases, a layer of the 3D object comprises more than one member of a material type.

In some instances, the elemental metal comprises an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

In some instances, the metal alloy comprises an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising a device, medical device (human & veterinary), machinery, cell phone, semiconductor equipment, generators, turbine, stator, motor, rotor, impeller, engine, piston, electronics (e.g., circuits), electronic equipment, agriculture equipment, gear, transmission, communication equipment, computing equipment (e.g., laptop, cell phone, ipad), air conditioning, generators, furniture, musical equipment, art, jewelry, cooking equipment, or sport gear. The impeller may be a shrouded (e.g., covered) impeller that is produced as one piece (e.g., comprising blades and cover) during one 3D printing procedure. The 3D object may comprise a blade. The impeller may be used for pumps (e.g., turbo pumps). Examples of an impeller and/or blade can be found in U.S. patent application Ser. No. 15/435,128, filed on Feb. 16, 2017; PCT patent application number PCT/US17/18191, filed on Feb. 16, 2017; or European patent application number. EP17156707.6, filed on Feb. 17, 2017, all titled “ACCURATE THREE-DIMENSIONAL PRINTING,” each of which is incorporated herein by reference in its entirety where non-contradictory. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

In some instances, the alloy includes a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or cmSX (e.g., cmSX-3, or cmSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

In some instances, the titanium-based alloy comprises alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

In some instances, the Nickel alloy comprises Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e. g. Talonite), Ultimet, or Vitallium. The chromium alloy may comprise chromium hydroxide, or Nichrome.

In some instances, the aluminum alloy comprises AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg-AI-Zn (Bergman phase) alloy.

In some instances, the copper alloy comprises Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some instances, the metal alloys are Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some examples, the material (e.g., pre-transformed material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Q*m), 5*10⁻⁶ Ω*m 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1*10⁻⁵ Ω*m to about 1*10⁻⁸ Ω*m). The high thermal conductivity may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³, from about 1 g/cm³ to about 10 g/cm³, or from about 10 g/cm³ to about 25 g/cm³).

At times, a metallic material (e.g., elemental metal or metal alloy) comprises small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

In some embodiments, a pre-transformed material within the enclosure is in the form of a powder, wires, sheets, or droplets. The material (e.g., pre-transformed, transformed, and/or hardened) may comprise elemental metal, metal alloy, ceramics, an allotrope of elemental carbon, polymer, and/or resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may comprise high performance material (HPM). The ceramic material may comprise a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or comprising (e.g., with) metal alloy. The material may comprise a stainless steel. The material may comprise a titanium alloy, aluminum alloy, and/or nickel alloy.

At times, one or more controllers are configured to control (e.g., direct) one or more apparatuses and/or operations utilized during formation of the 3D object(s). Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The controller may comprise an electronic circuitry, and electrical inlet, or an electrical outlet. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) that comprises a visual, auditory, olfactory, or a tactile signal.

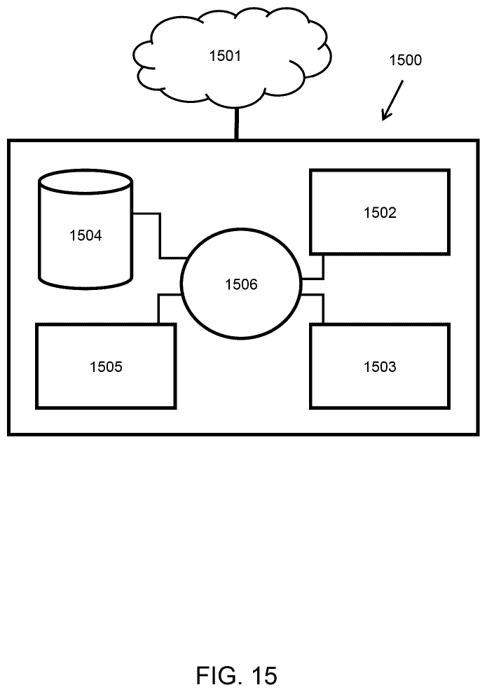

The controller may comprise processing circuitry (e.g., a processing unit). The processing unit may be central. The processing unit may comprise a central processing unit (herein “CPU”). The controllers or control mechanisms (e.g., comprising a computer system) may be configured to (e.g., programmed to) implement methods of the disclosure. The controller may control at least one component of the systems and/or apparatuses disclosed herein. FIG. 15 is a schematic example of a computer system 1500 that is programmed or otherwise configured to facilitate the formation of a 3D object according to the methods provided herein. The computer system 1500 can control (e.g., direct and/or regulate) various features of printing methods, apparatuses and systems of the present disclosure, such as, for example, estimating a likelihood of a failure of, and/or generation of forming instructions for, formation of a 3D object. Estimating a likelihood of failure may comprise an analysis that considers a geometry and/or orientation of the 3D object. The analysis may be performed before and/or during generation of forming instructions and/or formation of the 3D object. In some embodiments, the analysis may consider a (e.g., physics model) simulation of a process of forming at least a portion of the 3D object and/or the reaction of the 3D object to its formation (e.g., a post formation relaxation process within the formed 3D object). The physics model may be a simplified (e.g., physics model) simulation of at least a portion of the 3D object. At times, the analysis may not consider a (e.g., physics model) simulation of at least a portion of the 3D object. Generated forming instructions may comprise application of a pre-transformed material, application of an amount of energy emitted to a selected location, a detection system activation and deactivation, sensor data and/or signal acquisition, image processing, process parameters (e.g., dispenser layer height, planarization, chamber pressure), or any combination thereof. The computer system 1500 can be part of, or be in communication with, a forming (e.g., printing) system or apparatus, such as a 3D printing system or apparatus of the present disclosure. The processor may be coupled to one or more mechanisms disclosed herein, and/or any parts thereof. For example, the computer may be coupled to one or more transforming elements (e.g., energy sources), dispensers, optical elements, processing chamber, build module, platform, sensors, valves, switches, motors, pumps, or any combination thereof.

The computer system 1500 can include a processing unit 1506 (also “processor,” “computer” and “computer processor” used herein). The computer system may include memory or memory location 1502 (e.g., random-access memory, read-only memory, flash memory), electronic storage unit 1504 (e.g., hard disk), communication interface 1503 (e.g., network adapter) for communicating with one or more other systems, and peripheral devices 1505, such as cache, other memory, data storage and/or electronic display adapters. The memory 1502, storage unit 1504, interface 1503, and peripheral devices 1505 are in communication with the processing unit 1506 through a communication bus (solid lines), such as a motherboard. The storage unit can be a data storage unit (or data repository) for storing data. The computer system can be operatively coupled to a computer network (“network”) 1501 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1502. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1500 can be included in the circuit.

The storage unit 1504 can store files, such as drivers, libraries, and saved programs. The storage unit can store user data, e.g., user preferences and user programs. The storage unit may store one or more geometric models. The storage unit may store any region(s) (e.g., portions) of the one or more geometric models associated with an analysis of failure (e.g., auxiliary supports, overhangs and/or cavities). The storage unit may store any (e.g., designated) forming processes associated with the one or more geometric models. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 1502 or electronic storage unit 1504. The machine executable or machine-readable code can be provided in the form of software. During use, the processor 1506 can execute the code. In some cases, the code can be retrieved from the storage unit and stored on the memory for ready access by the processor. In some situations, the electronic storage unit can be precluded, and machine-executable instructions are stored on memory.

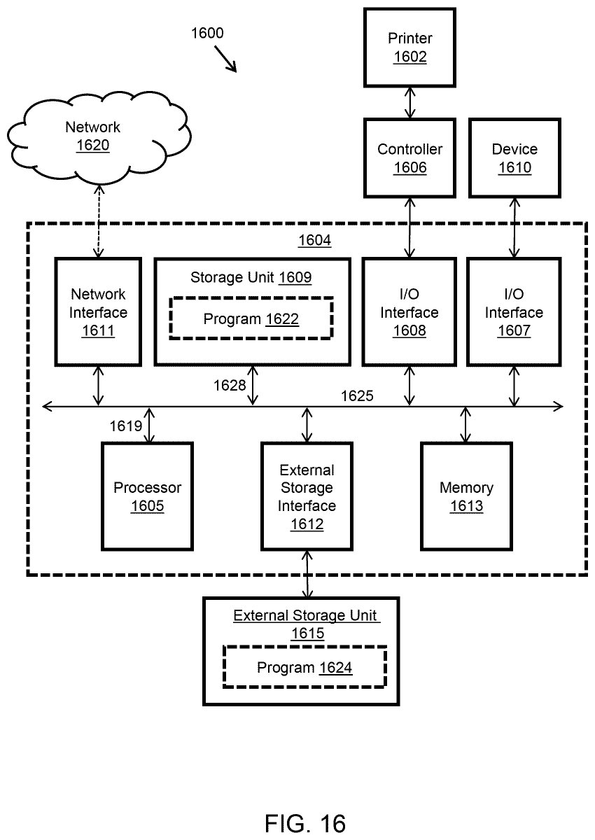

FIG. 16 shows an example computer system 1600, upon which the various arrangements described, can be practiced. The computer system (e.g., FIG. 16, 1600) can control and/or implement (e.g., direct and/or regulate) various features of printing methods, apparatus and/or system operations of the present disclosure. For example, the computer system can be used to instantiate a forming instructions engine. A forming instructions engine may generate instructions to control energy source parameters, processing chamber parameters (e.g., chamber pressure, gas flow and/or temperature), energy beam parameters (e.g., scanning rate, path and/or power), platform parameters (e.g., location and/or speed), layer forming apparatus parameters (e.g., speed, location and/or vacuum), or any combination thereof. A forming instructions engine may generate instructions for forming a 3D object in a layerwise (e.g., slice-by-slice) manner. For example, the computer system may be used to instantiate an object formation failure analysis engine. The object formation failure analysis engine may perform an analysis (e.g., estimation) of a likelihood of failure in forming a requested 3D object that considers a geometry and/or orientation of the 3D object. The analysis may be performed before and/or during instantiation of the forming instructions engine (e.g., generation of forming instructions), and/or formation of the requested 3D object. The generated instructions may according to default and/or designated (e.g., override) forming (e.g., printing) processes. The computer system can be part of, or be in communication with, one or more 3D printers (e.g., FIG. 16, 1602) or any of their (e.g., sub-) components. The computer system can include one or more computers (e.g., FIG. 16, 1604). The computer(s) may be operationally coupled to one or more mechanisms of the printer(s). For example, the computer(s) may be operationally coupled to one or more sensors, valves, switches, actuators (e.g., motors), pumps, optical components, and/or energy sources of the printer(s). In some cases, the computer(s) controls aspects of the printer(s) via one or more controllers (e.g., FIG. 16, 1606). The controller(s) may be configured to direct one or more operations of the one or more printer(s). For example, the controller(s) may be configured to direct one or more actuators of printer(s). In some cases, the controller(s) is part of the computer(s) (e.g., within the same unit(s)). In some cases, the controller(s) is separate (e.g., a separate unit) from the computer(s). In some instances, the computer(s) communicates with the controller(s) via one or more input/output (I/O) interfaces (e.g., FIG. 16, 1608). The input/output (I/O) interface(s) may comprise one or more wired or wireless connections to communicate with the printer(s). In some embodiments, the I/O interface comprises Bluetooth technology to communicate with the controller(s).

The computer(s) (e.g., FIG. 16, 1604) may have any number of components. For example, the computer(s) may comprise one or more storage units (e.g., FIG. 16, 1609), one or more processors (e.g., FIG. 16, 1605), one or more memory units (e.g., FIG. 16, 1613), and/or one or more external storage interfaces (e.g., FIG. 16, 1612). In some embodiments, the storage unit(s) includes a hard disk drive (HDD), a magnetic tape drive and/or a floppy disk drive. In some embodiments, the memory unit(s) includes a random access memory (RAM) and/or read only memory (ROM), and/or flash memory. In some embodiments, the external storage interface(s) comprises a disk drive (e.g., optical or floppy drive) and/or a universal serial bus (USB) port. The external storage interface(s) may be configured to provide communication with one or more external storage units (e.g., FIG. 16, 1615). The external storage unit(s) may comprise a portable memory medium. The external storage unit(s) may be a non-volatile source of data. In some cases, the external storage unit(s) is an optical disk (e.g., CD-ROM, DVD, Blu-ray Disc™), a USB-RAM, a hard drive, a magnetic tape drive, and/or a floppy disk. In some cases, the external storage unit(s) may comprise a disk drive (e.g., optical or floppy drive). Various components of the computer(s) may be operationally coupled via a communication bus (e.g., FIG. 16, 1625). For example, one or more processor(s) (e.g., FIG. 16, 1605) may be operationally coupled to the communication bus by one or more connections (e.g., FIG. 16, 1619). The storage unit(s) (e.g., FIG. 16, 1609) may be operationally coupled to the communication bus one or more connections (e.g., FIG. 16, 1628). The communication bus (e.g., FIG. 16, 1625) may comprise a motherboard.

In some embodiments, methods described herein are implemented as one or more software programs (e.g., FIGS. 16, 1622 and/or 1624). The software program(s) may be executable within the one or more computers (e.g., FIG. 16, 1604). The software may be implemented on a non-transitory computer readable media. The software program(s) may comprise machine-executable code. The machine-executable code may comprise program instructions. The program instructions may be carried out by the computer(s) (e.g., FIG. 16, 1604). The machine-executable code may be stored in the storage device(s) (e.g., FIG. 16, 1609). The machine-executable code may be stored in the external storage device(s) (e.g., FIG. 16, 1615). The machine-executable code may be stored in the memory unit(s) (e.g., FIG. 16, 1613). The storage device(s) (e.g., FIG. 16, 1609) and/or external storage device(s) (e.g., FIG. 16, 1615) may comprise a non-transitory computer-readable medium. The processor(s) may be configured to read the software program(s) (e.g., FIGS. 16, 1622 and/or 1624). In some cases, the machine-executable code can be retrieved from the storage device(s) and/or external storage device(s), and stored on the memory unit(s) (e.g., FIG. 16, 1606) for access by the processor (e.g., FIG. 16, 1605). In some cases, the access is in real-time (e.g., during printing). In some situations, the storage device(s) and/or external storage device(s) can be precluded, and the machine-executable code is stored on the memory unit(s). The machine-executable code may be pre-compiled and configured for use with a machine have a processer adapted to execute the machine-executable code, or can be compiled during runtime (e.g., in real-time). The machine-executable code can be supplied in a programming language that can be selected to enable the machine-executable code to execute in a pre-compiled or as-compiled fashion.

In some embodiments, the computer(s) is operationally coupled with, or comprises, one or more devices (e.g., FIG. 16, 1610). In some embodiments, the device(s) (e.g., FIG. 16, 1610) is configured to provide one or more (e.g., electronic) inputs to the computer(s). In some embodiments, the device(s) (e.g., FIG. 16, 1610) is configured to receive one or more (e.g., electronic) outputs from the computer(s). The computer(s) may communicate with the device(s) via one or more input/output (I/O) interfaces (e.g., FIG. 16, 1607). The input/output (I/O) interface(s) may comprise one or more wired or wireless connections. The device(s) can include one or more user interfaces (UI). The UI may include one or more keyboards, one or more pointer devices (e.g., mouse, trackpad, touchpad, or joystick), one or more displays (e.g., computer monitor or touch screen), one or more sensors, and/or one or more switches (e.g., electronic switch). In some cases, the UI may be a web-based user interface. At times, the UI provides a model design or graphical representation of a 3D object to be printed. The sensor(s) may comprise a light sensor, a thermal sensor, an audio sensor (e.g., microphone), and/or a tactile sensor. In some cases, the sensor(s) are part of the printer(s) (e.g., FIG. 16, 1602). For example, the sensor(s) may be located within a processing chamber of a printer (e.g., to monitor an atmosphere therein). The sensor(s) may be configured to monitor one or more signals (e.g., thermal and/or light signal) that is generated during a printing operation. In some cases, the sensor(s) are part of a component or apparatus that is separate from the printer(s). In some cases, the device(s) is a pre-printing processing apparatus. For example, in some cases, the device(s) can be one or more scanners (e.g., 2D or 3D scanner) for scanning (e.g., dimensions of) a 3D object. In some cases, the device(s) is a post-printing processing apparatus (e.g., a docking station, unpacking station, and/or a hot isostatic pressing apparatus). In some embodiments, the I/O interface comprises Bluetooth technology to communicate with the device(s).

In some embodiments, the computer(s) (e.g., FIG. 16, 1604), controller(s) (e.g., FIG. 16, 1606), printer(s) (e.g., FIG. 16, 1602) and/or device(s) (e.g., FIG. 16, 1610) comprises one or more communication ports. For example, one or more I/O interfaces (e.g., FIG. 16, 1607 or 1608) can comprise communication ports. The communication port(s) may be a serial port or a parallel port. The communication port(s) may be a Universal Serial Bus port (i.e., USB). The USB port can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, EOh, EFh, FEh, or FFh. The communication port(s) may comprise a plug and/or a socket (e.g., electrical, AC power, DC power). The communication port(s) may comprise an adapter (e.g., AC and/or DC power adapter). The communication port(s) may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the computer(s) is configured to communicate with one or more networks (e.g., FIG. 16, 1616). The network(s) may comprise a wide-area network (WAN) or a local area network (LAN). In some cases, the computer(s) includes one or more network interfaces (e.g., FIG. 16, 1611) that is configured to facilitate communication with the network(s). The network interface(s) may include wired and/or wireless connections. In some embodiments, the network interface(s) comprises a modulator demodulator (modem). The modem may be a wireless modem. The modem may be a broadband modem. The modem may be a “dial up” modem. The modem may be a high-speed modem. The WAN can comprise the Internet, a cellular telecommunications network, and/or a private WAN. The LAN can comprise an intranet. In some embodiments, the LAN is operationally coupled with the WAN via a connection, which may include a firewall security device. The WAN may be operationally coupled the LAN by a high capacity connection. In some cases, the computer(s) can communicate with one or more remote computers via the LAN and/or the WAN. In some instances, the computer(s) may communicate with a remote computer(s) of a user (e.g., operator). The user may access the computer(s) via the LAN and/or the WAN. In some cases, the computer(s) (e.g., FIG. 16, 1604) store and/or access data to and/or from data storage unit(s) that are located on one or more remote computers in communication via the LAN and/or the WAN. The remote computer(s) may be a client computer. The remote computer(s) may be a server computer (e.g., web server or server farm). The remote computer(s) can include desktop computers, personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants.

At times, the processor (e.g., FIG. 16, 1605) includes one or more cores. The computer system may comprise a single core processor, a multiple core processor, or a plurality of processors for parallel processing. The processor may comprise one or more central processing units (CPU) and/or graphic processing units (GPU). The multiple cores may be disposed in a physical unit (e.g., Central Processing Unit, or Graphic Processing Unit). The processor may be a single physical unit. The physical unit may be a die. The physical unit may comprise cache coherency circuitry. The processor may include multiple physical units. The physical unit may comprise an integrated circuit chip. The integrated circuit chip may comprise one or more transistors. The integrated circuit chip may comprise at least about 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The multiple cores may be disposed in close proximity. The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processors may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS, or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be an HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

At times, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processor(s) may be able to process algorithms comprising a matrix or a vector. The core may comprise a complex instruction set computing core (CISC), or reduced instruction set computing (RISC).

At times, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

At times, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

At times, the computing system includes an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the afore-mentioned times (e.g., from about 0.1 μs, to about 1 ms, from about 0.1 μs, to about 100 μs, or from about 0.1 μs to about 10 μs).

In some instances, the controller(s) (e.g., FIG. 16, 1606) uses real-time measurements and/or calculations to regulate one or more components of the printer(s). In some cases, the controller(s) regulate characteristics of the energy beam(s). The sensor(s) (e.g., on the printer) may provide a signal (e.g., input for the controller and/or processor) at a rate of at least about 0.1 KHz, 1 KHz, 10 KHz, 100 KHz, 1000 KHz, or 10000 KHz). The sensor(s) may be a temperature and/or positional sensor(s). The sensor(s) may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processor(s) may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during at least a portion of the 3D printing process. The real-time measurements may be in-situ measurements in the 3D printing system and/or apparatus. The real-time measurements may be during at least a portion of the formation of the 3D object. In some instances, the processor(s) may use the signal obtained from the at least one sensor to provide a processor(s) output, which output is provided by the processing system at a speed of at most about 100 minute (min), 50 min, 25 min, 15 min, 10 min, 5 min, 1 min, 0.5 min (i.e., 30 seconds (sec)), 15 sec, 10 sec, 5 sec, 1 sec, 0.5 sec, 0.25 sec, 0.2 sec, 0.1 sec, 80 milliseconds (ms), 50 ms, 10 ms, 5 ms, or 1 ms. In some instances, the processor(s) may use the signal obtained from the at least one sensor to provide a processor(s) output, which output is provided at a speed of any value between the aforementioned values (e.g., from about 100 min to about 1 ms, from about 100 min to about 10 min, from about 10 min to about 1 min, from about 5 min to about 0.5 min, from about 30 sec to about 0.1 sec, or from about 0.1 sec to about 1 ms). The processor(s) output may comprise an evaluation of the temperature at a location, position at a location (e.g., vertical and/or horizontal), or a map of locations. The location may be on the target surface. The map may comprise a topological or temperature map.

At times, the processor(s) (e.g., FIG. 16, 1605) uses the signal obtained from one or more sensors (e.g., on the printer) in an algorithm that is used in controlling the transforming agent (e.g., energy beam). The algorithm may comprise the path of the energy beam. In some instances, the algorithm may be used to alter the path of the energy beam on the target surface. The path may deviate from a cross section of a model corresponding to the requested 3D object. The processor may use the output in an algorithm that is used in determining the manner in which a model of the requested 3D object may be sliced. The processor may use the signal obtained from the at least one sensor in an algorithm that is used to configure one or more parameters and/or apparatuses relating to the 3D printing procedure. The parameters may comprise a characteristic of the energy beam. The parameters may comprise movement of a platform and/or a material bed. The parameters may include characteristics of a gas flow system. The parameters may include characteristics of a layer forming apparatus. The parameters may comprise relative movement of a transforming agent (e.g., energy beam) and the material bed. In some instances, the energy beam, the platform (e.g., material bed disposed on the platform), or both may translate. Alternatively, or additionally, the controller(s) (e.g., FIG. 16, 1610) may use historical data for the control. Alternatively, or additionally, the processor may use historical data in its one or more algorithms. The parameters may comprise the height of the layer of pre-transformed material disposed in the enclosure and/or the gap by which the cooling element (e.g., heat sink) is separated from the target surface. The target surface may be the exposed layer of the material bed.

At times, the memory (e.g., FIG. 16, 1606) comprises a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may complement to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

At times, all or portions of the software program(s) (e.g., FIG. 16, 1627) are communicated through the WAN or LAN networks. Such communications, for example, may enable loading of the software program(s) from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software program(s). As used herein, unless restricted to non-transitory, tangible “storage” media, terms such as computer or machine “readable medium” refer to any medium that participates in providing instructions to a processor for execution. Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and/or infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

At times, the computer system monitors and/or controls various aspects of the 3D printer(s). In some cases, the control is via controller(s) (e.g., FIG. 16, 1606). The control may be manual and/or programmed. The control may comprise an open loop control or a closed loop control (e.g., including feed forward and/or feedback) control scheme. The closed loop control may utilize signal from the one or more sensors. The control may utilize historical data. The control scheme may be pre-programmed. The control scheme may consider an input from one or more sensors (described herein) that are connected to the control unit (i.e., control system or control mechanism) and/or processor(s). The computer system (including the processor(s)) may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the: total time, time remaining, and time expended on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output (e.g., a likelihood of) any estimated formation failure of the requested 3D object. The computer may generate a report comprising various parameters of the 3D printing system, method, and or objects at predetermined time(s), on a request (e.g., from an operator), and/or at a whim. The output unit may comprise a screen, printer, a light source (e.g., lamp), or speaker. The control system may provide a report. The report may comprise any items recited as optionally output by the output unit.

At times, the systems, methods, and/or apparatuses disclosed herein comprises receiving a request for a 3D object (e.g., from a customer). The request can include a geometric model (e.g., a CAD file) of the requested 3D object. Alternatively, or additionally, a model of the requested 3D object may be generated. The systems, methods, and/or apparatuses disclosed herein may comprise an analysis (e.g., prediction and/or feedback) regarding an estimated likelihood of failure to generate the requested 3D object. The model may be used to generate 3D forming instructions. The analysis of the estimated likelihood of failure may be performed before, during, and/or following generation of the 3D forming instructions. The software program(s) (e.g., FIGS. 16, 1622 and/or 1624) may comprise the analysis of the estimated likelihood of failure to generate the requested 3D object and/or the 3D forming instructions. The 3D forming instructions may exclude the 3D model. The 3D forming instructions may be based on the 3D model. The 3D forming instructions may take the 3D model into account. The 3D forming instructions may be alternatively or additionally based on simulations. The 3D forming instructions may use the 3D model. The 3D forming instructions may comprise using a calculation (e.g., embedded in a software program(s)) that considers the 3D model, simulations, historical data, sensor input, or any combination thereof. The processor may compute the calculation during the 3D forming procedure (e.g., in real-time), during the formation of the 3D object, prior to the 3D forming procedure, after the 3D forming procedure, or any combination thereof. The processor may compute the calculation in the interval between pulses of the energy beam, during the dwell time of the energy beam, before the energy beam translates to a new position, while the energy beam is not translating, while the energy beam does not irradiate the target surface, while the (e.g., at least one) energy beam irradiates the target surface, or any combination thereof. The processor may compute the calculation in the interval between a movement of at least one optical element from a first position to a second position, while the at least one optical element moves (e.g., translates) to a new (e.g., second) position. For example, the processor(s) may compute the calculation while the energy beam translates and does substantially not irradiate the exposed surface. For example, the processor(s) may compute the calculation while the energy beam does not translate and irradiates the exposed surface. For example, the processor(s) may compute the calculation while the energy beam does not substantially translate and does substantially not irradiate the exposed surface. For example, the processor(s) may compute the calculation while the energy beam does translate and irradiates the exposed surface. The translation of the energy beam may be translation along an entire energy beam path or a portion thereof. The energy beam path may correspond to a cross section of the model of the 3D object. The translation of the energy beam may be translation along at least one energy beam path.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-33. (canceled)

34. An apparatus for printing a three-dimensional (3D) object, the apparatus comprising at least one controller configured to:
(a) couple to a power source, and operatively coupled to a 3D printer configured to print the 3D object comprising an elemental metal, a metal alloy, a ceramic, or an allotrope of elemental carbon;
(b) received from a user allowed tolerance for the 3D object, receive from the user a selection of parameters, the user being a client requesting the 3D object, the parameters comprising a printing parameter or a 3D object parameter, the parameters being used in a simulation of the printing of at least a portion of the 3D object, the simulation utilized to predict failure of at least a portion of the 3D object during the printing within allowed tolerances requested by the user, the simulation being conducted before the printing, an output of the simulation being evaluated according to the allowed tolerances;
(c) execute, or direct execution of the simulation before the printing to generate a result; and
(d) direct the 3D printer to print the 3D object based at least in part on compliance of the result of the simulation with the allowed tolerances of the user.

35. The apparatus of claim 34, wherein the parameters comprise a threshold value of one or more simulated values relating to at least one of the 3D object parameter comprising material deformation, material properties, object support, residual stress, mis-location of transformed material in the at least the portion of the 3D object, or cracking in the at least the portion of the 3D object.

36. The apparatus of claim 35, wherein the threshold value comprises a historical selection by the user, a historical selection by an average user, or a historical selection by a group of users.

37. The apparatus of claim 34, wherein the at least one controller is configured to utilize the simulation comprising a thermo-mechanics simulation or a fluid dynamics simulation.

38. The apparatus of claim 34, wherein the at least one controller is configured to receive from the user a decision as to which portion of the 3D object undergoes which simulation for a failure mode constituting an estimation of failure.

39. The apparatus of claim 38, wherein the at least one controller is configured to receive from the user a selection of a failure mode from a suggested group of failure modes.

40. The apparatus of claim 38, wherein the at least one controller is configured to receive designation of a portion of the at least the portion selected according to: (i) a selection by the user, (ii) a determination of support sufficiency of the portion, (iii) a complexity of a region of the portion, and/or (iv) historical data of the portion previously printed or an other portion similar to the portion, the other portion being previously printed.

41. The apparatus of claim 34, wherein the at least one controller is configured to receive from the user a selection of a degree of complexity for the simulation.

42. The apparatus of claim 34, wherein the at least one controller is configured to receive from the user a selection of a printing resolution of the at least the portion of the 3D object.

43. The apparatus of claim 34, wherein the at least one controller is configured to receive from the user a selection of a printing speed for the at least the portion of the 3D object.

44. The apparatus of claim 34, wherein the at least one controller is configured to receive from the user a request to refine the simulation of the at least the portion of the 3D object, and refine, or direct refinement, of the simulation according at least in part to the request by the user.

45. The apparatus of claim 34, wherein the at least one controller is configured to receive from the user a request to alter at least one dimension of the at least the portion of the 3D object, and direct simulating and/or printing the 3D object based at least in part on the request to alter the at least one dimension.

46. The apparatus of claim 34, wherein the at least one controller is configured to receive from the user a selection of a process of the printing.

47. The apparatus of claim 46, wherein the at least one controller is configured to receive from the user a selection of the process of the printing suggested to the user based at least in part on (i) a curvature of the at least the portion of the 3D object, (ii) an angle of the at least the portion of the 3D object, (iii) a material property of the at least the portion of the 3D object, (iv) a rate of formation of the at least the portion of the 3D object, and/or (v) a surface property of the at least the portion of the 3D object.

48. The apparatus of claim 46, wherein the at least one controller is configured to receive from the user a selection of a process of the printing selected from (a) a historical selection of the process preferred by the user, (b) a historical selection of the process preferred by an average user, or (c) a historical selection of the process preferred by a group of users.

49. The apparatus of claim 34, wherein the at least one controller is configured to receive from the user: (i) characteristic of a transforming agent utilized during the printing and (ii) geometry of the at least the portion of the 3D object.

50. The apparatus of claim 34, wherein the at least one controller is configured to receive data from the user via remote communication through a communication network.

51. claim 34, wherein the at least one controller is configured to receive data from the user via communication comprising (i) web based communication, (ii) wide-area network (WAN) communication, or (iii) local area network (LAN) communication.

52. A method of 3D printing, the method comprising: (a) providing the apparatus of claim 34, and (b) using the apparatus to print the 3D object.

53. Non-transitory computer readable program instructions that, when read by one or more processors operatively coupled to a transforming agent utilized in the printing, cause the one or more processors to execute one or more of (b), (c), and (d) of claim 34, the program instructions being inscribed on at least one non-transitory computer readable medium.
